(19) United States
(12) Patent Application Publication
(10) Pub. No.: US 2026/0244921 A1
(43) Pub. Date: Aug. 20, 2026

(54) GENERATIVE AI MODELS USING INDUCTIVE MOMENT MATCHING

(71) Applicant: Luma AI, Inc., Palo Alto, CA (US)

(72) Inventors: Jiaming SONG, Burlingame, CA (US); Lin Qi ZHOU, Palo Alto, CA (US)

(21) Appl. No.: 19/565,157

(22) Filed: Mar. 12, 2026

Related U.S. Application Data
(63) Continuation of application No. PCT/US2026/015636, filed on Feb. 18, 2026.
(60) Provisional application No. 63/760,396, filed on Feb. 19, 2025.

(51) Int. Cl. G06N 3/08; G06N 3/0475

(52) U.S. Cl. CPC G06N 3/08; G06N 3/0475

(57) ABSTRACT

Described are methods and systems for training generative artificial intelligence (AI) models. A method for training a generative AI model can include obtaining a first dataset comprising an observed data sample from a data distribution of observed data and a second dataset comprising a prior sample from a prior distribution; synthesizing first data at a first time step based on the observed data sample and the prior sample; synthesizing second data at a second time step based on the observed data sample and the first data; generating, using a neural network, a first output and a second output at the target time step; and obtaining a trained generative AI model by updating parameters of the neural network, wherein the updating comprises at least computing a loss between a first distribution of the first output and a second distribution of the second output.

### CROSS-REFERENCE TO RELATED APPLICATIONS

This application is a continuation application of International Application No. PCT/US2026/015636, filed Feb. 18, 2026, which claims the benefit of U.S. Provisional Application No. 63/760,396, filed Feb. 19, 2025, which is incorporated by reference herein in its entirety.

### BACKGROUND

Generative artificial intelligence (AI) models can enable technical applications related to generating, e.g., images, videos, audio, and the like. However, achieving efficient computing inference, high-fidelity outputs, and stable model training remain technical challenges. For example, diffusion models and flow matching models can generate high-quality samples but are slow at inference. Further, distilling them into one or few-step models can lead to models that are unstable and require extensive tuning.

Recognized herein is a need for generative AI models that can at least be trained in one or few-steps or stages while remaining stable and generating high-fidelity outputs.

### SUMMARY

Provided herein are methods and systems that can at least train generative AI models in one or few-steps while remaining stable and generating high-fidelity outputs. To resolve technical trade-offs between, e.g., efficient inference and stability, the present disclosure provides methods and systems for inductive moment matching (IMM), a new class of generative AI models for one- or few-step sampling with single-stage training. Unlike distillation, IMM does not require pre-training initialization and optimization of two or more networks, which can waste computing and network resources. Unlike consistency models, IMM can provide distribution-level convergence and remain stable under various hyperparameters and standard model architectures. As demonstrated herein, IMM can surpass diffusion models on ImageNet-256×256 with 1.99 Fréchet inception distance (FID) using only one or few stages of 8 inference steps. Further, IMM can achieve state-of-the-art 2-step FID of 1.98 with one or few stages on Canadian Institute for Advanced Research (CIFAR)-10 for a model trained from scratch.

In an aspect, disclosed herein is a method for training a generative artificial intelligence (AI) model, the method comprising: (a) obtaining (i) a first dataset comprising an observed data sample from a data distribution of observed data and (ii) a second dataset comprising a prior sample from a prior distribution; (b) synthesizing first data at a first time step based on the observed data sample and the prior sample; (c) synthesizing second data at a second time step based on the observed data sample and the first data, wherein the second time step is between a target time step and the first time step; (d) generating, using a neural network, a first output and a second output at the target time step, wherein (i) the first output is obtained using the first data with the target time step and the first time step as conditioning inputs and (ii) the second output is obtained using the second data with the target time step and the second time step as conditioning inputs; and (e) obtaining a trained generative AI model by updating parameters of the neural network, wherein the updating comprises at least computing a loss between a first distribution of the first output and a second distribution of the second output. In some embodiments, the method further comprises generating the first dataset and the second dataset. In some embodiments, the observed data comprises data obtained from image data, video data, audio data, text data, sensor data, geospatial data, or metadata. In some embodiments, the observed data comprises continuous data, structured data, or unstructured data. In some embodiments, the prior sample comprises random noise. In some embodiments, the prior distribution comprises a Gaussian distribution, a uniform random distribution, or a Dirichlet distribution. In some embodiments, synthesizing the first data comprises sampling from a first marginal interpolating distribution parametrized by the observed data sample and the prior sample. In some embodiments, the first marginal interpolating distribution is determined using a denoising diffusion implicit model. In some embodiments, synthesizing the second data comprises sampling from a second marginal interpolating distribution parametrized by the observed data sample and the first data. In some embodiments, the second marginal interpolating distribution is determined using a denoising diffusion implicit model. In some embodiments, the first output comprises a first marginal preserving interpolant between the first data and the observed data. In some embodiments, the first marginal preserving interpolant preserves a marginal distribution of the first output for a plurality of time steps. In some embodiments, the second output comprises a second marginal preserving interpolant between the second data and the observed data. In some embodiments, the second marginal preserving interpolation preserves a marginal distribution of the second first output for a plurality of time steps. In some embodiments, the first time step is sampled from a first time distribution. In some embodiments, the target time step is sampled from a second time distribution, parametrized by the first time step. In some embodiments, the second time step is determined using a mapping function parametrized by the first time step and the target time step. In some embodiments, the computed loss is determined using maximum mean discrepancy. In some embodiments, the maximum mean discrepancy is determined using a kernel function. In some embodiments, the method further comprises applying a stop gradient operation on the second output when computing the loss. In some embodiments, the method further comprises prompting the trained generative AI model with at least a request for a type of data and a category of data. In some embodiments, the method further comprises generating, using the trained generative AI model, new data based at least on the prompting. In some embodiments, the new data is determined to be statistically similar to the observed data. In some embodiments, the new data is determined to be statistically similar to the observed data with a Fréchet inception distance (FID) of less than about 2.5. In some embodiments, the method further comprises automatically rendering the new data on a graphical user interface (GUI), wherein the GUI comprises dynamically selectable objects or elements to modify the new data or append additional data to the new data in real time. In some embodiments, the trained generative AI model comprises a stable model trained in one stage. In some embodiments, the method further comprises repetitively synthesizing a third data or more data at successive time steps, based on data synthesized at a previous time step. In some embodiments, the first dataset comprises a first training dataset, wherein the second dataset comprises a second training dataset, and wherein each dataset is used to obtain the trained generative AI model.

In another aspect, disclosed herein is a method comprising: (a) training a generative artificial intelligence (AI) model in one stage, wherein the model is stable; and (b) generating, using the trained generative AI model, new data, wherein the new data comprises high fidelity data.

In another aspect, disclosed herein is a method comprising: (a) obtaining a trained generative artificial intelligence (AI) model according to any one of claims herein; (b) prompting the trained generative AI model with at least a request for a type of data and a category of data; and (c) generating, using the trained generative AI model, new data based at least on the prompting in (b).

In another aspect, disclosed herein is a system comprising at least one processor and instructions executable by the at least one processor to cause the at least one processor to perform operations comprising: (a) obtaining (i) a first dataset comprising an observed data sample from a data distribution of observed data and (ii) a second dataset comprising a prior sample from a prior distribution; (b) synthesizing first data at a first time step based on the observed data sample and the prior sample; (c) synthesizing second data at a second time step based on the observed data sample and the first data, wherein the second time step is between a target time step and the first time step; (d) generating, using a neural network, a first output and a second output at the target time step, wherein (i) the first output is obtained using the first data with the target time step and the first time step as conditioning inputs and (ii) the second output is obtained using the second data with the target time step and the second time step as conditioning inputs; and (e) obtaining a trained generative AI model by updating parameters of the neural network, wherein the updating comprises at least computing a loss between a first distribution of the first output and a second distribution of the second output. In some embodiments, the system further comprises generating the first dataset and the second dataset. In some embodiments, the observed data comprises data obtained from image data, video data, audio data, text data, sensor data, geospatial data, or metadata. In some embodiments, the observed data comprises continuous data, structured data, or unstructured data. In some embodiments, the prior sample comprises random noise. In some embodiments, the prior distribution comprises a Gaussian distribution, a uniform random distribution, or a Dirichlet distribution. In some embodiments, synthesizing the first data comprises sampling from a first marginal interpolating distribution parametrized by the observed data sample and the prior sample. In some embodiments, the first marginal interpolating distribution is determined using a denoising diffusion implicit model. In some embodiments, synthesizing the second data comprises sampling from a second marginal interpolating distribution parametrized by the observed data sample and the first data. In some embodiments, the second marginal interpolating distribution is determined using a denoising diffusion implicit model. In some embodiments, the first output comprises a first marginal preserving interpolant between the first data and the observed data. In some embodiments, the first marginal preserving interpolant preserves a marginal distribution of the first output for a plurality of time steps. In some embodiments, the second output comprises a second marginal preserving interpolant between the second data and the observed data. In some embodiments, the second marginal preserving interpolation preserves a marginal distribution of the second first output for a plurality of time steps. In some embodiments, the first time step is sampled from a first time distribution. In some embodiments, the target time step is sampled from a second time distribution, parametrized by the first time step. In some embodiments, the second time step is determined using a mapping function parametrized by the first time step and the target time step. In some embodiments, the computed loss is determined using maximum mean discrepancy. In some embodiments, the maximum mean discrepancy is determined using a kernel function. In some embodiments, the system further comprises applying a stop gradient operation on the second output when computing the loss. In some embodiments, the system further comprises prompting the trained generative AI model with at least a request for a type of data and a category of data. The system of claim 51, further comprises generating, using the trained generative AI model, new data based at least on the prompting. In some embodiments, the new data is determined to be statistically similar to the observed data. In some embodiments, the new data is determined to be statistically similar to the observed data with a Fréchet inception distance (FID) of less than about 2.5. In some embodiments, the system further comprises automatically rendering the new data on a graphical user interface (GUI), wherein the GUI comprises dynamically selectable objects or elements to modify the new data or append additional data to the new data in real time. In some embodiments, the trained generative AI model comprises a stable model trained in one stage. In some embodiments, the system further comprises repetitively synthesizing a third data or more data at successive time steps, based on data synthesized at a previous time step. In some embodiments, the first dataset comprises a first training dataset, wherein the second dataset comprises a second training dataset, and wherein each dataset is used to obtain the trained generative AI model.

In another aspect, disclosed herein is a computer program product, the computer program product comprising at least one non-transitory computer-readable medium having computer-readable program code portions embodied therein, the computer-readable program code portions comprising: an executable portion configured to obtain (i) a first dataset comprising an observed data sample from a data distribution of observed data and (ii) a second dataset comprising a prior sample from a prior distribution; an executable portion configured to synthesize first data at a first time step based on the observed data sample and the prior sample; an executable portion configured to synthesize second data at a second time step based on the observed data sample and the first data, wherein the second time step is between a target time step and the first time step; an executable portion configured to generate, using a neural network, a first output and a second output at the target time step, wherein (i) the first output is obtained using the first data with the target time step and the first time step as conditioning inputs and (ii) the second output is obtained using the second data with the target time step and the second time step as conditioning inputs; and an executable portion configured to obtain a trained generative AI model by updating parameters of the neural network, wherein the updating comprises at least computing a loss between a first distribution of the first output and a second distribution of the second output.

Additional aspects and advantages of the present disclosure will become readily apparent from the following detailed description, wherein only illustrative embodiments of the present disclosure are shown and described. As will be realized, the present disclosure is capable of other and different embodiments, and its several details are capable of modifications in various obvious respects, all without departing from the present disclosure. Accordingly, the drawings and description are to be regarded as illustrative in nature and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the present disclosure contained in the specification, the specification is intended to supersede and/or take precedence over any such contradictory material.

### BRIEF DESCRIPTION OF THE DRAWINGS

The novel features of the present disclosure are set forth with particularity in the appended claims. A better understanding of the features and advantages of the present disclosure will be obtained by reference to the following detailed description that sets forth illustrative embodiments, in which the principles of the present disclosure are utilized, and the accompanying drawings of which:

FIG. 1 shows examples of generated samples on ImageNet-256×256 using 8 steps, in some embodiments.

FIG. 2 shows an example method of using an interpolation from data to prior to define a one-step sampler that moves from any t to s<t, directly transforming qₜ(xₜ) to qₛ(xₛ), in some embodiments. This can be repeated by jumping to an intermediate r<t before moving to s<r.

FIG. 3 shows an example model that, with self-consistent interpolants, uses M particle samples (M=2 is shown) for moment matching, in some embodiments. Samples from

$${p}_{s \vert t}^{θ} ( {x}_{s} )$$

are obtained by drawing from

$${p}_{s \vert t}^{θ} ( x \vert {x}_{t} )$$

followed by q_{s|t}(xₛ|x, xₜ). Solid and dashed lines indicate sampling with and without gradient propagation, respectively. After M samples are drawn, sample xₛ is repulsed by x′ₛ and attracted towards samples of x^{~}ₛ and x^{~}′ₛ through kernel function k(⋅, ⋅).

FIGS. 4A-4B show example data illustrating model training stability. in some embodiments. FIG. 4A shows FID convergence for different embeddings, in some embodiments. FIG. 4B shows CIFAR-10 samples from Fourier embedding (scale=16), in some embodiments.

FIG. 5 shows example data illustrating that more particles indicate more stable training on ImageNet-256×256, in some embodiments.

FIG. 6 shows example data of ImageNet-256×256 FID with different sampler types, in some embodiments.

FIGS. 7A-7C show example data illustrating the performance of a model trained using moment matching self-distillation (MMSD), in some embodiments. FIG. 7A shows data illustrating that the model scales with training compute, in some embodiments. FIG. 7B shows data illustrating that the model scales with inferences compute, in some embodiments. FIG. 7C shows data illustrating that the model exhibits strong correlation between model size and performance, in some embodiments.

FIG. 8 shows example data illustrating that sample visual quality increases with increase in both model size and sampling compute, in some embodiments.

FIGS. 9A-9B show example data illustrating a performance of a model based on a value of a noise embedding, in some embodiments. FIG. 9A shows data illustrating log distance in embedding space for cₙₒᵢₛₑ(t)=ct, in some embodiments. FIG. 9B shows data illustrating similar ImageNet-256×256 convergence across different c, in some embodiments.

FIG. 10 shows example data of ImageNet-256×256 FID progression with different t, r gap with M=4, in some embodiments.

FIGS. 11A-11B show example data of FID progression on different types of mapping function r(s,t), in some embodiments. FIG. 11A shows example data of FID progression on different types of mapping function r(s,t) for CIFAR-10, in some embodiments. FIG. 11B shows example data of FID progression on different types of mapping function r(s,t) for ImageNet-256×256, in some embodiments.

FIG. 12 shows examples of uncurated samples on CIFAR-10, unconditional, 2 steps, in some embodiments.

FIG. 13 shows examples of uncurated samples on ImageNet-256×256 using DiT-XL/2 architecture, guidance w=1.5, 8 steps, in some embodiments.

FIG. 14 shows examples of uncurated samples on ImageNet-256×256 using DiT-XL/2 architecture, guidance R=1.5, 8 steps, in some embodiments.

FIG. 15 depicts a non-limiting example of a computing device configured to perform methods herein, in some embodiments.

FIG. 16 depicts a non-limiting example of a web/mobile application provision system configured to perform methods herein, in some embodiments.

FIG. 17 depicts a non-limiting example of a cloud-based web/mobile application provision system configured to perform methods herein, in some embodiments.

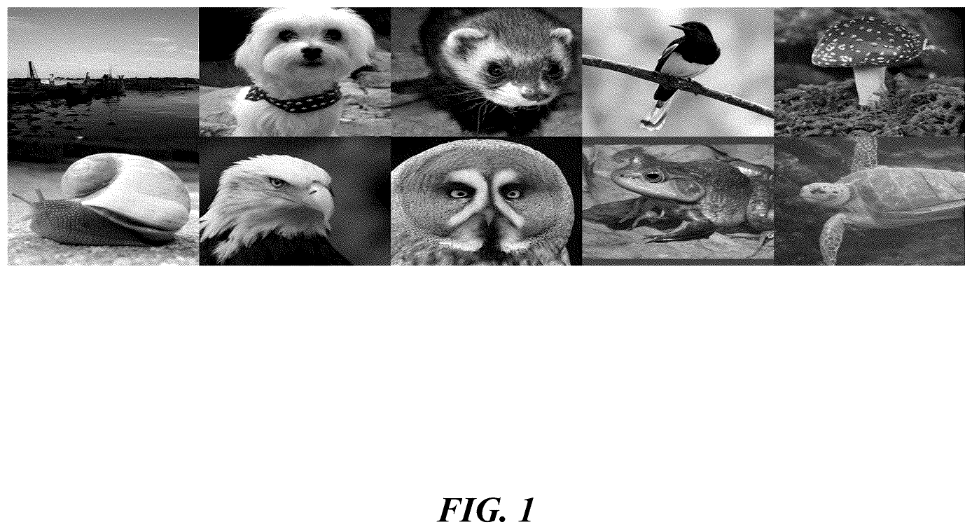

### DETAILED DESCRIPTION

While various embodiments of the present disclosure have been shown and described herein, such embodiments are provided by way of example only. Numerous variations, changes, or substitutions may occur without departing from the present disclosure. It should be understood that various alternatives to the embodiments of the present disclosure described herein may be employed.

### 1 INTRODUCTION

Generative models for domains, e.g., continuous domains, may enable applications in images (Rombach et al., 2022; Saharia et al., 2022; Esser et al., 2024; each of which is incorporated by reference herein in its entirety), videos (Ho et al., 2022a; Blattmann et al., 2023; OpenAI, 2024; each of which is incorporated by reference herein in its entirety), or audio (Chen et al., 2020; Kong et al., 2020; Liu et al., 2023; each of which is incorporated by reference herein in its entirety). Yet achieving high-fidelity outputs, efficient inference, and stable training remains an unmet technical challenge. Diffusion models (Sohl-Dickstein et al., 2015; Ho et al., 2020; Song et al., 2020b; each of which is incorporated by reference herein in its entirety) may require many inference steps for high-fidelity outputs. Further, step-reduction methods, such as diffusion distillation (Yin et al., 2024; Sauer et al., 2025; Zhou et al., 2024; Luo et al., 2024a; each of which is incorporated by reference herein in its entirety) and consistency models (Song et al., 2023; Geng et al., 2024; Lu & Song, 2024; Kim et al., 2023; each of which is incorporated by reference herein in its entirety) may risk training collapse without careful tuning and regularization, e.g., pre-generating data-noise pair and early stopping.

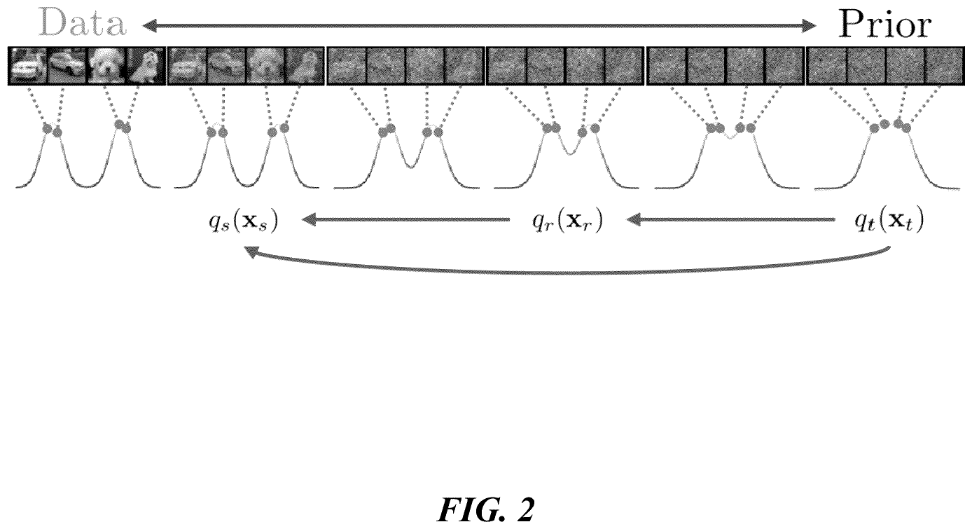

To solve at least the aforementioned technical challenges, the present disclosure provides methods and systems for inductive moment matching (IMM). IMM can provide technical solutions for at least a stable, single-stage training procedure that learns generative AI models from scratch for single- or multi-step inference. IMM can operate on the time-dependent marginal distributions of stochastic interpolants (Albergo et al., 2023; which is incorporated by reference herein in its entirety), described as continuous-time stochastic processes that connect two arbitrary probability density functions (data at t=0 and prior at t=1). As illustrated in FIG. 2, by learning a mapping, e.g., a stochastic or deterministic mapping from a first marginal at time t to a second marginal at time s<t, IMM can provide technical solutions for one- or multi-step generation of trained generative AI models.

For example, IMM models can be trained efficiently from mathematical induction. For time s<r<t, two distributions can be formed at s by running a one-step IMM from samples at r and t. Their divergence can be minimized, thereby enforcing that the distributions at s are independent of the starting time-steps. This construction by induction can enable convergence to the data distribution. To improve training stability, IMM can be modeled based on certain stochastic interpolants, and the objective can be optimized with stable sample-based divergence estimators, e.g., moment matching (Gretton et al., 2012; which is incorporated by reference herein in its entirety). The present disclosure demonstrates that consistency models (CMs) are a single-particle, first-moment matching special case of IMM, which can at least explain the training instability of CMs.

To summarize, models such as diffusion models and flow matching models are slow at sampling. Even if perfectly trained, they require many inefficient computing steps, e.g., tens to more than hundreds of steps, to produce high-fidelity samples. Compared to the present disclosure, methods which focus on distilling these slow samplers into fast one-step or few-step ones as a post-training step in a two-stage approach often require extensive tuning, e.g., balancing training of two or more networks or tuned training schedules.

In contrast, the present disclosure can provide a single-stage training approach without adversarial losses to directly achieve few-step sampling during inference yet achieve both high-fidelity outputs and sampling efficiency. Further, the present disclosure provides broader implications for generative modeling by enabling end-to-end training of models that support both few-step and many-step inference. By eliminating the need for an additional distillation step during deployment, methods and systems herein can streamline the training-to-inference pipeline, thereby at least reducing computing and network resources to train and deploy generative AI models. IMM can learn by using maximum mean discrepancy (MMD) as a stable divergence metric that matches two probability distributions using samples. Such methods can incorporate a learning strategy that allows the model to learn from its own samples inspired by mathematical induction. IMM is demonstrated herein to converge to the data distribution and is empirically more stable than other few-step approaches, e.g., consistency training, while achieving improved technical performance on ImageNet-256×256. As demonstrated, on ImageNet-256×256, IMM surpasses diffusion models and achieves 1.99 Fréchet inception distance (FID) with only 8 inference steps in one or few stages using standard transformer architectures. On (CIFAR)-10, IMM similarly achieves state-of-the-art of 1.98 FID with 2-step generation in one or few stages for a model trained from scratch.

In an aspect, the present disclosure provides methods for training a generative artificial intelligence (AI) model. In some embodiments, a method comprises obtaining (i) a first training set comprising an observed data sample from a data distribution of observed data (e.g., distribution at t=0) and (ii) a second training set comprising a prior sample from a prior distribution (e.g., distribution at t=1). In some embodiments, the method comprises synthesizing first data at a first time step (e.g., time t) based on the observed data sample and the prior sample. In some embodiments, the method comprises synthesizing second data at a second time step (e.g., time r) based on the observed data sample and the first data. In some embodiments, the second time step is between a target time step (e.g., time s) and the first time step. In some embodiments, the method comprises generating, using a neural network, a first output and a second output at the target time step. In some embodiments, the first output is obtained using the first data with the target time step and the first time step as conditioning inputs and (ii) the second output is obtained using the second data with the target time step and the second time step as conditioning inputs. In some embodiments, the method comprises obtaining a trained generative AI model by updating parameters of the neural network. In some embodiments, the updating comprises at least computing a loss between a first distribution of the first output and a second distribution of the second output.

In some embodiments, a method comprises (a) training a generative artificial intelligence (AI) model in one stage. In some embodiments, the model is stable. In some embodiments, the method comprises generating, using the trained generative AI model, new data, wherein the new data comprises high fidelity data.

In some embodiments, a method comprises obtaining a trained generative artificial intelligence (AI) model according to any of the method disclosed herein. In some embodiments, the method comprises prompting the trained generative AI model with at least a request for a type of data and a category of data. In some embodiments, the method comprises generating, using the trained generative AI model, new data based at least on the prompting.

In some embodiments, the method comprises generating the first training set and the second training set. In some embodiments, generating the first training set comprises obtaining the observed data. In some embodiments, the observed data is obtained from a memory, a database, a storage, a cloud, or any combination thereof. In some embodiments, generating the first training set comprises generating the data distribution, based on the observed data. In some embodiments, generating the first training set comprises sampling or selecting the observed data sample from the data distribution of observed data. In some embodiments, generating the second training set comprises generating the prior distribution. In some embodiments, generating the second training set comprises sampling the prior sample from the prior distribution.

In some embodiments, the observed data comprises data obtained from image data, video data, audio data, text data, sensor data, geospatial data, or metadata. In some embodiments, the observed data is obtained using a sensor. In some embodiments, the image data or the video data is obtained using a camera or a scanner. In some embodiments, the audio data is obtained using a microphone. In some embodiments, the text data is obtained from a user using a keyboard, a graphical user interface (GUI), a voice recognition software, an optical character recognition (OCR) software, or any combination thereof. In some embodiments, the geospatial data is obtained using a global positioning system (GPS) sensor, a satellite imaging sensor, a radar sensor, a light detection and ranging (LiDAR) sensor, or any combination thereof. In some embodiments, the metadata comprises temporal metadata, geospatial metadata, descriptive metadata, structural metadata, or any combination thereof.

In some embodiments, the observed data comprises continuous data, structured data, or unstructured data. In some embodiments, the continuous data comprises measured data. In some embodiments, the measured data may take on an infinite number of values within a specified range. In some embodiments, the structured data is organized in a data schema. In some embodiments, the data schema comprises a table, a chart, a graph, a matrix, or any combination thereof. In some embodiments, the unstructured data is not organized in the data schema. In some embodiments, the unstructured data comprises image data, audio data, text data, or any combination thereof.

In some embodiments, the first dataset comprises a first training dataset. In some embodiments, the second dataset comprises a second training dataset. In some embodiments, each dataset is used to obtain the trained generative AI model. In some embodiments, the first training dataset or the second training dataset may comprise data obtained from one or more sensors. In some embodiments, the first training dataset or the second training dataset may comprise labeled data. The labeled data may comprise a label corresponding to a type, a structure, a content, or a topic of the first training dataset or the second training dataset. In some embodiments, the trained generative AI model is configured to generate data that is similar to the first training dataset or the second training dataset.

In another aspect, the present disclosure provides systems configured to implement methods herein. In some embodiments, a system comprises at least one processor. In some embodiments, the system comprises instructions executable by the at least one processor to cause the at least one processor to perform operations. In some embodiments, the operations comprise obtaining (i) a first dataset comprising an observed data sample from a data distribution of observed data and (ii) a second dataset comprising a prior sample from a prior distribution. In some embodiments, the operations comprise synthesizing first data at a first time step based on the observed data sample and the prior sample. In some embodiments, the operations comprise synthesizing second data at a second time step based on the observed data sample and the first data. In some embodiments, the second time step is between a target time step and the first time step. In some embodiments, the operations comprise generating, using a neural network, a first output and a second output at the target time step. In some embodiments, (i) the first output is obtained using the first data with the target time step and the first time step as conditioning inputs and (ii) the second output is obtained using the second data with the target time step and the second time step as conditioning inputs. In some embodiments, the operations comprise obtaining a trained generative AI model by updating parameters of the neural network. In some embodiments, the updating comprises at least computing a loss between a first distribution of the first output and a second distribution of the second output.

In some embodiments, the present disclosure provides computer program products. In some embodiments, a computer program product comprising at least one non-transitory computer-readable medium having computer-readable program code portions embodied therein. In some embodiments, the computer-readable program code portions comprise an executable portion configured to obtain (i) a first dataset comprising an observed data sample from a data distribution of observed data and (ii) a second dataset comprising a prior sample from a prior distribution. In some embodiments, the computer-readable program code portions comprise an executable portion configured to synthesize first data at a first time step based on the observed data sample and the prior sample. In some embodiments, the computer-readable program code portions comprise an executable portion configured to synthesize second data at a second time step based on the observed data sample and the first data. In some embodiments, the second time step is between a target time step and the first time step. In some embodiments, the computer-readable program code portions comprise an executable portion configured to generate, using a neural network, a first output and a second output at the target time step. In some embodiments, (i) the first output is obtained using the first data with the target time step and the first time step as conditioning inputs and (ii) the second output is obtained using the second data with the target time step and the second time step as conditioning inputs. In some embodiments, the computer-readable program code portions comprise an executable portion configured to obtain a trained generative AI model by updating parameters of the neural network. In some embodiments, the updating comprises at least computing a loss between a first distribution of the first output and a second distribution of the second output

### 2 PRELIMINARIES

### 2.1 Diffusion, Flow Matching, and Interpolants

Methods and systems herein can provide technical improvements over diffusion models, flow matching models, and stochastic interpolants. For a data distribution q(x), diffusion models, e.g., variance-preserving (VP) diffusion models (Ho et al., 2020; Song et al., 2020b; each of which is incorporated by reference herein in its entirety) and flow matching (FM) (Lipman et al., 2022; Liu et al., 2022; each of which is incorporated by reference herein in its entirety), may be used to construct time-augmented variables xₜ as an interpolation between data x~q(x) and prior ϵ~N(0, I) such that xₜ=αₜx+σₜϵ where α₀=σ₁=1, α₁=σ₀=0. VP diffusion may choose

$$\begin{matrix}{α}_{t} = cos ( \frac{π}{2} t ) , \\ {σ}_{t} = sin ( \frac{π}{2} t )\end{matrix}$$

and FM chooses αₜ=1−t, σₜ=t. Both v-prediction diffusion (Salimans & Ho, 2022; which is incorporated by reference herein in its entirety) and FM can be trained by matching the conditional velocity vₜ=αₜ′x+σₜ′ϵ such that a generative AI model, e.g., a neural network G_{θ}(xₜ, t) approximates E_{x,} _{_{ϵ}}[vₜ|xₜ]. Samples can then be generated via an ordinary differential equation (ODE), e.g., a probability-flow ordinary differential equation

$$( PF - ODE ) \frac{{dx}_{t}}{dt} = {G}_{θ} ( {x}_{t} , t )$$

starting from ϵ~N(0, I).

Stochastic interpolants. Unifying diffusion models and FM, interpolants, e.g., stochastic interpolants (Albergo et al., 2023; Albergo & Vanden-Eijnden, 2022; each of which is incorporated by reference herein in its entirety) construct a conditional interpolation qₜ(xₜ|x, ϵ)=N(Iₜ(x, ϵ), γₜ²I) between any data x~q(x) and prior ϵ−p(ϵ) and sets constraints I₁(x, ϵ)=ϵ, I₀(x, ϵ)=x, and γ=γ₀=0. Similar to FM, a sampler, e.g., a deterministic sampler can be learned by explicitly matching the conditional interpolant velocity vₜ=∂ₜIₜ(x, ϵ)+γ\dot{ }ₜ z where z~N(0, I) such that G_{θ}(xₜ, t)≈E_{x,} _{_{ϵz}}[vₜ|xₜ]. Sampling can be performed following the

$$PF - ODE \frac{{dx}_{t}}{dt} = {G}_{θ} ( {x}_{t} , t )$$

similarly starting from prior ϵ~p(ϵ).

In some embodiments, the prior sample comprises random noise. In some embodiments, the random noise is sampled from a random distribution. In some cases, the random noise is generated using a random number generator (RNG). In some embodiments, the prior distribution comprises a Gaussian distribution, a uniform random distribution, or a Dirichlet distribution.

When γₜ≡0 and Iₜ(x, ϵ)=αₜx+σₜϵ for αₜ, σₜ defined in FM, the intermediate variable xₜ=αₜx+σₜϵ becomes a deterministic interpolation and its interpolant velocity vₜ=αₜ′x+σₜ′ϵ can reduce to FM velocity. Thus, its training and inference can both reduce to that of FM. When ϵ~N(0, I), stochastic interpolants can reduce to v-prediction diffusion.

### 2.2 Maximum Mean Discrepancy

Methods and systems herein can train models based on computing loss using maximum mean discrepancy. In some embodiments, the computed loss is determined using maximum mean discrepancy. In some embodiments, the computed loss is determined based at least in part on a generative adversarial network (GAN) objective. In some embodiments, the maximum mean discrepancy is determined using a kernel function. In some embodiments, the kernel function comprises a Laplacian kernel. In some embodiments, the kernel function comprises a radial basis function (RBF) kernel.

Maximum mean discrepancy (MMD, Gretton et al. (2012); which is incorporated by reference herein in its entirety) between distribution p(x),q(y) for x, y ∈R^{D} is an integral probability metric (Muller, 1997; which is incorporated by reference herein in its entirety). MMD can be defined on Reproducing Kernel Hilbert Space (RKHS) H with a positive definite kernel k R^{D}×R^{D}→R as

$${MMD}^{2} ( p ( x ) , q ( y ) ) = {‖ {𝔼}_{x} [ k ( x , \cdot ) ] - {𝔼}_{y} [ k ( y , \cdot ) ] ‖}_{ℋ}^{2} \qquad ( 1 )$$

where the norm is in H. Choices such as the radial basis function (RBF) kernel may imply an inner product of infinite-dimensional feature maps consisting of all moments of p(x) and q(y), e.g., E[x^{j}] and E[y^{j}] for integer j>1 (Steinwart & Christmann, 2008; which is incorporated by reference herein in its entirety).

### 3 INDUCTIVE MOMENT MATCHING

The present disclosure provides methods and systems for inductive moment matching (IMM), a method that can train a model of both high fidelity and sampling efficiency in a single stage. To do so, a time-augmented interpolation between data (distribution at t=0) and prior (distribution at t=1) can be assumed. An implicit one-step model, e.g., a one-step sampler, that transforms the distribution at time t to the distribution at time s for any s<t may be learned (Section 3.1). The model can enable direct one-step sampling from t=1 to s=0, and few-step sampling via recursive application from a t to an r<t and then to an s<r until s=0; this allows the model to learn from its own samples via bootstrapping (Section 3.2).

### 3.1 Model Construction Via Interpolants

Methods and systems herein can provide for model construction via interpolants.

Given data x~q(x) and prior ϵ~p(ϵ), the time-augmented interpolation xₜ e.g., defined in Albergo et al. (2023) (which is incorporated by reference herein in its entirety), follows xₜ~qₜ(xₜ|x, ϵ). This implies a marginal interpolating distribution

$${q}_{t} ( {x}_{t} ) = \int \int {q}_{t} ( {x}_{t} \vert x , ϵ ) q ( x ) p ( ϵ ) dxd ϵ . \qquad ( 2 )$$

A model distribution, implicitly defined by a one-step sampler that transforms qₜ(xₜ) into qₛ(xₛ) for some s≤t, can be learned. This can be done via a special class of interpolants, which preserves the marginal distribution qₛ(xₛ) while interpolating between x and xₜ. These may be termed marginal-preserving interpolants among a class of generalized interpolants. Formally, xₛ may be defined as a generalized interpolant between x and xₜ if, for all s∈[0, t], its distribution follows q_{s|t}(xₛ|x, xₜ)=N(I_{s|t}(x, xₜ), γ_{s2|t}I) (3) and satisfies constraints I_{t|t}(x, xₜ)=xₜ, I_{0|t}(x, xₜ)=x, γ_{t|t}=γ_{0|t}=0, and qₜ|(xₜ|x, ϵ)≡qₜ(xₜ|x, ϵ). When t=1, it can reduce to regular stochastic interpolants. Next, marginal-preserving interpolants can be defined.

Definition 1 (Marginal-preserving interpolants). A generalized interpolant xₛ is marginal-preserving if for all t∈[0,1] and for all s∈[0, t], the following equality holds:

$${q}_{s} ( {x}_{s} ) = \int \int {q}_{s \vert t} ( {x}_{s} \vert x , {x}_{t} ) {q}_{t} ( x \vert {x}_{t} ) {q}_{t} ( {x}_{t} ) {dx}_{t} dx , \qquad ( 4 )$$

$$where$$

$${q}_{t} ( x \vert {x}_{t} ) = \int \frac{{q}_{t} ( {x}_{t} \vert x , ϵ ) q ( x ) p ( ϵ )}{{q}_{t} ( {x}_{t} )} d ϵ dx \qquad ( 5 )$$

That is, this class of interpolants has the same marginal at s regardless of t. For all t∈[0,1], the noisy model distribution may be defined at s∈[0, t] as

$${p}_{s \vert t}^{θ} ( {x}_{s} ) = \int \int {q}_{s \vert t} ( {x}_{s} \vert x , {x}_{t} ) {p}_{s \vert t}^{θ} ( x \vert {x}_{t} ) {q}_{t} ( {x}_{t} ) {dx}_{t} dx \qquad ( 6 )$$

where the interpolant is marginal preserving and

$${p}_{s \vert t}^{θ} ( x \vert {x}_{t} )$$

is the clean model distribution implicitly parameterized as a one-step sampler. This definition can also enable multistep sampling. To produce a clean sample x given xₜ~qₜ(xₜ) in two steps via an intermediate s:

$$\hat{x} ∼ {p}_{s \vert t}^{θ} ( x \vert {x}_{t} ) \qquad ( 1 )$$

can be sampled followed by \hat{x}ₛ~q_{s|t}(xₛ|x, xₜ) and (2) if the marginal of \hat{x}ₛ matches qₛ(xₛ), x can be obtained by

$$x ∼ {p}_{0 \vert t}^{θ} ( x \vert {x}_{t} ) .$$

Therefore, it can be useful to minimize divergence between Eq. (4) and (6) using the objective below.

Naïve objective. As one can easily draw samples from the model, it can be naïvely learned by directly minimizing

$$ℒ ( θ ) = {𝔼}_{s , t} [ D ( {q}_{s} ( {x}_{s} ) , {p}_{s \vert t}^{θ} ( {x}_{s} ) ) ] \qquad ( 7 )$$

with time distribution p(s,t) and a sample-based divergence metric D(⋅, ⋅) such as MMD or GAN (Goodfellow et al., 2020; which is incorporated by reference herein in its entirety). If an interpolant xₛ is marginal-preserving, then the minimum loss is 0 (see Lemma 3). One might also notice the similarity between right-hand sides of Eq. (4) and (6).

However,

$${q}_{s} ( {x}_{s} ) = {P}_{s \vert t}^{θ} ( {x}_{s} )$$

does not necessarily imply

$${P}_{s \vert t}^{θ} ( x \vert {x}_{t} ) = {q}_{t} ( x \vert {x}_{t} ) .$$

In fact, the minimize

$${p}_{s \vert t}^{θ} ( x \vert {x}_{t} )$$

is not unique and, under mild assumptions, a minimizer, e.g., a deterministic minimizer exists (see Section 4).

### 3.2 Learning Via Inductive Bootstrapping

Methods and systems herein can improve model training by using inductive learning methods that involve bootstrapping.

In some embodiments, the first time step is sampled from a first time distribution. In some embodiments, the target time step is sampled from a second time distribution, parametrized by the first time step. In some embodiments, the second time step is determined using a mapping function parametrized by the first time step and the target time step.

While sound, the naïve objective in Eq. (7) is difficult to optimize in practice because when t is far from s, the input distribution qₜ(xₜ) can be far from the target qₛ(xₛ). Fortunately, the interpolant construction implies that the model definition in Eq. (6) satisfies boundary condition qₛ

$$( {x}_{s} ) = {p}_{s \vert s}^{θ} ( {x}_{s} )$$

regardless of θ (see Lemma 4). This indicates that

$${P}_{s \vert t}^{θ} ( {x}_{s} ) \approx {q}_{s} ( {x}_{s} )$$

when t is close to s. Furthermore, the interpolant enforce

$${P}_{s \vert t}^{θ} ( {x}_{s} ) \approx {P}_{s \vert r}^{θ} ( {x}_{s} )$$

for any r<t close to t as long
as the model is continuous around t. Therefore, an inductive learning algorithm for

$${p}_{s \vert t}^{θ} ( {x}_{s} )$$

can be constructed using samples from

$${p}_{s \vert r}^{θ} ( {x}_{s} ) .$$

For improved analysis, a sequence number n for parameter θᵣ and function r(s,t) can be defined, where s≤r(s,t)<t such that

$${p}_{s \vert t}^{{θ}_{n}} ( {x}_{s} )$$

learns to match

$${p}_{s \vert r}^{θ} ( {x}_{s} )$$

r's arguments can be omitted when context is clear and r(s,t) may be a finite decrement from t but truncated at s≤t (see Example 2.3 for well-conditioned r(s,t)).

General objective. With marginal-preserving interpolants and mapping r(s,t), θₙ in the following objective can be learned:

$$ℒ ( {θ}_{n} ) = {𝔼}_{s , t} [ w ( s , t ) {MMD}^{2} ( {p}_{s \vert r}^{{θ}_{n - 1}} ( {x}_{s} ) , {p}_{s \vert t}^{{θ}_{n}} ( {x}_{s} ) ) ] \qquad ( 8 )$$

where w(s,t) is a weighting function. MMD may be chosen as the objective due to its superior optimization stability and this objective may be shown to learn the correct data distribution.

Theorem 1. Assuming r(s,t) is well-conditioned, the interpolant is marginal-preserving, and

$${θ}_{n}^{*}$$

is a minimizer of Eq. (8) for each n with infinite data and network capacity, for all t∈[0, 1], s∈[0, t],

$${lim}_{n \to ∞} {MMD}^{2} ( {q}_{s} ( {x}_{s} ) , {p}_{s \vert r}^{{θ}_{n}^{*}} ( {x}_{s} ) ) = 0 \qquad ( 9 )$$

In other words, θₙ eventually learns the target distribution qₛ(xₛ) by parameterizing a one-step sampler

$${p}_{s \vert t}^{{θ}_{n}} ( x \vert {x}_{t} ) .$$

### 4 SIMPLIFIED FORMULATION AND PRACTICE

The present disclosure provides algorithmic and practical decisions in their utility.

### 4.1 Algorithmic Considerations

Methods and systems herein can choose marginal-preserving interpolants to enable iterative model training. Despite theoretical soundness, it can be technically challenging to empirically choose a marginal-preserving interpolant. First, a sufficient condition for marginal preservation is presented.

In some embodiments, synthesizing the first data comprises sampling from a first marginal interpolating distribution parametrized by the observed data sample and the prior sample. In some embodiments, the first marginal interpolating distribution is determined using a denoising diffusion implicit model. In some embodiments, synthesizing the second data comprises sampling from a second marginal interpolating distribution parametrized by the observed data sample and the first data. In some embodiments, the second marginal interpolating distribution is determined using a denoising diffusion implicit model. In some embodiments, the first output comprises a first marginal preserving interpolant between the first data and the observed data. In some embodiments, the first marginal preserving interpolant preserves a marginal distribution of the first output for a plurality of time steps. In some embodiments, the second output comprises a second marginal preserving interpolant between the second data and the observed data. In some embodiments, the second marginal preserving interpolation preserves a marginal distribution of the second first output for a plurality of time steps.

Definition 2 (Self-consistent interpolants). Given s,t∈[0, 1], s≤t, an interpolant xₛ~q_{s|t}(xₛ|x, xₜ) is self-consistent if for all r∈[s,t], the following holds:

$${q}_{s \vert t} ( {x}_{s} \vert x , {x}_{t} ) = \int {q}_{s \vert r} ( {x}_{s} \vert x , {x}_{r} ) {q}_{r \vert t} ( {x}_{r} \vert x , {x}_{t} ) {dx}_{r} \qquad ( 10 )$$

In other words, xₛ has the same distribution if one (1) directly samples it by interpolating x and xₜ and (2) first samples any xᵣ (given x and xₜ) and then samples xₛ (given x and xᵣ). Furthermore, self-consistency implies marginal preservation (Lemma 5).

DDIM interpolant. Denoising diffusion implicit models (Song et al., 2020a; which is incorporated by reference herein in its entirety) can provide a fast ODE sampler for diffusion models, defined as

$$DDIM ( {x}_{t} , x , s , t ) = ( {α}_{s} - \frac{{σ}_{s}}{{σ}_{t}} {α}_{t} ) x + \frac{{σ}_{s}}{{σ}_{t}} {x}_{t} \qquad ( 11 )$$

and sample xₛ=DDIM(xₜ, Eₓ[x|xₜ], s,t) can be drawn when Eₓ[x|xₜ] is approximated by a network. Example 3.1 shows that DDIM as an interpolant, e.g., γ_{s|t}≡0 and I_{s|t}(x, xₜ)=DDIM(xₜ, x, s, t), is self-consistent. Moreover, with deterministic interpolants such as DDIM, there exists a minimizer, e.g., a deterministic minimizer

$${p}_{s \vert t}^{θ} ( x \vert {x}_{t} )$$

### of Eq. (7).

Proposition 1. (Informal) If γ_{s|t}≡0 and I_{s|t}(x, xₜ) satisfies mild assumptions, there exists a deterministic

$${p}_{s \vert t}^{θ} ( x \vert {x}_{t} )$$

that attains 0 loss for Eq. (7).

See Example 2.6 for formal statement and proof. This allows

$${P}_{s \vert t}^{θ} ( x \vert {x}_{t} ) = δ ( x - {g}_{θ} ( {x}_{t} , s , t ) )$$

to be defined for a generative AI model, e.g., a neural network g_{θ}(xₜ, s,t) with parameter θ by default.

Eliminating stochasticity. DDIM interpolant, deterministic model, and prior p(ϵ)=N(0, σ_{d}²I) may be used, where σ_{d} is the data standard deviation (Lu & Song, 2024; which is incorporated by reference herein in its entirety). As a result, one can draw xₛ from model via

$$x = {f}_{s , t}^{θ} ( {x}_{t} ) = DDIM ( {x}_{t} , {g}_{θ} ( {x}_{t} , s , t ) , s , t )$$

Re-using xₜ for xᵣ. Inspecting Eq. (8) and (6), xᵣ~qᵣ(xᵣ) can be used to generate samples from the target distribution. Instead of sampling xᵣ given a new (x, ϵ) pair, variance can be reduced by reusing xₜ and x such that xᵣ=DDIM(xₜ, x, r, t). This is justified because xᵣ derived from xₜ preserves the marginal distribution qᵣ(xᵣ) (see Example 3.2).

In some embodiments, the method further comprises applying a stop gradient operation on the second output when computing the loss.

Stop gradient. n can be set to optimization step number, e.g., advancing from n−1 to n is a single optimizer step where θₙ is initialized from θₙ₋₁. Equivalently, n can be omitted from θₙ and θₙ₋₁ may be written as the stop-gradient parameter θ⁻.

Simplified objective. Let xₜ, x′ₜbe i.i.d. random variables from qₜ(xₜ) and xₜ, x′ₜ are variables obtained by reusing xₜ, x′ₜ respectively, the training objective can be derived from the MMD definition in Eq. (1) (see Example 3.3) as

$${ℒ}_{IMM} ( θ ) = {𝔼}_{{x}_{t} , {x}_{t}^{′} , {x}_{r} , {x}_{r}^{′} , s , t} [ w ( s , t ) [ k ( {y}_{s , t} , {y}_{s , t}^{′} ) + k ( {y}_{s , r} , {y}_{s , r}^{′} ) - k ( {y}_{s , t} , {y}_{s , r}^{′} ) - k ( {y}_{s , r} , {y}_{s , t}^{′} ) ] ] \qquad ( 12 )$$

where

$${y}_{s , t} = {f}_{s , t}^{θ} ( {x}_{t} ) , {y}_{s , t}^{′} = {f}_{s , t}^{θ} ( {x}_{t}^{′} ) , {y}_{s , t} = {f}_{s , r}^{θ} ( {x}_{r} ) , {y}_{s , r}^{′} = {f}_{s , r}^{θ} ( {x}_{r}^{′} ) , k ( \cdot , \cdot )$$

is a kernel function, and w(s,t) is a prior weighting function.

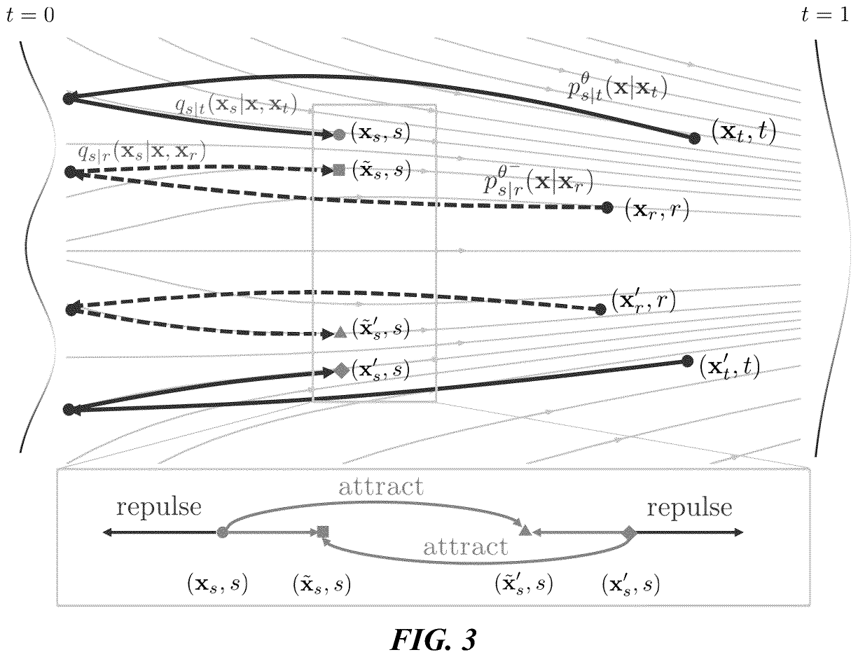

An empirical estimate of the above objective uses M particle samples to approximate each distribution indexed by t. In practice, a batch of model output with size B may be divided into B/M groups within which share the same (s,t) sample, and the objective is approximated by instantiating B/M number of M×M matrices. Note that the number of model passes does not change with respect to M (see Example 3.4). A M=2 version is visualized in FIG. 3 and a simplified training algorithm is shown in Algorithm 1. A full training algorithm is shown in Example 4.

### 4.2 Other Implementation Choices

Methods and systems herein can provide various functions and mathematical relations for use in training the generative AI model. Detailed analysis of each decision is described in Example 3.

Flow trajectories. Two flow trajectories (Nichol & Dhariwal, 2021; Lipman et al., 2022; each of which is incorporated by reference herein in its entirety) can be investigated for utility.

Cosine.

$${α}_{t} = cos ( \frac{1}{2} π t ) , {σ}_{t} = sin ( \frac{1}{2} π t ) .$$

Optimal transport (OT)-FM. αₜ=1−t, σₜ=t.

Network g_{θ}(xₜ,s,t). g_{θ}(xₜ,s,t)=cₛₖᵢₚ(t)xₜ+cₒᵤₜ(t)G_{θ}(cᵢₙ(t)xₜ, cₙₒᵢₛₑ(s), cₙₒᵢₛₑ (t)) may be set with a generative AI model, e.g., a neural network G_{θ}, following elucidating the design Space of diffusion-based generative models (EDM, Karras et al., 2022; which is incorporated by reference herein in its entirety). Let cᵢₙ(t)=1/(αₜ²+σₜ²)/σ_{d} (Lu & Song, 2024; which is incorporated by reference herein in its entirety). Listed below are valid choices for other coefficients.

Identity. cₛₖᵢₚ(t)=0, cₒᵤₜ(t)=1.

Simple-EDM (Lu & Song, 2024; which is incorporated by reference herein in its entirety).

$${c}_{skip} ( t ) = {α}_{t} / ( {α}_{t}^{2} + {σ}_{t 2} ) , {c}_{out} ( t ) = - {σ}_{d} {σ}_{t} / p {σ}_{t 2} + {σ}_{t 2} .$$

Euler-FM. cₛₖᵢₚ(t)=1, cₒᵤₜ(t)=−tσ_{d}. This can be specific to OT-FM schedule.

Example 3.5 shows that

$${f}_{s , t}^{θ} ( {x}_{t} )$$

similarly follows the EDM parameterization of the form

$${f}_{s , t}^{θ} ( {x}_{t} ) = {c}_{skip} ( s , t ) {x}_{t} + {c}_{out} ( s , t ) {G}_{θ} ( {c}_{in} ( t ) {x}_{t} , {c}_{noise} ( s ) , {c}_{noise} ( t ) ) .$$

Noise conditioning cₙₒᵢₛₑ(⋅). cₙₒᵢₛₑ(t)=ct can be chosen for some constant c≥1. The model convergence can be relatively insensitive to c, but larger c, e.g., 1000, can be useful (Song et al., 2020b; Peebles & Xie, 2023; each of which is incorporated by reference herein in its entirety), because it enables sufficient distinction between nearby r and t.

Mapping function r(s,t). r(s,t) via constant decrement ηₜ=σₜ/αₜ works well where the decrement is chosen in the form of (ηₘₐₓ−ηₘᵢₙ)/2^{k} for some appropriate k (details in Example 3.7).

Kernel function. Kernel functions, e.g., time-dependent Laplace kernels of the form k_{s,t}(x, y)=exp(−w^{~}(s, t)max(∥x-y∥₂, ϵ)/D) for x, y ∈R^{D}, some ϵ>0 may be used to avoid undefined gradients, and w^{~}(s,t)=1/|cₒᵤₜ(s,t)|. Laplace kernels can provide better gradient signals than RBF kernels. (see Example 3.8).

Weighting w(s,t) and distribution p(s,t). Diffusion models, e.g., variational diffusion models (VDM) may be used (Kingma et al., 2021; Kingma & Gao, 2024; each of which is incorporated by reference herein in its entirety) and p(t)=U(ϵ, T) and p(s|t)=U(ϵ, t) may be defined for constants ϵ, T ∈[0,1]. Similarly, weighting can be defined as

$$( s , t ) = \frac{1}{2} σ ( b - {λ}_{t} ) ( - \frac{d}{dt} {λ}_{t} ) ( \frac{{α}_{t}^{2}}{{α}_{t}^{2} + {σ}_{t}^{2}} ) \qquad ( 13 )$$

where σ(⋅) is sigmoid function, λₜ denotes log-signal-noise ratio (SNR), and a∈{1,2}, σ(⋅), b∈R are constants (see Example 3.9).

### 4.3 Sampling

Methods and systems herein can provide various sampling strategies for more efficient model training.

Pushforward sampling. A sample x, can be obtained by directly pushing xₜ~qₜ(xₜ) through

$${f}_{s , t}^{θ} ( {x}_{t} ) .$$

This can be iterated for an arbitrary number of steps starting from ϵ~N(0, σ_{d}²I) until s=0. By definition, one application of

$${f}_{s t}^{θ} ( {x}_{t} )$$

can be equivalent to one DDIM step using the learned network g_{θ}(xₜ,s,t) as the x prediction. This sampler can then be viewed as a few-step sampler using DDIM where g_{θ}(xₜ, s, t) outputs a realistic sample x instead of its expectation Eₓ[x|xₜ], as in diffusion models.

Restart sampling. Stochasticity can be introduced during sampling (Xu et al., 2023; Song et al., 2023; each of which is incorporated by reference herein in its entirety) by re-noising a sample to a higher noise-level before sampling again. For example, a two-step restart sampler from xₜrequires s∈(0, t) for drawing sample

$$\hat{x} = {f}_{0 , s}^{θ} ( {x}_{s} )$$

where

$${x}_{s} ∼ {q}_{s} ( {x}_{s} \vert {f}_{0 , t}^{θ} ( {x}_{t} ) ) .$$

Classifier-free guidance. Given a data-label pair (x, c), during inference time, guidance, e.g., classifier-free guidance (Ho & Salimans, 2022; which is incorporated by reference herein in its entirety) with weight w can replace conditional model output G_{θ}(xₜ, s, t, c) by a reweighted model output via

$$w {G}_{θ} ( {x}_{t} , s , t , c ) + ( 1 - w ) {G}_{θ} ( {x}_{t} , s , t , ∅ ) \qquad ( 14 )$$

where Ø denotes the null-token indicating unconditional output. Similarly, the guided model can be defined as f_{s,t, w}^{θ}(xₜ)=cₛₖᵢₚ(s,t)xₜ+cₒᵤₜ(s,t)G^{w}_{θ}(xₜ,s,t, c), where G^{w}_{θ}(xₜ,s,t, c) is as defined in Eq. (14) and drop cᵢₙ(⋅) and cₙₒᵢₛₑ(⋅) can be dropped for notational simplicity. This decision is justified in Example 5. Similar to diffusion models, c can be randomly dropped with probability p during training without special practices.

Algorithm 1. Training (see Example 4 for complete description):

```
Input: parameter θ, DDIM(xₜ,x,s,t), B, M, p
Output: learned θ
while model not converged do
  Sample data x, label c, and prior ∈ with batch size
  B and split into B/M groups. Each group shares a (s,r,t) sample.
  For each group, xₜ ← DDIM(∈,x,t, 1).
  For each group, xᵣ ← DDIM(xₜ,x,r,t).
  For each instance, set c = Ø with prob. p.
  Minimize the empirical loss L\hat{ }_{IMM}(θ) in Eq. (67).
end while
```

Algorithm 2. Pushforward sampling (see Example 6 for complete description):
$Input : model {f}^{θ} , {\{ {t}_{i} \}}_{i = 0}^{N} , 𝒩 ( 0 , {σ}_{d}^{2} I ) , ( optional ) w$
Output: xₜ_{₀}
$Sample {x}_{{t}_{N}} ∼ 𝒩 ( 0 , {σ}_{d}^{2} I )$
for i = N, ... , 1 do
${x}_{{t}_{i - 1}} ← {f}_{{t}_{i - 1} , {t}_{i}}^{θ} ( {x}_{t} ) or {f}_{{t}_{i - 1} , {t}_{i} , w}^{θ} ( {x}_{t} ) .$
end for

Pushforward sampling is presented in Algorithm 2, and both samplers are described in Example 6.

### 5 CONSISTENCY OF METHODS HEREIN

Methods and systems herein can provide machine learning models that are consistent in formulation or implementation with additional generative AI models.

Detailed description and analysis are found in Example 7.

Consistency models. Consistency models (CMs) (Song et al., 2023; Song & Dhariwal, 2023; Lu & Song, 2024; which is incorporated by reference herein in its entirety) can use a network g_{θ}(xₜ, t) that outputs clean data given noisy input xₜ. It can utilize point-wise consistency g_{θ}(xₜ, t)=g_{θ}(xᵣ, r) for any r<t where xᵣ is obtained via an ODE solver from xₜ using a pretrained model or ground truth data. CMs, e.g., discrete-time CM can satisfy g_{θ}(x₀, 0)=x₀ and train via loss E_{t,} _{_{x, t}}[d(g_{θ}(xₜ, t), g_{θ}(xᵣ, r))] where d(⋅, ⋅) can be chosen as L₂ or learned perceptual image patch similarity (LPIPS) (Zhang et al., 2018; which is incorporated by reference herein in its entirety).

It may be shown in the following Lemma that CM objective with L₂ distance is a single-particle estimate of IMM objective with energy kernel.
Lemma 1. When xₜ=xₜ′, xᵣ=xᵣ′, k(x, y)=−∥x-y∥², and s>0 is a small constant, Eq. (12) reduces to CM loss [symbol] ₓ_{ₜ}_{, x, t}[w(t)∥g_{θ}(xₜ, t)−g_{∂}−(xᵣ, r)∥²] for some valid mapping r(t)<t.

This single-particle estimate ignores the repulsion force imposed by k(⋅, ⋅). Energy kernel matches the first moment, ignoring all higher moments. These decisions can be significant contributors to training instability and performance degradation of CMs.

Improved CMs (Song & Dhariwal, 2023; which is incorporated by reference herein in its entirety) propose a loss, e.g., pseudohuber loss as d(⋅, ⋅) which may be justified in the Lemma below.
Lemma 2. Negative pseudo-huber loss k_{c}(x, y)=c−\sqrt{∥x-y∥²+c²} for c>0 is a conditionally positive definite kernel that matches all moments ofx and y where weights on higher moments depend on c.

From a moment-matching perspective, the improved performance can be explained by the loss matching all moments of the distributions. In addition to pseudo-huber loss, many other kernels (e.g., Laplace, RBF, etc.) are all valid choices in the design space.

IMM loss can be extended to the differential limit by taking r(s,t)→t. The result can subsume the continuous-time CM (Lu & Song, 2024; which is incorporated by reference herein in its entirety) as a single-particle estimate (see Example 8).

Diffusion GAN and adversarial consistency distillation. GAN, e.g., diffusion GAN (Xiao et al., 2021; which is incorporated by reference herein in its entirety) can parameterize the generative distribution as

$${P}_{s \vert t}^{θ} ( {x}_{s} \vert {x}_{t} ) = \int \int {q}_{s \vert t} ( {x}_{s} \vert x , {x}_{t} ) δ ( x - {G}_{θ} ( {x}_{t} , z , t ) ) dzdx$$

for s as a fixed decrement from t and p(z) a noise distribution. It defines the interpolant q_{s|t} (xₛ|x, xₜ) as the DDPM posterior distribution, which is self-consistent (see Example 7.2) Diffusion GAN can introduce randomness to the sampling process to match qᵣ(x|xₜ) instead of the marginal. Both Diffusion GAN and adversarial consistency distillation (Sauer et al., 2025; which is incorporated by reference herein in its entirety) can use GAN objective, which shares similarity to MMD in that MMD is defined as an integral probability metric where the discriminator can be chosen in RKHS. This can eliminate the need for explicit adversarial optimization of a neural-network discriminator.

Generative moment matching network (GMMN). GMMN (Li et al., 2015; which is incorporated by reference herein in its entirety) directly applies MMD to train a generator G_{θ}(z) where z~N(0, I) to match the data distribution. It is a special case of IMM in that when t=1 and r(s,t)≡s=0, the loss reduces to naïve GMMN objective.

### 6 FURTHER DESCRIPTION OF TECHNICAL PROBLEMS AND SOLUTIONS

Methods and systems herein can provide technical improvements in training and generative performance, compared to other generative models.

Diffusion, flow matching, and stochastic interpolants. Diffusion models (Sohl-Dickstein et al., 2015; Song et al., 2020b; Ho et al., 2020; Kingma et al., 2021; each of which is incorporated by reference herein in its entirety) and flow matching (Lipman et al., 2022; Liu et al., 2022; each of which is incorporated by reference herein in its entirety) are generative frameworks that can learn a score or velocity field of a noising process from data into a simple prior. They can be scaled for text-to-image tasks (Rombach et al., 2022; Saharia et al., 2022; Podell et al., 2023; Chen et al., 2023; Esser et al., 2024; each of which is incorporated by reference herein in its entirety) or text-to-video tasks (Ho et al., 2022a; Blattmann et al., 2023; OpenAI, 2024; each of which is incorporated by reference herein in its entirety).

Interpolants, e.g., stochastic interpolants (Albergo et al., 2023; Albergo & Vanden-Eijnden, 2022; each of which is incorporated by reference herein in its entirety) can extend these ideas by defining a stochastic path between data and prior, then matching its velocity to facilitate distribution transfer. IMM can provide technical solutions that improve on top of the interpolant construction by directly learning one-step mappings between any intermediate marginal distributions.

Diffusion distillation. To resolve diffusion models' sampling inefficiency, methods (Salimans & Ho, 2022; Meng et al., 2023; Yin et al., 2024; Zhou et al., 2024; Luo et al., 2024a; Heek et al., 2024; each of which is incorporated by reference herein in its entirety) may focus on distilling one-step or few-step models from pre-trained diffusion models. Some approaches (Yin et al., 2024; Zhou et al., 2024; each of which is incorporated by reference herein in its entirety) propose jointly optimizing two networks, but the training relies on careful tuning in practice and can lead to mode collapse (Yin et al., 2024; which is incorporated by reference herein in its entirety). Another method (Salimans et al., 2024; which is incorporated by reference herein in its entirety) matches the first moment of the data distribution available from pre-trained diffusion models. IMM can improve on the diffusion distilling methods by implicitly matching moments using MMD, and allow for training from scratch with a single model.

Few-step generative AI models from scratch. Early one-step generative AI models may rely on GANs (Goodfellow et al., 2020; Karras et al., 2020; Brock, 2018; each of which is incorporated by reference herein in its entirety) and MMD (Li et al., 2015; 2017; each of which is incorporated by reference herein in its entirety) (or their combination) but scaling adversarial training may remain challenging. Independent classes of few-step models, e.g. consistency models (CMs) (Song et al., 2023; Song & Dhariwal, 2023; Lu & Song, 2024; each of which is incorporated by reference herein in its entirety), consistency trajectory models (CTMs) (Kim et al., 2023; Heek et al., 2024; each of which is incorporated by reference herein in its entirety) and shortcut models (SMs) (Frans et al., 2024; which is incorporated by reference herein in its entirety) may face training instability and may require specialized components (Lu & Song, 2024; which is incorporated by reference herein in its entirety) (e.g., Jacobian-vector product (JVP) for flash attention) or other special practices. High weight decay may be used for SMs, combined LPIPS (Zhang et al., 2018; which is incorporated by reference herein in its entirety) or GAN losses may be used for CTMs, and special training schedules (Geng et al., 2024; which is incorporated by reference herein in its entirety) can be used to improve stability. IMM improves on the GANs and few-step models, as it can be trained stably with a single loss and can achieve strong performance without special training practices.

### 7 DEMONSTRATION OF METHODS AND SYSTEMS HEREIN

IMM's empirical performance (Section 7.1), training stability (Section 7.2), sampling choices (Section 7.3), scaling behavior (Section 7.4), and practical decisions ablation (Section 7.5) are demonstrated herein.

### 7.1 Image Generation

Methods and systems herein can provide trained generative AI models that are capable of generating high-fidelity data, e.g., images, video, audio, text, and the like, that are statistically similar to training datasets.

In some embodiments, the method comprises prompting the trained generative AI model with at least a request for a type of data and a category of data. In some embodiments, the type of data comprises a data modality (e.g., image, video, text, etc.). In some embodiments, the category of data comprises a content, a structure, or a topic of the data. In some embodiments, the type of data and the category of data matches a type and a category of the observed data. In some embodiments, the method further comprises generating, using the trained generative AI model, new data based at least on the prompting. In some embodiments, the new data comprises the type of data and the category of data.

In some embodiments, the new data is determined to be statistically similar to the observed data. The new data may be statistically similar to the observed data if a distribution of the new data is statistically similar to the data distribution of the observed data. In some embodiments, the statistical similarity between the new data and the observed data may be determined based on comparing one or more values of the new data with one or more values of the observed data. In some embodiments, the statistical similarity between the new data and the observed data may be determined based on comparing one or more parameters of the data distribution of the observed data and the distribution of the new data.

In some embodiments, the new data is determined to be statistically similar to the observed data with a Fréchet inception distance (FID) of less than about 2.5. The FID may measure a distance between the distribution of the new data and the observed data distribution. The FID may be determined based on determining a mean or a covariance of the distribution of the new data and the observed data distribution. The FID may be computed based at least in part on the mean or the covariance of the distribution of the new data and the observed data distribution. In some embodiments, the FID is at least or at most about 1, 1.5, 2, 2.5, 3, 3.5, 4, 4.5, 5, 5.5, 6, 6.5, 7, 7.5, 8, 8.5, 9, 9.5, 10, or any increment therein.

In some embodiments, the method further comprises automatically rendering the new data on a graphical user interface (GUI), wherein the GUI comprises dynamically selectable objects or elements to modify the new data or append additional data to the new data in real time. In some embodiments, the new data may be modified to update one or more features, to save the new data, or to delete the new data. In some embodiments, the additional data comprises additionally generated data or additionally obtained data, e.g., with one or more sensors.

FID (Heusel et al., 2017; which is incorporated by reference herein in its entirety) results may be presented for unconditional CIFAR-10 and class-conditional ImageNet-256×256 in Table 1 and 2. For CIFAR-10, baselines may be separated into diffusion and flow models, distillation models, and few-step models from scratch. IMM belongs to the last category in which it can achieve state-of-the-art performance of 1.98 using pushforward sampler. For ImageNet-256×256, transformer architectures, e.g., the popular Diffusion models with Transformers (DiT) (Peebles & Xie, 2023; which is incorporated by reference herein in its entirety) architecture may be used because of its scalability. INMM can be compared with GANs, masked and autoregressive models, diffusion and flow models, and few-step models trained from scratch.

TABLE 1
CIFAR-10 results trained without label conditions

| | | FID | Steps |
|---|---|---|---|
| Family | Method | (↓) | (↓) |
| Diffusion | DDPM (Ho et al., 2020) | 3.17 | 1000 |
| & Flow | DDPM++ (Song et al., 2020b) | 3.16 | 1000 |
| | NCSN++ (Song et al., 2020b) | 2.38 | 1000 |
| | DPM-Solver (Lu et al., 2022) | 4.70 | 10 |
| | iDDPM (Nichol & Dhariwal, 2021) | 2.90 | 4000 |
| | EDM (Karras et al., 2022) | 2.05 | 35 |
| | Flow Matching (Lipman et al., 2022) | 6.35 | 142 |
| | Rectified Flow (Liu et al., 2022) | 2.58 | 127 |
| Few-Step via | PD (Salimans & Ho, 2022) | 4.51 | 2 |
| Distillation | 2-Rectified Flow (Salimans & Ho, 2022) | 4.85 | 1 |
| | DFNO (Zheng et al., 2023) | 3.78 | 1 |
| | KD (Luhman & Luhman, 2021) | 9.36 | 1 |
| | TRACT (Berthelot et al., 2023) | 3.32 | 2 |
| | Diff-Instruct (Luo et al., 2024a) | 5.57 | 1 |
| | PID (LPIPS) (Tee et al., 2024) | 3.92 | 1 |
| | DMD (Yin et al., 2024) | 3.77 | 1 |
| | CD (LPIPS) (Song et al., 2023) | 2.93 | 2 |
| | CTM (w/GAN) (Kim et al., 2023) | 1.87 | 2 |
| | SiD (Zhou et al., 2024) | 1.92 | 1 |
| | SiM (Luo et al., 2024b) | 2.06 | 1 |
| | sCD (Lu & Song, 2024) | 2.52 | 2 |
| Few-Step | iCT (Song & Dhariwal, 2023) | 2.83 | 1 |
| from Scratch | ECT (Geng et al., 2024) | 2.46 | 2 |
| | sCT (Lu & Song, 2024) | 3.60 | 1 |
| | MMSD (ours) | 2.11 | 2 |
| | | 2.97 | 1 |
| | | 2.06 | 2 |
| | | 2.93 | 1 |
| | | 2.05 | 2 |

TABLE 2
Class-conditional ImageNet-256 × 256 results

| Family | Method | FID(↓) | Steps (↓) | #Params |
|---|---|---|---|---|
| GAN | BigGAN (Brock, 2018) | 6.95 | 1 | 112M |
| | GigaGAN (Kang et al., 2023) | 3.45 | 1 | 569M |
| | StyleGAN-XL (Karras et al., 2020) | 2.30 | 1 | 166M |
| Masked | VQGAN (Esser et al., 2021) | 26.52 | 1024 | 227M |
| & AR | MaskGIT (Chang et al., 2022) | 6.18 | 8 | 227M |
| | MAR (Li et al., 2024) | 1.98 | 64 | 166M |
| | VAR-d20 (Tian et al., 2024a) | 2.57 | 10 | 600M |
| | VAR-d30 (Tian et al., 2024a) | 1.92 | 10 | 2B |
| Diffusion | ADM (Dhariwal & Nichol, 2021) | 10.94 | 250 | 554M |
| & Flow | CDM (Ho et al., 2022b) | 4.88 | 8100 | — |
| | SimDiff (Hoogeboom et al., 2023) | 2.77 | 512 | 2B |
| | LDM-4-G (Rombach et al., 2022) | 3.60 | 250 | 400M |
| | U-DiT-L (Tian et al., 2024b) | 3.37 | 250 | 916M |
| | DiT-XL/2 (w = 1.0) (Peebles & Xie, 2023) | 9.62 | 250 | 675M |
| | DiT-XL/2 (w = 1.25) (Peebles & Xie, 2023) | 3.22 | 250 | 675M |
| | DiT-XL/2 (w = 1.5) (Peebles & Xie, 2023) | 2.27 | 250 | 675M |
| | SiT-XL/2 (w = 1.0) (Ma et al., 2024) | 9.35 | 250 | 675M |
| | SiT-XL/2 (w = 1.5) (Ma et al., 2024) | 2.15 | 250 | 675M |
| Few-Step | iCT (Song et al, 2023) | 34.24 | 1 | 675M |
| from Scratch | Shortcut (Frans et al., 2024) | 20.3 | 2 | 675M |
| | MMSD (ours) (XL/2, w = 1.25) | 10.60 | 1 | 675M |
| | MMSD (ours) (XL/2, w = 1.5) | 7.80 | 4 | 675M |
| | | 3.80 | 128 | 675M |
| | | 7.12 | 1 | 675M |
| | | 4.87 | 2 | 675M |
| | | 3.36 | 4 | 675M |
| | | 2.80 | 8 | 675M |
| | | 7.97 | 1 | 675M |
| | | 4.01 | 2 | 675M |
| | | 2.61 | 4 | 675M |
| | | 2.13 | 8 | 675M |

Decreasing FID can be observed with more steps and INMM can achieve 1.99 FID with 8 steps (with w=1.5), surpassing DiT and SiT (Ma et al., 2024; which is incorporated by reference herein in its entirety) using the same architecture except for injecting time s (see Example 9). Notably, the methods disclosed herein also achieve better 8-step FID than the 10-step visual autoregressive modeling (VAR) (Tian et al., 2024a; which is incorporated by reference herein in its entirety) of comparable size. At 16 steps, IMM also achieves 1.90 FID outperforming VAR's 2B variant (see Example 9). However, different from VAR, IMM grants flexibility of variable number of inference steps and the large improvement in FID from 1 to 8 steps additionally demonstrates IMM's efficient inference-time scaling capability. Lastly, the IMM model similarly surpass Shortcut models' (Frans et al., 2024; which is incorporated by reference herein in its entirety) best performance with only 8 steps. Inference details are described in Section 7.3 and Example 9.2.

### 7.2. IMM Training is Stable

Methods and systems herein can provide trained generative AI models that are stable in performance across various settings. In some embodiments, the trained generative AI model comprises a stable model trained in one stage.

IMM is stable and achieves improved performance across a range of parameterization choices.

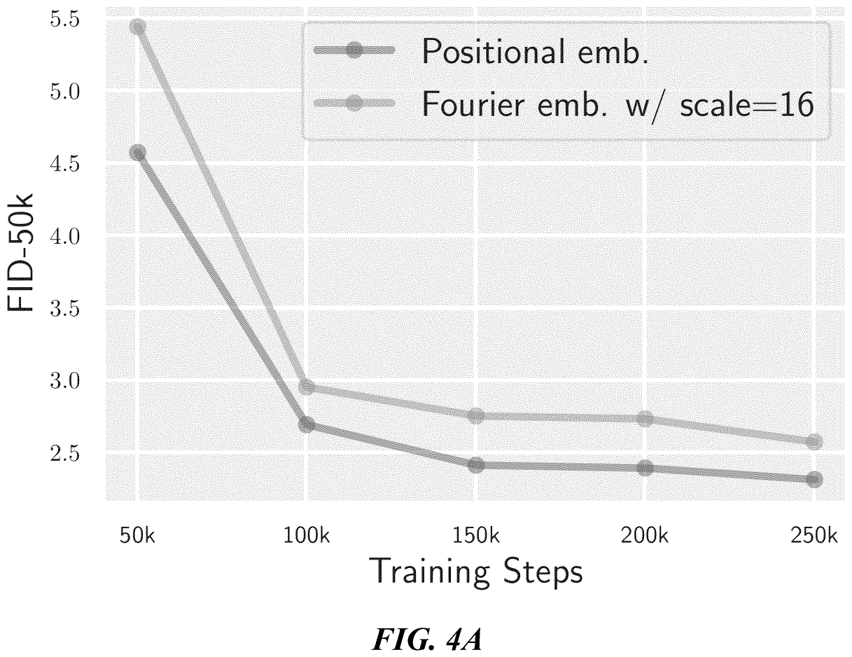

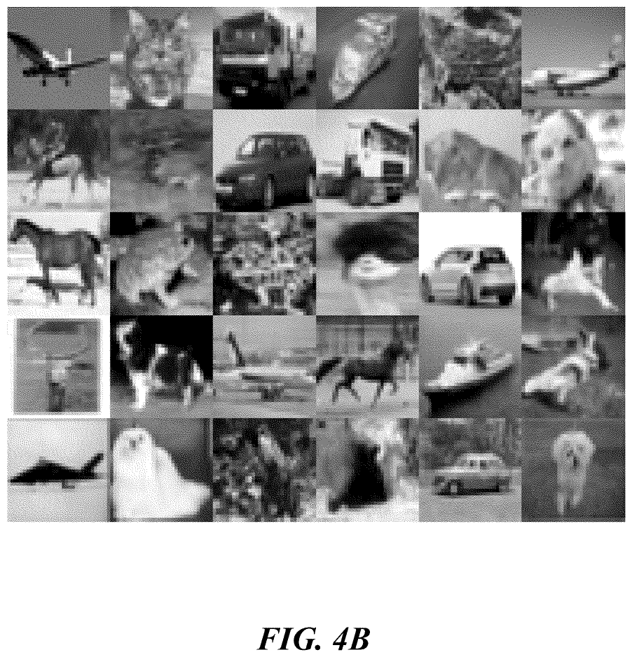

Positional vs. Fourier embedding. A technical problem with CMs (Song et al., 2023; which is incorporated by reference herein in its entirety) is its training instability when using Fourier embedding with scale 16, which may force reliance on positional embeddings for stability. FIGS. 4A-4B show that IMM does not face this problem. For Fourier embedding, the standard NCSN++ may be used (Song et al., 2020b; which is incorporated by reference herein in its entirety), and architecture and embedding scale may be set to 16. For positional embeddings, DDPM++ can be adopted (Song et al., 2020b; which is incorporated by reference herein in its entirety). Both embedding types can converge reliably, and samples from the Fourier embedding model are included in FIGS. 4A-4B.

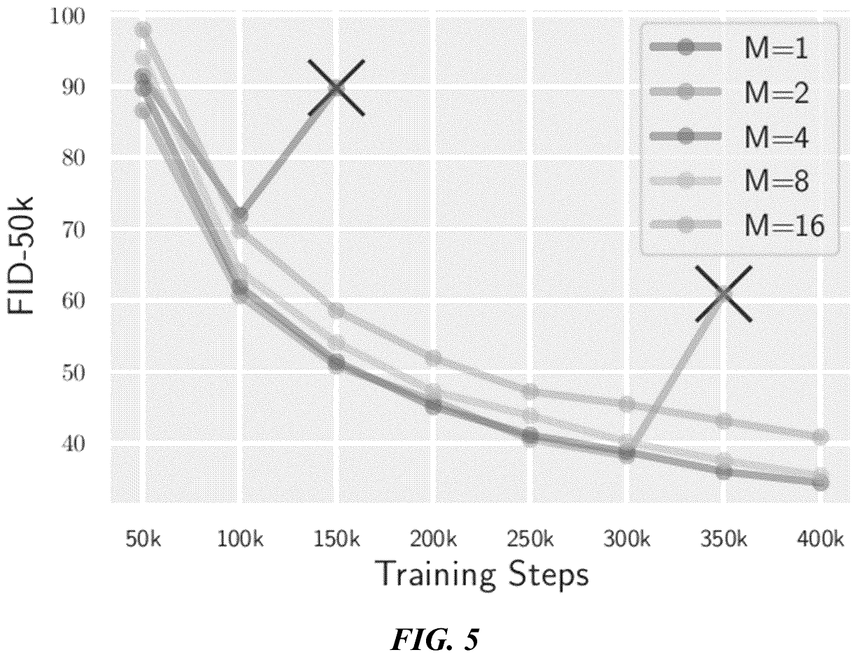

Particle number. Particle number M for estimating MMD may be an important parameter for empirical success (Gretton et al., 2012; Li et al., 2015; each of which is incorporated by reference herein in its entirety), where the estimate may be more accurate with larger M. In this case, increasing M can slow down convergence because a fixed batch size B is used, in which the samples are grouped into B/M groups of M, where each group shares the same t. The larger M may mean that fewer's are sampled. On the other hand, using small numbers of particles, e.g., M=2, may lead to training instability and performance degradation, especially on a large scale, e.g., with DiT architectures. As shown in FIG. 5, there may exist an optimal spot where a few particles effectively help with training stability while further increasing M slows down convergence. In ImageNet256×256, training may collapse when M=1 (e.g., as used in CM) and M=2, and lowest FID may be achieved under the same computation budget with M=4. M<4 may not allow sufficient mixing between particles and larger M means fewer t's are sampled for each step, thus slowing convergence. It may be useful to use a large enough M for stability, but not too large for slowed convergence.

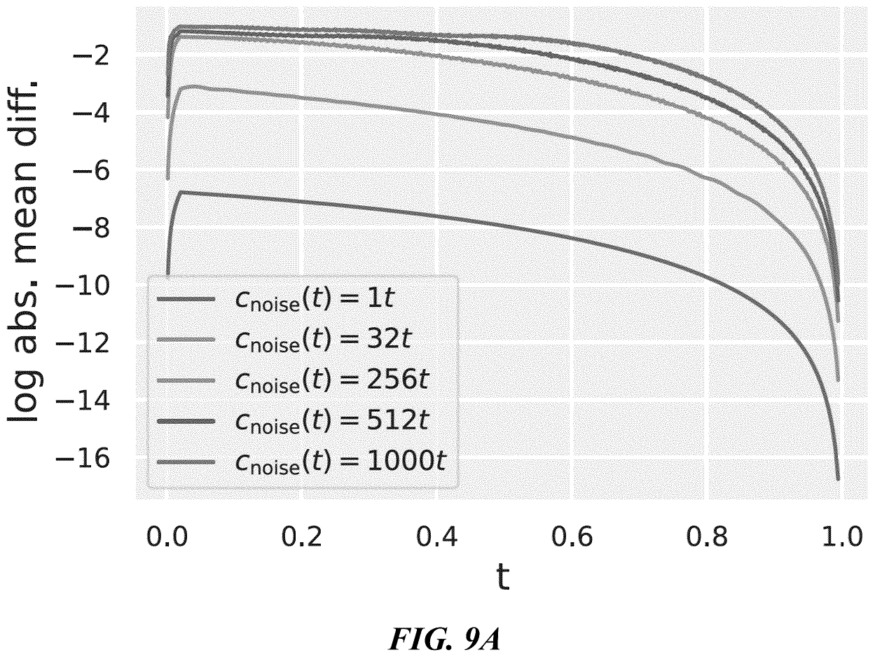

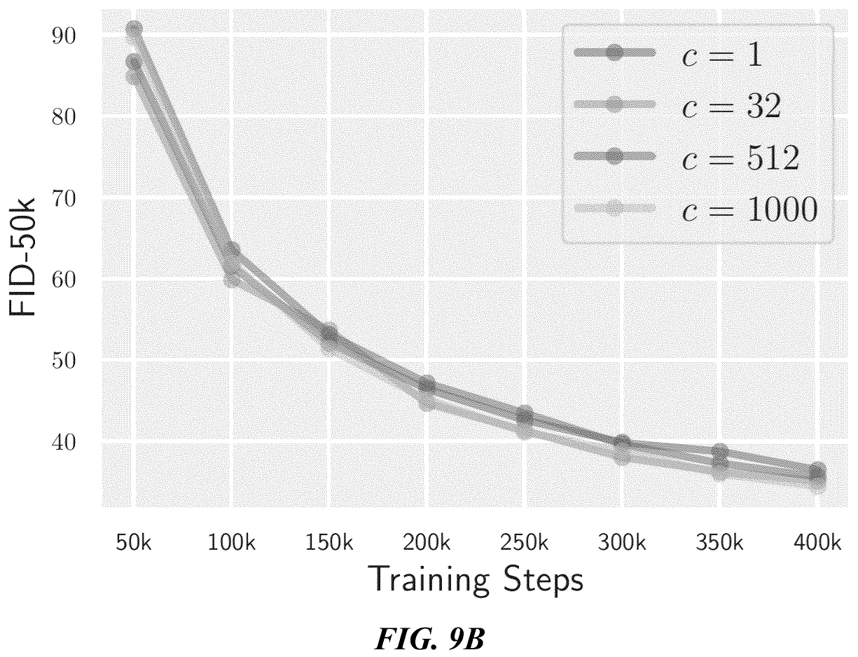

Noise embedding cₙₒᵢₛₑ(⋅). FIG. 9A shows the log absolute mean difference of t and r(s, t) in the positional embedding space. Increasing c can increase distinguishability of nearby distributions. FIG. 9B shows that similar convergence on ImageNet-256×256 across different c can be observed, demonstrating the insensitivity of the framework with respect to noise function.

### 7.3 Sampling

Methods and systems herein can provide efficient sampling methodologies for training a generative AI model.

In some embodiments, the method comprises repetitively synthesizing a third data or more data at successive time steps, based on data synthesized at a previous time step. In some embodiments, the successive time steps are between the target time step and the first time step. In some embodiments, the successive time steps are between the target time step and the second time step. In some embodiments, the successive time steps follow a chronological order. For example, the second time step may be between the target time step and the first time step, the third time step may be between the target time step and the second time step, etc. In some embodiments, the successive time steps comprise at least or at most about 1, 2, 3, 4, 5, 6, 7, 8, 9, 10, 15, 20, 25, 30, 35, 40, 45, or 50 time steps.

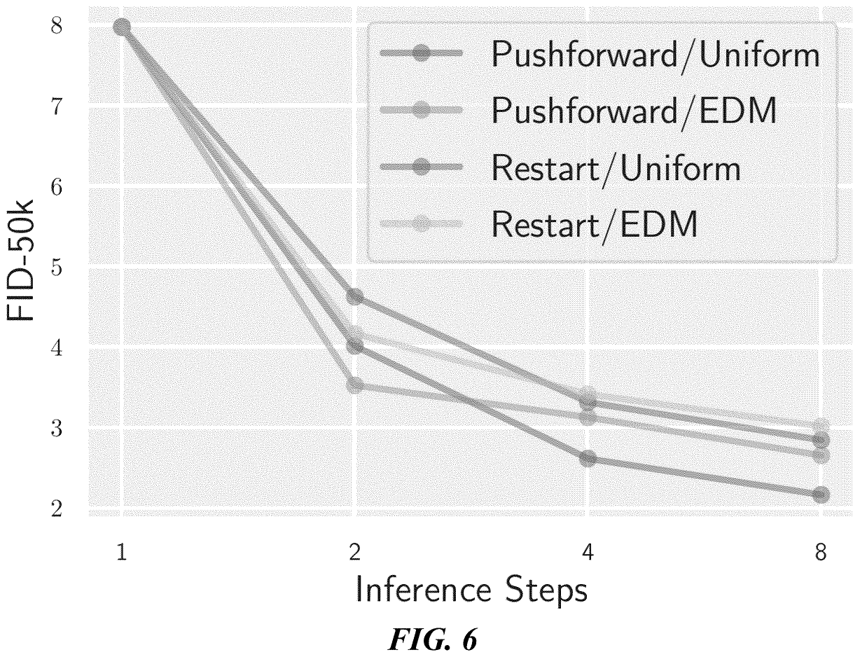

Different sampling settings may be investigated for best performance. One-step sampling can be performed by simple pushforward from T to ϵ (concrete values in Example 9.2). On CIFAR-10, 2 steps are used and intermediate time t₁ is set such that ηₜ₁=1.4, a choice that works well empirically. On ImageNet-256×256, more than 2 steps are used and, for simplicity, (1) uniform decrement in t and (2) elucidating the design Space of diffusion-based generative models (EDM) (Karras et al., 2024; which is incorporated by reference herein in its entirety) schedule (detailed in Example 9.2) are investigated. FID of various sampler settings are shown FIG. 6 with guidance weight w=1.5. Pushforward samplers with uniform schedule can work the best on ImageNet256×256 and can be used as the default setting for multi-step generation. Additionally, pushforward combined with restart samplers can achieve superior results.

TABLE 3
FID results with different flow schedules
and network parameterization.

| | id/cos | id/FM | sEDM/cos | sEDM/FM | eFM |
|---|---|---|---|---|---|
| CIFAR-10 | 3.77 | 3.45 | 2.39 | 2.10 | 2.53 |
| ImageNet- | 46.44 | 47.32 | 27.33 | 28.67 | 27.01 |
| 256 × 256 | | | | | |

### 7.4 Scaling Behavior

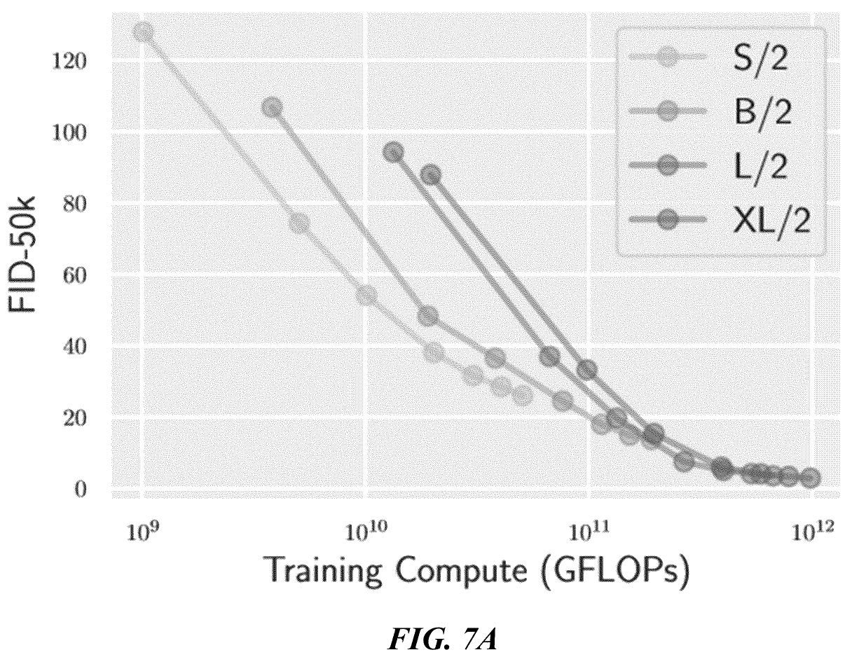

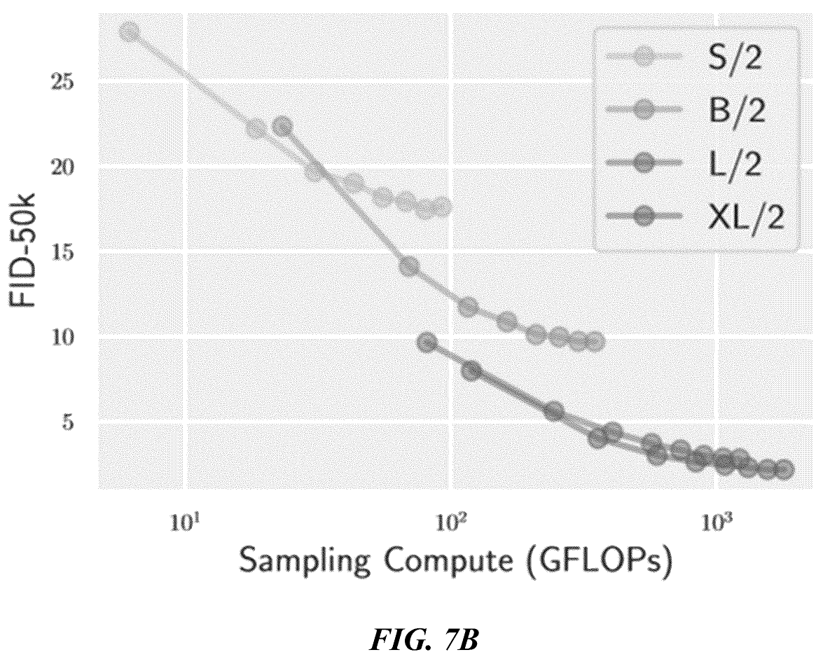

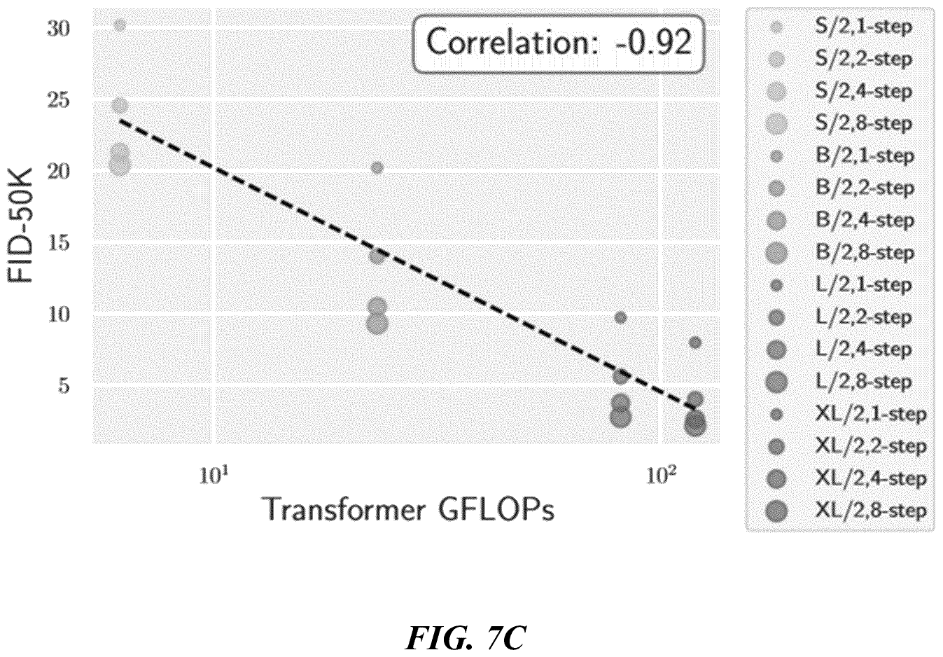

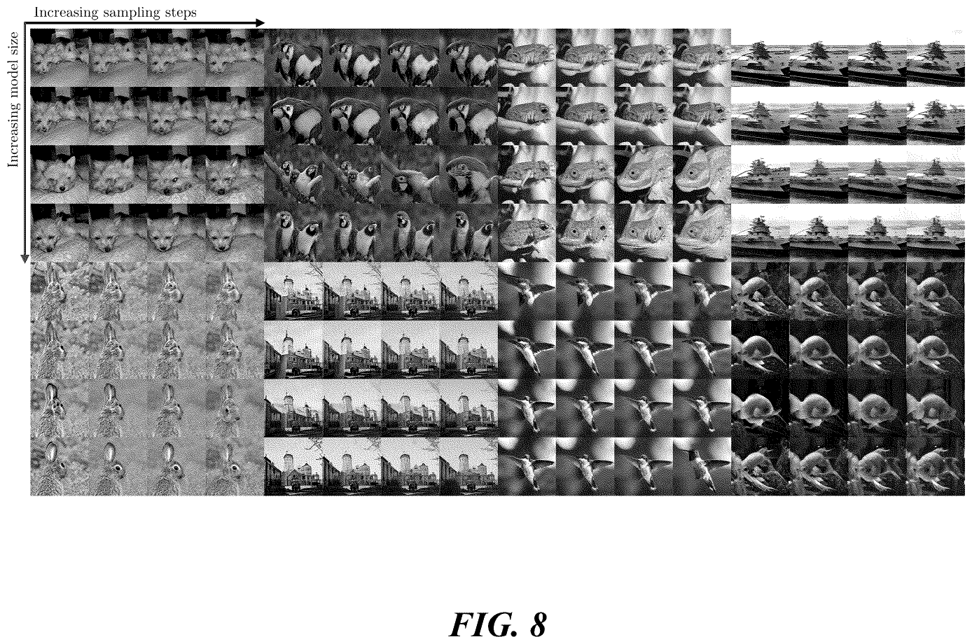

Methods and systems herein can provide generative AI models that scale in performance with training compute. Similar to diffusion models, IMM can scale with training and inference compute, as well as model size on ImageNet256×256. FIGS. 7A-7C show FID vs. training and inference compute in GFLOPs, and strong correlation is found between compute used and performance. Samples are visualized in FIG. 8 with increasing model size, e.g., DiT-S, DiT-B, DiT-L, or DiT-XL, and increasing inference steps, e.g., 1, 2, 4, or 8 steps. The sample quality increases along both axes, as larger transformers with more inference steps can capture more complex distributions. This may explain that more computing can sometimes yield different visual content from the same initial noise as shown in the visual results.

### 7.5 Ablation Studies

Methods and systems herein can provide ablation studies that can provide information about the effects of various design choices on model performance. Ablation studies may be performed with probabilistic architectures, e.g., denoising diffusion probabilistic models (DDPM)++ architecture for CIFAR-10 and DiT-B for ImageNet-256×256. FID comparisons use 2-step samplers by default.

Flow schedules and parameterization. Various combinations of network parameterization and flow schedules can be investigated: Simple-EDM+cosine (sEDM/cos), Simple-EDM+OT-FM (sEDM/FM), Euler-FM+OT-FM (eFM), Identity+cosine (id/cos), Identity+OT-FM (id/FM). Identity parameterization may fall behind other types of parameterization, which may show similar performance across datasets (see Table 3). On smaller scale (e.g., on CIFAR-10), sEDM/FM may work the best, but on larger scale (e.g., on ImageNet-256×256), eFM may work the best. This may indicate that OT-FM schedule and Euler parameterization may be more scalable than other choices.

Mapping function r(s,t). The choices for ablation include (1) const ne ment in ηₜ, (2) constant decrement in t, (3) constant decrement in

$${λ}_{t} = log ( {α}_{t}^{2} / {σ}_{t}^{2} ) ,$$

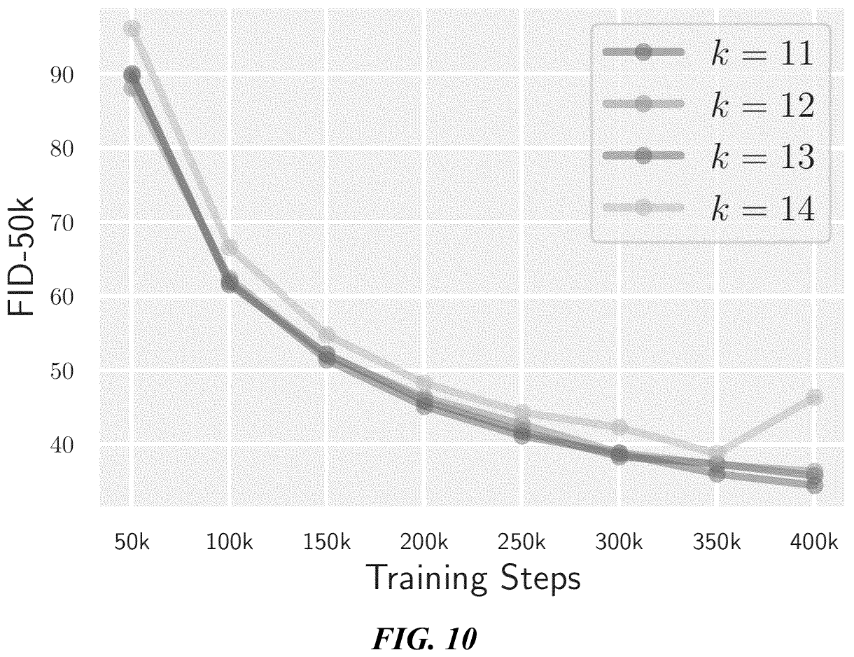

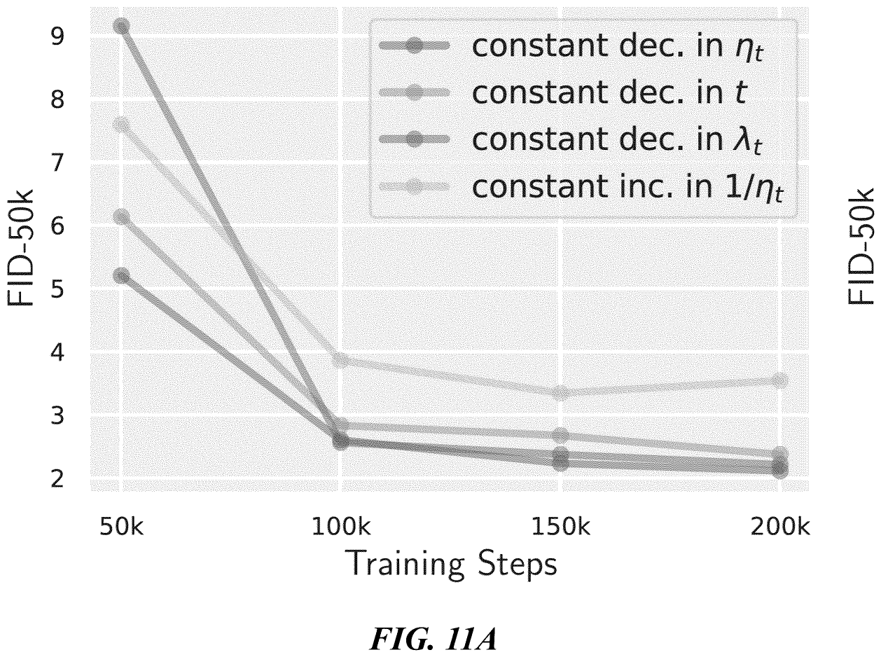

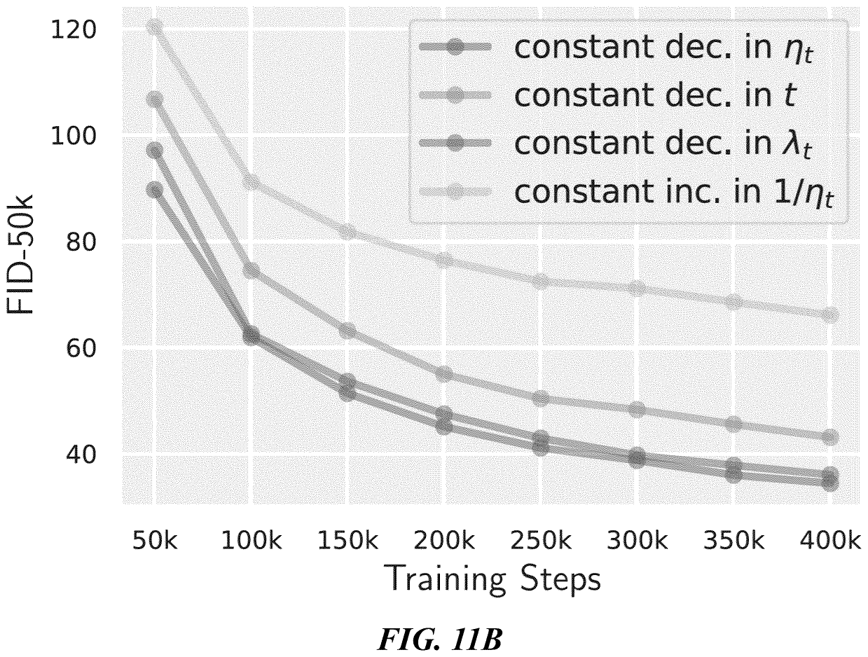

(4) constant increment in 1/ηₜ(see Example 3.6). For fair comparison, the decrement gap can be chosen so that the minimum t−r(s,t) is ≈10⁻³ and the same network parameterization can be used. FID progression in FIGS. 11A-11C shows that (1) consistently outperforms other choices. The mapping gap can be additionally ablated using M=4 in (1). The constant decrement can be in the form of (ηₘₐₓ−ηₘᵢₙ)/2^{k} for an appropriately chosen k. FIG. 10 shows that the performance can be relatively stable across k∈{11,12, 13}but can experience instability for k=14. This suggests that, for a given particle number, there may exists a largest k for stable optimization.

TABLE 4
Ablation of weight w(s, t) on ImageNet-256 × 256.

| | FID-50k |
|---|---|
| w(s, t) = 1 | 40.19 |
| +ELBO weight | 96.43 |
| +aₜ | 33.44 |
| +1/(aₜ² + σₜ²) | 27.43 |

Weighting function. In Table 4, the weighting factors are ablated in three groups: (1) the VDM ELBO factors

$$\frac{1}{2} σ ( b - {λ}_{t} ) ( - \frac{d}{dt} {λ}_{t} ) ,$$

(2) weighting αₜ (i.e., when a=1), and (3) weighting 1/(αₜ²+σₜ²). It may be useful to use αₜ jointly with weighting, e.g., evidence lower bound (ELBO) weighting, because it can convert v-pred network to a ϵ-pred parameterization (see Example 3.9), consistent with diffusion ELBO-objective. Factor 1/(αₜ²+σₜ²) upweighting middle time-steps can further boost performance, a helpful practice that can also be useful for FM training (Esser et al., 2024; which is incorporated by reference herein in its entirety). Additional study of the exponent a is performed in Example 9 and it was found that a=2 may emphasize optimizing the loss when t is small while a=1 may distribute weights more equally to larger t. As a result, a=2 may achieve higher quality multi-step generation than a=1.

### 8 CONCLUSION

The present disclosure provides methods and systems for inductive moment matching, a framework that learns a few-step generative AI model from scratch. It can train by leveraging interpolants, e.g., self-consistent interpolants to interpolate between data and prior and by matching all moments of its own distribution interpolated to be closer to that of data. The methods disclosed herein can provide convergence in distribution and can generalizes other generative AI methods. The methods disclosed herein can achieve state of-the-art performance across benchmarks while achieving orders of magnitude faster inference. The methods disclosed herein can provide a new perspective on training few-step models from scratch and inspire a new generation of generative AI models.

Thus, the present disclosure can advance research in diffusion models and generative AI, which can enable new creative possibilities and democratize content creation. Potential benefits include expanding artistic expression, assisting content creators, and generating synthetic data for research.

### REFERENCES

Albergo, M. S. and Vanden-Eijnden, E. Building normalizing flows with stochastic interpolants. arXiv preprint arXiv:2209.15571, 2022; which is incorporated by reference herein in its entirety.
Albergo, M. S., Boffi, N. M., and Vanden-Eijnden, E. Stochastic interpolants: A unifying framework for flows and diffusions. arXiv preprint arXiv:2303.08797, 2023; which is incorporated by reference herein in its entirety.
Auffray, Y. and Barbillon, P. Conditionally positive definite kernels: theoretical contribution, application to interpolation and approximation. PhD thesis, INRIA, 2009; which is incorporated by reference herein in its entirety.
Bao, F., Nie, S., Xue, K., Cao, Y., Li, C., Su, H., and Zhu, J. All are worth words: A vit backbone for diffusion models. In Proceedings of the IEEE/CVF conference on computer vision and pattern recognition, pp. 22669-22679, 2023; which is incorporated by reference herein in its entirety.
Berthelot, D., Autef, A., Lin, J., Yap, D. A., Zhai, S., Hu, S., Zheng, D., Talbott, W., and Gu, E. Tract: Denoising diffusion models with transitive closure time-distillation. arXiv preprint arXiv:2303.04248, 2023; which is incorporated by reference herein in its entirety.
Blattmann, A., Dockhorn, T., Kulal, S., Mendelevitch, D., Kilian, M., Lorenz, D., Levi, Y., English, Z., Voleti, V., Letts, A., et al. Stable video diffusion: Scaling latent video diffusion models to large datasets. arXiv preprint arXiv:2311.15127, 2023; which is incorporated by reference herein in its entirety.
Brock, A. Large scale gan training for high fidelity natural image synthesis. arXiv preprint arXiv:1809.11096, 2018; which is incorporated by reference herein in its entirety.
Chang, H., Zhang, H., Jiang, L., Liu, C., and Freeman, W. T. Maskgit: Masked generative image transformer. In Proceedings of the IEEE/CVF Conference on Computer Vision and Pattern Recognition, pp. 11315-11325, 2022; which is incorporated by reference herein in its entirety.
Chen, J., Yu, J., Ge, C., Yao, L., Xie, E., Wu, Y., Wang, Z., Kwok, J., Luo, P., Lu, H., et al. Pixart-α: Fast training of diffusion transformer for photorealistic text-to-image synthesis. arXiv preprint arXiv:2310.00426, 2023; which is incorporated by reference herein in its entirety.
Chen, N., Zhang, Y., Zen, H., Weiss, R. J., Norouzi, M., and Chan, W. Wavegrad: Estimating gradients for waveform generation. arXiv preprint arXiv:2009.00713, 2020; which is incorporated by reference herein in its entirety.
Dhariwal, P. and Nichol, A. Diffusion models beat gans on image synthesis. Advances in neural information processing systems, 34:8780-8794, 2021; which is incorporated by reference herein in its entirety.
Esser, P., Rombach, R., and Ommer, B. Taming transformers for high-resolution image synthesis. In Proceedings of the IEEE/CVF conference on computer vision and pattern recognition, pp. 12873-12883, 2021; which is incorporated by reference herein in its entirety.
Esser, P., Kulal, S., Blattmann, A., Entezari, R., Muller, J., Saini, “H., Levi, Y., Lorenz, D., Sauer, A., Boesel, F., et al. Scaling rectified flow transformers for high-resolution image synthesis. In Forty-first International Conference on Machine Learning, 2024; which is incorporated by reference herein in its entirety.
Frans, K., Hafner, D., Levine, S., and Abbeel, P. One step diffusion via shortcut models. arXiv preprint arXiv:2410.12557, 2024; which is incorporated by reference herein in its entirety.
Geng, Z., Pokle, A., Luo, W., Lin, J., and Kolter, J. Z. Consistency models made easy. arXiv preprint arXiv:2406.14548, 2024; which is incorporated by reference herein in its entirety.
Goodfellow, I., Pouget-Abadie, J., Mirza, M., Xu, B., WardeFarley, D., Ozair, S., Courville, A., and Bengio, Y. Generative adversarial networks. Communications of the ACM, 63(11): 139-144, 2020; which is incorporated by reference herein in its entirety.
Gretton, A., Borgwardt, K. M., Rasch, M. J., Scholkopf, B., and Smola, A. A kernel two-sample test. The Journal of Machine Learning Research, 13(1):723-773, 2012; which is incorporated by reference herein in its entirety.
Heek, J., Hoogeboom, E., and Salimans, T. Multistep consistency models. arXiv preprint arXiv:2403.06807, 2024; which is incorporated by reference herein in its entirety.
Heusel, M., Ramsauer, H., Unterthiner, T., Nessler, B., and Hochreiter, S. Gans trained by a two time-scale update rule converge to a local nash equilibrium. Advances in neural information processing systems, 30, 2017; which is incorporated by reference herein in its entirety.
Ho, J. and Salimans, T. Classifier-free diffusion guidance. arXiv preprint arXiv:2207.12598, 2022; which is incorporated by reference herein in its entirety.
Ho, J., Jain, A., and Abbeel, P. Denoising diffusion probabilistic models. Advances in neural information processing systems, 33:6840-6851, 2020; which is incorporated by reference herein in its entirety.
Ho, J., Chan, W., Saharia, C., Whang, J., Gao, R., Gritsenko, A., Kingma, D. P., Poole, B., Norouzi, M., Fleet, D. J., et al. Imagen video: High definition video generation with diffusion models. arXiv preprint arXiv:2210.02303, 2022a; which is incorporated by reference herein in its entirety.
Ho, J., Saharia, C., Chan, W., Fleet, D. J., Norouzi, M., and Salimans, T. Cascaded diffusion models for high fidelity image generation. Journal of Machine Learning Research, 23(47): 1-33, 2022b; which is incorporated by reference herein in its entirety.
Hoogeboom, E., Heek, J., and Salimans, T. simple diffusion: End to-end diffusion for high resolution images. In International Conference on Machine Learning, pp. 13213-13232. PMLR, 2023; which is incorporated by reference herein in its entirety.
Kang, M., Zhu, J.-Y., Zhang, R., Park, J., Shechtman, E., Paris, S., and Park, T. Scaling up gans for text-to-image synthesis. In Proceedings of the IEEE/CVF Conference on Computer Vision and Pattern Recognition, pp. 10124-10134, 2023; which is incorporated by reference herein in its entirety.
Karras, T., Laine, S., Aittala, M., Hellsten, J., Lehtinen, J., and Aila, T. Analyzing and improving the image quality of stylegan. In Proceedings of the IEEE/CVF conference on computer vision and pattern recognition, pp. 8110-8119, 2020; which is incorporated by reference herein in its entirety.
Karras, T., Aittala, M., Aila, T., and Laine, S. Elucidating the design space of diffusion-based generative models. Advances in neural information processing systems, 35:26565-26577, 2022; which is incorporated by reference herein in its entirety.
Karras, T., Aittala, M., Lehtinen, J., Hellsten, J., Aila, T., and Laine, S. Analyzing and improving the training dynamics of diffusion models. In Proceedings of the IEEE/CVF Conference on Computer Vision and Pattern Recognition, pp. 24174-24184, 2024; which is incorporated by reference herein in its entirety.
Kim, D., Lai, C.-H., Liao, W.-H., Murata, N., Takida, Y., Uesaka, T., He, Y., Mitsufuji, Y., and Ermon, S. Consistency trajectory models: Learning probability flow ode trajectory of diffusion. arXiv preprint arXiv:2310.02279, 2023; which is incorporated by reference herein in its entirety.
Kingma, D. and Gao, R. Understanding diffusion objectives as the elbo with simple data augmentation. Advances in Neural Information Processing Systems, 36, 2024; which is incorporated by reference herein in its entirety.
Kingma, D., Salimans, T., Poole, B., and Ho, J. Variational diffusion models. Advances in neural information processing systems, 34:21696-21707, 2021; which is incorporated by reference herein in its entirety.
Kong, Z., Ping, W., Huang, J., Zhao, K., and Catanzaro, B. Diffwave: A versatile diffusion model for audio synthesis. arXiv preprint arXiv:2009.09761, 2020; which is incorporated by reference herein in its entirety.
Li, C.-L., Chang, W.-C., Cheng, Y., Yang, Y., and Poczos, B.'Mmd gan: Towards deeper understanding of moment matching network. Advances in neural information processing systems, 30, 2017; which is incorporated by reference herein in its entirety.
Li, T., Tian, Y., Li, H., Deng, M., and He, K. Autoregressive image generation without vector quantization. arXiv preprint arXiv:2406.11838, 2024; which is incorporated by reference herein in its entirety.
Li, Y., Swersky, K., and Zemel, R. Generative moment matching networks. In International conference on machine learning, pp. 1718-1727. PMLR, 2015; which is incorporated by reference herein in its entirety.
Lipman, Y., Chen, R. T., Ben-Hamu, H., Nickel, M., and Le, M. Flow matching for generative modeling. arXiv preprint arXiv:2210.02747, 2022; which is incorporated by reference herein in its entirety.
Liu, H., Chen, Z., Yuan, Y., Mei, X., Liu, X., Mandic, D., Wang, W., and Plumbley, M. D. Audioldm: Text-to-audio generation with latent diffusion models. arXiv preprint arXiv:2301.12503, 2023; which is incorporated by reference herein in its entirety.
Liu, X., Gong, C., and Liu, Q. Flow straight and fast: Learning to generate and transfer data with rectified flow. arXiv preprint arXiv:2209.03003, 2022; which is incorporated by reference herein in its entirety.
Lu, C. and Song, Y. Simplifying, stabilizing and scaling continuous-time consistency models. arXiv preprint arXiv:2410.11081, 2024; which is incorporated by reference herein in its entirety.
Lu, C., Zhou, Y., Bao, F., Chen, J., Li, C., and Zhu, J. Dpm-solver: A fast ode solver for diffusion probabilistic model sampling in around 10 steps. Advances in Neural Information Processing Systems, 35:5775-5787, 2022; which is incorporated by reference herein in its entirety.
Luhman, E. and Luhman, T. Knowledge distillation in iterative generative models for improved sampling speed. arXiv preprint arXiv:2101.02388, 2021; which is incorporated by reference herein in its entirety.
Luo, W., Hu, T., Zhang, S., Sun, J., Li, Z., and Zhang, Z. Diffinstruct: A universal approach for transferring knowledge from pre-trained diffusion models. Advances in Neural Information Processing Systems, 36, 2024a; which is incorporated by reference herein in its entirety.
Luo, W., Huang, Z., Geng, Z., Kolter, J. Z., and Qi, G.-j. One-step diffusion distillation through score implicit matching. arXiv preprint arXiv:2410.16794, 2024b; which is incorporated by reference herein in its entirety.
Ma, N., Goldstein, M., Albergo, M. S., Boffi, N. M., VandenEijnden, E., and Xie, S. Sit: Exploring flow and diffusion-based generative models with scalable interpolant transformers. arXiv preprint arXiv:2401.08740, 2024; which is incorporated by reference herein in its entirety.
Meng, C., Rombach, R., Gao, R., Kingma, D., Ermon, S., Ho, J., and Salimans, T. On distillation of guided diffusion models. In Proceedings of the IEEE/CVF Conference on Computer Vision and Pattern Recognition, pp. 14297-14306, 2023; which is incorporated by reference herein in its entirety.
Muller, A. Integral probability metrics and their generating classes” of functions. Advances in applied probability, 29(2):429-443, 1997; which is incorporated by reference herein in its entirety.
Nichol, A. Q. and Dhariwal, P. Improved denoising diffusion probabilistic models. In International conference on machine learning, pp. 8162-8171. PMLR, 2021; which is incorporated by reference herein in its entirety.
OpenAI. Video generation models as world simulators. https: //openai.com/sora/, 2024; which is incorporated by reference herein in its entirety.
Peebles, W. and Xie, S. Scalable diffusion models with transformers. In Proceedings of the IEEE/CVF International Conference on Computer Vision, pp. 4195-4205, 2023; which is incorporated by reference herein in its entirety.
Podell, D., English, Z., Lacey, K., Blattmann, A., Dockhorn, T., Muller, J., Penna, J., and Rombach, R. Sdxl: Improving latent” diffusion models for high-resolution image synthesis. arXiv preprint arXiv:2307.01952, 2023; which is incorporated by reference herein in its entirety.
Rombach, R., Blattmann, A., Lorenz, D., Esser, P., and Ommer, B. High-resolution image synthesis with latent diffusion models. In Proceedings of the IEEE/CVF conference on computer vision andpattern recognition, pp. 10684-10695, 2022; which is incorporated by reference herein in its entirety.
Saharia, C., Chan, W., Saxena, S., Li, L., Whang, J., Denton, E. L., Ghasemipour, K., Gontijo Lopes, R., Karagol Ayan, B., Salimans, T., et al. Photorealistic text-to-image diffusion models with deep language understanding. Advances in neural information processing systems, 35:36479-36494, 2022; which is incorporated by reference herein in its entirety.
Salimans, T. and Ho, J. Progressive distillation for fast sampling of diffusion models. arXiv preprint arXiv:2202.00512, 2022; which is incorporated by reference herein in its entirety.
Salimans, T., Mensink, T., Heek, J., and Hoogeboom, E. Multistep distillation of diffusion models via moment matching. arXiv preprint arXiv:2406.04103, 2024; which is incorporated by reference herein in its entirety.
Sauer, A., Lorenz, D., Blattmann, A., and Rombach, R. Adversarial diffusion distillation. In European Conference on Computer Vision, pp. 87-103. Springer, 2025; which is incorporated by reference herein in its entirety.
Sohl-Dickstein, J., Weiss, E., Maheswaranathan, N., and Ganguli, S. Deep unsupervised learning using nonequilibrium thermodynamics. In International conference on machine learning, pp. 2256-2265. PMLR, 2015; which is incorporated by reference herein in its entirety.
Song, J., Meng, C., and Ermon, S. Denoising diffusion implicit models. arXiv preprint arXiv:2010.02502, 2020a; which is incorporated by reference herein in its entirety.
Song, Y. and Dhariwal, P. Improved techniques for training consistency models. arXiv preprint arXiv:2310.14189, 2023; which is incorporated by reference herein in its entirety.
Song, Y., Sohl-Dickstein, J., Kingma, D. P., Kumar, A., Ermon, S., and Poole, B. Score-based generative modeling through stochastic differential equations. arXiv preprint arXiv:2011.13456, 2020b; which is incorporated by reference herein in its entirety.
Song, Y., Dhariwal, P., Chen, M., and Sutskever, I. Consistency models. arXiv preprint arXiv:2303.01469, 2023; which is incorporated by reference herein in its entirety.
Steinwart, I. and Christmann, A. Support vector machines. Springer Science & Business Media, 2008; which is incorporated by reference herein in its entirety.
Tee, J. T. J., Zhang, K., Yoon, H. S., Gowda, D. N., Kim, C., and Yoo, C. D. Physics informed distillation for diffusion models. arXiv preprint arXiv:2411.08378, 2024; which is incorporated by reference herein in its entirety.
Tian, K., Jiang, Y., Yuan, Z., Peng, B., and Wang, L. Visual autoregressive modeling: Scalable image generation via nextscale prediction. arXiv preprint arXiv:2404.02905, 2024a; which is incorporated by reference herein in its entirety.
Tian, Y., Tu, Z., Chen, H., Hu, J., Xu, C., and Wang, Y. U-dits: Downsample tokens in u-shaped diffusion transformers. arXiv preprint arXiv:2405.02730, 2024b; which is incorporated by reference herein in its entirety.
Xiao, Z., Kreis, K., and Vahdat, A. Tackling the generative learning trilemma with denoising diffusion gans. arXiv preprint arXiv:2112.07804, 2021; which is incorporated by reference herein in its entirety.
Xu, Y., Deng, M., Cheng, X., Tian, Y., Liu, Z., and Jaakkola, T. Restart sampling for improving generative processes. Advances in Neural Information Processing Systems, 36:76806-76838, 2023; which is incorporated by reference herein in its entirety.
Yin, T., Gharbi, M., Zhang, R., Shechtman, E., Durand, F., Freeman, W. T., and Park, T. One-step diffusion with distribution matching distillation. In Proceedings of the IEEE CVF Conference on Computer Vision and Pattern Recognition, pp. 6613-6623, 2024; which is incorporated by reference herein in its entirety.
Zhang, R., Isola, P., Efros, A. A., Shechtman, E., and Wang, O. The unreasonable effectiveness of deep features as a perceptual metric. In Proceedings of the IEEE conference on computer vision andpattern recognition, pp. 586-595, 2018; which is incorporated by reference herein in its entirety.
Zheng, H., Nie, W., Vahdat, A., Azizzadenesheli, K., and Anandkumar, A. Fast sampling of diffusion models via operator learning. In International conference on machine learning, pp. 42390-42402. PMLR, 2023; which is incorporated by reference herein in its entirety.
Zhou, M., Zheng, H., Wang, Z., Yin, M., and Huang, H. Score identity distillation: Exponentially fast distillation of pretrained diffusion models for one-step generation. In Forty-first International Conference on Machine Learning, 2024; which is incorporated by reference herein in its entirety.

### EXAMPLES

While various examples of the present disclosure have been shown and described herein, such examples are provided by way of example only. Numerous variations, changes, or substitutions may occur without departing from the present disclosure. It should be understood that various alternatives to the examples described herein may be employed.

### Example 1—Background: Properties of Stochastic Interpolants

Some relevant properties of stochastic interpolants are described for exposition.

Boundary satisfaction. For an interpolant distribution qₜ (xₜ|x, ϵ) defined in Albergo et al. (2023, which is incorporated by reference herein in its entirety), and the marginal qₜ (xₜ) as defined in Eq. (2), q₁(x₁)=p(x₁) and q₀(x₀)=q(x₀) can be checked so that x₁=ϵ and x₀=x.

$$\begin{matrix}{q}_{1} ( {x}_{1} ) & = & \int \int {q}_{1} ( {x}_{1} \vert x , ϵ ) q ( x ) p ( ϵ ) dxd ϵ & ( 15 ) \\ & = & \int \int δ ( {x}_{1} - ϵ ) q ( x ) p ( ϵ ) dxd ϵ & ( 16 ) \\ & = & \int \int q ( x ) p ( {x}_{1} ) dx & ( 17 ) \\ & = & p ( {x}_{1} ) & ( 18 )\end{matrix}$$

$$\begin{matrix}{q}_{0} ( {x}_{0} ) & = & \int \int {q}_{0} ( {x}_{0} \vert x , ϵ ) q ( x ) p ( ϵ ) dxd ϵ & ( 19 ) \\ & = & \int \int δ ( {x}_{0} - x ) q ( x ) p ( ϵ ) dxd ϵ & ( 20 ) \\ & = & \int \int q ( {x}_{0} ) p ( ϵ ) dx & ( 21 ) \\ & = & q ( {x}_{0} ) & ( 22 )\end{matrix}$$

Joint distribution. The joint distribution of x and xₜ is written as

$${q}_{t} ( x , {x}_{t} ) = \int {q}_{t} ( {x}_{t} \vert x , ϵ ) q ( x ) p ( ϵ ) d ϵ \qquad ( 23 )$$

Independence of joint at t=1

$$\begin{matrix}{q}_{1} ( x , {x}_{1} ) & = & \int {q}_{1} ( {x}_{1} \vert x , ϵ ) q ( x ) p ( ϵ ) d ϵ & ( 24 ) \\ & = & \int δ ( {x}_{1} - ϵ ) q ( x ) p ( ϵ ) d ϵ & ( 25 ) \\ & = & q ( x ) p ( {x}_{1} ) & ( 26 ) \\ & = & q ( x ) p ( ϵ ) & ( 27 )\end{matrix}$$

in which case x₁=c.

### Example 2—Theorems and Derivations

### 2.1 Divergence Minimizer

Lemma 3. Assuming marginal-preserving interpolant and metric D(⋅, ⋅), a minimizer θ* of Eq. (7) exists, e.g.,

$${p}_{s \vert t}^{{θ}^{*}} ( x \vert {x}_{t} ) = {q}_{t} ( x \vert {x}_{t} ) ,$$

and the minimum is 0.

Proof qₜ(x|xₜ) is directly substituted into the objective to check. First,

$$\begin{matrix}{p}_{s \vert t}^{{θ}^{*}} ( {x}_{s} ) & = & \int \int {q}_{s \vert t} ( {x}_{s} \vert x , {x}_{t} ) {p}_{s \vert t}^{{θ}^{*}} ( x \vert {x}_{t} ) {q}_{t} ( {x}_{t} ) {dx}_{t} dx & ( 28 ) \\ & = & \int \int {q}_{s \vert t} ( {x}_{s} \vert x , {x}_{t} ) {q}_{t} ( x \vert {x}_{t} ) {q}_{t} ( {x}_{t} ) {dx}_{t} dx & ( 29 ) \\ & {=}^{( a )} & {q}_{s} ( {x}_{s} ) & ( 30 )\end{matrix}$$

where (a) is due to definition of marginal preservation. So the objective becomes

$${𝔼}_{s , t} [ w ( s , t ) D ( {q}_{s} ( {x}_{s} ) , {p}_{s \vert t}^{{θ}^{*}} ( {x}_{s} ) ) ] = {𝔼}_{s , t} [ w ( s , t ) D ( {q}_{s} ( {x}_{s} ) , {q}_{s} ( {x}_{s} ) ) ] = 0 \qquad ( 31 )$$

In general, the minimizer qₜ(x|xₜ) exists. However, this does not show that the minimizer is unique. In fact, the minimizer is not unique in general because a deterministic minimizer can also exist under certain assumptions on the interpolant (see Example 2.6).

Failure Case without Marginal Preservation. The marginal-preservation property of the interpolant q_{s|t} (xₛ|x, xₜ) is important for the naïve objective in Eq. (7) to attain 0 loss (Lemma 3). Consider the failure case below where the constructed interpolant is a generalized interpolant but not necessarily marginal-preserving. Then it is shown that there exists a t such that

$${p}_{s \vert t}^{θ} ( {x}_{s} )$$

can never reach qₛ (xₛ) regardless of θ.

Proposition 2 (Example Failure Case). Let q(x)=β(x), p(ϵ)=δ(ϵ−1), and suppose an interpolant I_{s|t}(x, xₜ)= and

$${γ}_{s \vert t} = \frac{s}{t} \sqrt{1 - \frac{s}{t}} \text{?} ( t < 1 ) ,$$

then

$$D ( {q}_{s} ( x \text{?} ) \text{?} {p}_{s \vert t}^{θ} ( {x}_{s} ) ) > 0$$

$$\text{?} \text{indicates text missing or illegible when filed}$$

for all 0<s<t<1 regardless of the learned distribution

$${p}_{s \vert t}^{θ} ( x \vert {x}_{t} )$$

given any metric D(⋅, ⋅).

Proof. This example first implies the learning target

$$\begin{matrix}{q}_{s} ( {x}_{s} ) & = & \int \int {q}_{s} ( {x}_{s} \vert x , ϵ ) q ( x ) p ( ϵ ) dxd ϵ & ( 32 ) \\ & = & \int \int δ ( {x}_{s} - ( ( 1 - s ) x + s ϵ ) ) δ ( x ) δ ( ϵ - 1 ) dxd ϵ & ( 33 ) \\ & = & δ ( {x}_{s} - s ) & ( 34 )\end{matrix}$$

is a delta distribution. However, it is shown that if any t<1 is selected and

$$0 < s < \text{?} , {p}_{s \vert t}^{θ} ( {x}_{s} )$$

$$\text{?} \text{indicates text missing or illegible when filed}$$

can never be a delta distribution.

$$\begin{matrix}{p}_{s \vert t}^{θ} ( {x}_{s} ) & = & \int \int {q}_{s \vert t} ( {x}_{s} \vert x , {x}_{t} ) {p}_{s \vert t}^{θ} ( x \vert {x}_{t} ) {q}_{t} ( {x}_{t} ) {dx}_{t} dx & ( 35 ) \\ & = & \int \int 𝒩 ( ( 1 - \frac{s}{t} ) x + \frac{s}{t} {x}_{t} , \frac{{s}^{2}}{{t}^{2}} ( 1 - \frac{{s}^{2}}{{t}^{2}} ) I ) {p}_{s \vert t}^{θ} ( x \vert {x}_{t} ) δ ( {x}_{t} - & ( 36 ) \\ & & t ) {dx}_{t} dx & \\ & = & \int 𝒩 ( ( 1 - \frac{s}{t} ) x + s , \frac{{s}^{2}}{{t}^{2}} ( 1 - \frac{{s}^{2}}{{t}^{2}} ) I ) {p}_{s \vert t}^{θ} ( x \vert {x}_{t} = t ) dx & ( 37 )\end{matrix}$$

Now, it is shown the model distribution has non-zero variance under these choices of t and s. Expectations are over

$${ρ}_{s \vert t}^{θ} ( {x}_{s} )$$

or conditional interpolant q_{s|t} (xₛ|x, xₜ) for all equations below.

$$\begin{matrix}Var ( {x}_{s} ) = 𝔼 [ {x}_{s}^{2} ] - {𝔼 [ {x}_{s} ]}^{2} & ( 38 ) \\ = \int \int 𝔼 [ {x}_{s}^{2} \vert x , {x}_{t} ] {p}_{s \vert t}^{θ} ( x \vert {x}_{t} ) {q}_{t} ( {x}_{t} ) {dxdx}_{t} - {𝔼 [ {x}_{s} ]}^{2} & ( 39 ) \\ = \int \int 𝔼 [ {x}_{s}^{2} \vert x , {x}_{t} ] {p}_{s \vert t}^{θ} ( x \vert {x}_{t} ) {q}_{t} ( {x}_{t} ) {dxdx}_{t} - {𝔼 [ {x}_{s} ]}^{2} & ( 40 ) \\ = \begin{matrix}\int \int [ Var ( {x}_{s} \vert x , {x}_{t} ] + {𝔼 [ {x}_{s} \vert x , {x}_{t} ]}^{2} {p}_{s \vert t}^{θ} ( x \vert {x}_{t} ) {q}_{t} ( {x}_{t} ) {dxdx}_{t} - \\ 2 {𝔼 [ {x}_{s} ]}^{2} + {𝔼 [ {x}_{s} ]}^{2}\end{matrix} & ( 41 ) \\ = \begin{matrix}\int \int [ Var ( {x}_{s} \vert x , {x}_{t} ] + {𝔼 [ {x}_{s} \vert x , {x}_{t} ]}^{2} {p}_{s \vert t}^{θ} ( x \vert {x}_{t} ) {q}_{t} ( {x}_{t} ) dxdx - \\ \int \int 𝔼 [ {x}_{s} ] 𝔼 [ {x}_{s} \vert {xx}_{t} ] {p}_{s \vert t}^{θ} ( x \vert {x}_{t} ) {q}_{t} ( {x}_{t} ) {dxdx}_{t} - {𝔼 [ {x}_{s} ]}^{2}\end{matrix} & ( 42 ) \\ = {\underbrace{\int \int {[ ( {x}_{s} ∣ x , {x}_{t} ) + {𝔼 [ {x}_{s} ∣ x , {x}_{t} ]}^{2} − 𝔼 [ {x}_{s} ] 𝔼 [ {x}_{s} \vert x , {x}_{t} ] + 𝔼 \vert {x}_{s} ]}^{2}}}_{( α )} {p}_{s \{ t}^{θ} ( x ∣ {x}_{t} ) {q}_{t} ( {x}_{t} ) {dx dx}_{t} & ( 43 )\end{matrix}$$

where (a) can be simplified as

$$Var ( {x}_{s} \vert x , {x}_{t} ) + {( {𝔼 [ {x}_{s} \vert x , {x}_{t} ]}^{2} - 𝔼 [ {x}_{s} ] )}^{2} > 0 \qquad ( 44 )$$

because Var(xₛ|x, xₜ)>0 for all 0<s<t<1 due to its non-zero Gaussian noise. Therefore, Var(xₛ)>0, implying

$${ρ}_{s \vert t}^{θ} ( {x}_{s} )$$

can never be a delta function regardless of model

$${ρ}_{s \vert t}^{θ} ( x \vert {x}_{t} ) .$$

A valid metric D(⋅, ⋅) over probability

$${ρ}_{s \vert t}^{θ} ( {x}_{s} )$$

and qₛ(xₛ) implies

$$D ( {q}_{s} ( {x}_{s} ) , {ρ}_{s \vert t}^{θ} ( {x}_{s} ) ) = 0 ⇔ {ρ}_{s \vert t}^{θ} ( {x}_{s} ) = {q}_{s} ( {x}_{s} )$$

which means

$${p}_{s \vert t}^{θ} ( {x}_{s} ) \neq {q}_{s} ( {x}_{s} ) ⇒ D ( {q}_{s} ( {x}_{s} ) , {p}_{s \vert t}^{θ} ( {x}_{s} ) ) > 0$$

### 2.2 Boundary Satisfaction of Model Distribution

The operator output

$${p}_{s \vert t}^{θ} ( {x}_{s} )$$

satisfies boundary condition.
Lemma 4 (Boundary Condition). For all s∈[0,1] and all θ, the following boundary condition holds.

$${q}_{s} ( {x}_{s} ) = {p}_{s \vert s}^{θ} ( {x}_{s} ) \qquad ( 45 )$$

Proof.

$$\begin{matrix}{p}_{s \vert t}^{θ} ( {x}_{s} ) = \int \int {\underbrace{{q}_{s , s} ( {x}_{s} \vert x , {x}_{s} \text{?} )}}_{δ ( {x}_{s} - {x}_{s} ) \text{?}} {p}_{s \vert t}^{θ} ( x \vert {x}_{s} \text{?} ) q \text{?} d ( {x}_{s} \text{?} ) dx \text{?} dx \\ = \int {p}_{s \vert s}^{θ} ( x \vert {x}_{s} ) {q}_{s} ( {x}_{s} ) dx \\ = {q}_{s} ( {x}_{s} ) \int {p}_{s \vert s}^{θ} ( x \vert {x}_{s} ) dx \\ = {q}_{s} ( {x}_{s} ) \end{matrix}$$

$$\text{?} \text{indicates text missing or illegible when filed}$$

2.3 Definition of Well-Conditioned r(s, t)

For simplicity, the mapping function r(s, t) is well-conditioned if

$$r ( s , t ) = max ( s , t - Δ ( t ) ) \qquad ( 46 )$$

where Δ(t)≥ϵ>0 is a positive function such that r(s, t) is increasing for t≥s+c₀(s) where c₀(s) is the largest t that is mapped to s. Formally, c₀(s)=sup{t: r(s, t)=s}. For t≥s+c₀(s), the inverse w.r.t. t exists, i.e. r⁻¹(s, ⋅) and r⁻¹ (s, r(s, t))=t. All practical implementations follow this general form, and are detailed in Example 3.6.

### 2.4 Main Theorem

Theorem 1. Assuming r(s, t) is well-conditioned, the interpolant is marginal-preserving, and is a minimizer of Eq. (8) for each n with infinite data and network capacity, for all t∈[0, 1], s∈[0, t],

$${lim}_{n \to ∞} {MMD}^{2} ( {q}_{s} ( {x}_{s} ) , {p}_{s \vert t}^{θ} \text{?} ( {x}_{s} ) ) = 0. \qquad ( 9 )$$

$$\text{?} \text{indicates text missing or illegible when filed}$$

Proof. It is proven by induction on sequence number n. First, r(s, t) is well-conditioned by following the definition in Eq. (46). Furthermore, for notational convenience, let

$${r}_{n}^{- 1} ( s , \cdot ) := {r}^{- 1} ( s , {r}^{- 1} ( s , {r}^{- 1} ( s , … ) ) )$$

be n nested application of r⁻¹ (s, ⋅) on the second argument. Additionally,

$${r}_{0}^{- 1} ( s , t ) = t .$$

Base case: n=1. Given any s≥0, r(s, u)=s for all s<u≤c₀(s), implying

$${MMD}^{2} ( {p}_{s \vert s}^{θ} \text{?} ( {x}_{s} ) , {p}_{s}^{θ} \text{?} ( {x}_{s} ) ) {=}^{( α )} {MMD}^{2} ( {q}_{s} ( {x}_{s} ) , {p}_{s}^{\text{?} θ} ( {x}_{s} ) ) {=}^{( b )} 0 \qquad ( 47 )$$

$$\text{?} \text{indicates text missing or illegible when filed}$$

for u≤c₀(s) where (a) is implied by Lemma 4 and (b) is implied by Lemma 3

Inductive assumption: n−1. Assume

$${p}_{\text{?}}^{\text{?}} ( {x}_{\text{?}} ) = {q}_{\text{?}} ( {x}_{\text{?}} )$$

$$\text{?} \text{indicates text missing or illegible when filed}$$

for all

$$s \leq u \leq {r}_{n - 2}^{- 1} ( r , {c}_{0} ( s ) ) .$$

The target distribution

$${p}_{\text{?}}^{\text{?}} ( {x}_{\text{?}} )$$

$$\text{?} \text{indicates text missing or illegible when filed}$$

in Eq. (8) is inspected if optimized on

$$\text{?} \leq u \leq {r}_{n - 1}^{- 1} ( \text{?} , {c}_{0} ( s ) ) .$$

$$\text{?} \text{indicates text missing or illegible when filed}$$

On this interval, r(s, ⋅) can be applied to the inequality to get

$$s = r ( \text{?} , \text{?} ) \leq r ( \text{?} , \text{?} ) \leq r ( s , {r}_{\text{?}}^{\text{?}} ( \text{?} , \text{?} ( s ) ) ) = {r}_{\text{?}}^{\text{?}} ( \text{?} , \text{?} ( s ) )$$

$$\text{?} \text{indicates text missing or illegible when filed}$$

since r(s, ⋅) is increasing. And by inductive assumption

$${p}_{\text{?}}^{\text{?}} ( {x}_{\text{?}} ) = {q}_{\text{?}} ( {x}_{\text{?}} )$$

$$\text{?} \text{indicates text missing or illegible when filed}$$

for

$$s \leq r ( s , u ) \leq {\text{?}}_{\text{?}}^{\text{?}} ( \text{?} , \text{?} ( \text{?} ) ) ,$$

$$\text{?} \text{indicates text missing or illegible when filed}$$

this implies minimizing

$${𝔼}_{\text{?}} [ w ( s , u ) {MMD}^{2} ( {p}_{\text{?}}^{\text{?}} ( {x}_{\text{?}} ) , {p}_{\text{?}}^{\text{?}} ( {x}_{\text{?}} ) ) ]$$

$$\text{?} \text{indicates text missing or illegible when filed}$$

on

$$s \leq u \leq {r}_{\text{?}}^{\text{?}} ( s , {c}_{0} ( s ) )$$

$$\text{?} \text{indicates text missing or illegible when filed}$$

is equivalent to minimizing

$${𝔼}_{\text{?}} [ w ( s , u ) {MMD}^{2} ( {q}_{\text{?}} ( {x}_{\text{?}} ) , {p}_{\text{?}}^{\text{?}} ( {x}_{\text{?}} ) ) ] \qquad ( 48 )$$

$$\text{?} \text{indicates text missing or illegible when filed}$$

for

$$s \leq u \leq {r}_{\text{?}}^{\text{?}} ( s , {c}_{0} ( s ) ) .$$

$$\text{?} \text{indicates text missing or illegible when filed}$$

Lemma 3 implies that its minimum achieves

$${p}_{\text{?}}^{\text{?}} ( {x}_{\text{?}} ) = {q}_{\text{?}} ( {x}_{\text{?}} ) .$$

$$\text{?} \text{indicates text missing or illegible when filed}$$

Lastly, taking n→∞ implies

$${lim}_{\text{?}} {r}_{\text{?}}^{\text{?}} ( s , s ) = 1$$

$$\text{?} \text{indicates text missing or illegible when filed}$$

and thus the induction covers the entire [s, 1] interval given each s. Therefore,

$${lim}_{\text{?}} MMD ( {q}_{\text{?}} ( {x}_{\text{?}} ) , {p}_{\text{?}}^{\text{?}} ( {x}_{\text{?}} ) ) = 0$$

$$\text{?} \text{indicates text missing or illegible when filed}$$

for all 0≤s≤t≤1.

### 2.5 Self-Consistency Implies Marginal Preservation

Without assuming marginal preservation, it is important to define the marginal distribution of xₛ under generalized interpolants q_{s|t} (xₛ|x, xₜ) as

$${q}_{s \vert t} ( {x}_{s} ) == \int \sum {q}_{s \vert t} ( {x}_{s} \vert x , {x}_{t} ) {q}_{t} ( x \vert {x}_{t} ) {q}_{t} ( {x}_{t} ) {dx}_{t} dx \qquad ( 49 )$$

and it is shown that with self-consistent interpolants, this distribution is invariant of t, i.e. q_{s|t} (xₛ)=qₛ(xₛ).
Lemma 5. If the interpolant q_{s|t} (xₛ|x, xₜ) is self-consistent, the marginal distribution q_{s|t} (xₛ) as defined in Eq. (49) satisfies qₛ(xₛ)=q_{s|t} (xₛ) for all t∈[s, 1].

Proof. For t∈[s, 1],

$${q}_{s \vert t} ( {x}_{s} ) = \int \int {q}_{s \vert t} ( {x}_{s} \vert x , {x}_{t} ) ) {q}_{t} ( x \vert {x}_{t} ) {q}_{t} ( {x}_{t} ) {dx}_{t} dx \qquad ( 50 )$$

$$= \int \int {q}_{s \vert t} ( {x}_{s} \vert x , {x}_{t} ) ) {q}_{t} ( {x}_{t} ) \int \frac{{q}_{t} ( {x}_{t} \vert x , ϵ ) q ( x ) p ( ϵ )}{{q}_{t} ( {x}_{t} )} d ϵ {dx}_{t} dx \qquad ( 51 )$$

$$= \int \int {q}_{s \vert t} ( {x}_{s} \vert x , {x}_{t} ) q ( x ) \int {q}_{t} ( {x}_{t} \vert x , ϵ ) p ( ϵ ) d ϵ {dx}_{t} dx \qquad ( 52 )$$

$$= \int \int q ( x ) p ( ϵ ) ( \int {q}_{s \vert t} ( {x}_{s} \vert x , {x}_{t} ) {q}_{t} ( {x}_{t} \vert x , ϵ ) {dx}_{t} ) d ϵ dx \qquad ( 53 )$$

$$= \int \int q ( x ) p ( ϵ ) ( \int {q}_{s \vert t} ( {x}_{s} \vert x , {x}_{t} ) {q}_{t , 1} ( {x}_{t} \vert x , ϵ ) {x}_{t} ) d ϵ dx \qquad ( 54 )$$

$${=}^{( a )} \int \int {q}_{s , 1} ( {x}_{s} \vert x , ϵ ) q ( x ) p ( ϵ ) d ϵ dx \qquad ( 55 )$$

$${=}^{( b )} \int \int {q}_{s} ( {x}_{s} \vert x , ϵ ) q ( x ) p ( ϵ ) d ϵ dx \qquad ( 56 )$$

$$= {q}_{s} ( {x}_{s} ) \qquad ( 57 )$$

where (a) uses definition of self-consistent interpolants and (b) uses definition of the generalized interpolant.

It is shown in Example 3.1 that DDIM is an example self-consistent interpolant. Furthermore, DDPM posterior (Ho et al., 2020; Kingma et al., 2021; each of which is incorporated by reference herein in its entirety) is also self-consistent (see Lemma 6).

### 2.6 Existence of Deterministic Minimizer

The formal statement for the deterministic minimizer is presented.

Proposition 3. if for all t∈[0, 1], s∈[0, t], q_{s|t}≡0, I_{s|t}(x, xₜ) is invertible w.r.t.x, and there exists C₁<∞ such that ∥I_{t|}1(x, ∈)∥<C₁∥x−ϵ∥, then there exists a function h_{s|t}: [symbol] ^{D}→ [symbol] ^{D} such that

$${q}_{s} ( {x}_{s} ) = \int \int {q}_{s \vert t} ( {x}_{s} \vert x , {x}_{t} ) δ ( x - {h}_{s \vert t} ( {x}_{t} ) ) {q}_{t} ( {x}_{t} ) {dxdx}_{t} . \qquad ( 58 )$$

Proof Let

$${I}_{s \vert t}^{- 1} ( \cdot , {x}_{t} )$$

be the inverse of I_{s|t} w.r.t. x such that

$${I}_{s \vert t}^{- 1} ( {I}_{s \vert t} ( x , {x}_{t} ) , {x}_{t} ) = x and {I}_{s \vert t} ( {I}_{s \vert t}^{- 1} ( y , {x}_{t} ) , {x}_{t} ) = y$$

for all x, xₜ, y∈ [symbol] ^{D}. Since there exists C₁<□ such that ∥I_{t|1} (x, ϵ)∥<C₁∥x−ϵ∥ for all t∈[0,1], the PF-ODE of the original interpolant I_{t|1} (x, ϵ)=Iₜ (x, ϵ) exists for all t∈ [0,1](Albergo et al., 2023, which is incorporated by reference herein in its entirety). Then, for all t∈[0,1], s∈[0, t], let

$${\hat{h}}_{s \vert t} ( {x}_{t} ) = {x}_{t} + {\int }_{t}^{s} {𝔼}_{x , ϵ} [ \frac{\partial }{\partial u} {I}_{u} ( x , ϵ ) \vert {x}_{u} ] du , \qquad ( 59 )$$

which pushes forward the measure qₜ (xₜ) to qₛ (xₛ). Define:

$${h}_{s \vert t} ( {x}_{t} ) = {I}_{s \vert t}^{- 1} ( {\hat{h}}_{s \vert t} ( {x}_{t} ) , {x}_{t} ) . \qquad ( 60 )$$

Then, since q_{s|t}≡0, q_{s|t}(xₛ|x, xₜ)=δ(xₛ−I_{s|t}(x, xₜ)) where x~δ(x−h_{s|t}(xₜ)). Therefore,

$${x}_{s} = {I}_{s \vert t} ( {h}_{s \vert t} ( {x}_{t} ) , {x}_{t} ) = {I}_{s \vert t} ( {I}_{s \vert t}^{- 1} ( {h}_{s \vert t} ( {x}_{t} ) , {x}_{t} ) , {x}_{t} ) = {\hat{h}}_{s \vert t} ( {x}_{t} ) \qquad ( 61 )$$

whose marginal follows qₛ (xₛ) due to it being the result of PF-ODE trajectories starting from qₜ(xₜ).

Concretely, DDIM interpolant satisfies all of the deterministic assumption, the regularity condition, and the invertibility assumption because it is a linear function of x and xₜ. Therefore, any diffusion or FM schedule with DDIM interpolant will enjoy a deterministic minimizer

$${p}_{s \vert t}^{θ} ( x \vert {x}_{t} ) .$$

### Example 3—Analysis of Simplified Parameterization

### 3.1 DDIM Interpolant

It is checked that DDIM interpolant is self-consistent. By definition, q_{s|t}(xₛ|x, xₜ)=δ(xₛ−DDIM(xₜ, x, t, s)). It is checked that for all s≤r≤t,

$$\begin{matrix}\int {q}_{s \vert r} ( {x}_{s} \vert x , {x}_{r} ) {q}_{r \vert t} ( {x}_{r} \vert x , {x}_{t} ) {dx}_{r} = \int δ ( {x}_{s} - DDIM ( {x}_{r} , x , r , s ) ) δ ( {x}_{r} - DDIM ( {x}_{t} , x , t , r ) ) {dx}_{r} \\ = δ ( {x}_{s} - DDIM ( DDIM ( {x}_{t} , x , t , r ) , x , r , s ) )\end{matrix}$$

$$where$$

$$\begin{matrix}DDIM ( DDIM ( {x}_{t} , x , t , r ) , x , r , s ) = {α}_{s} x + ( {σ}_{s} / {σ}_{r} ) ( [ {α}_{r} x + ( {σ}_{r} / {σ}_{t} ) ( {x}_{t} - {α}_{t} x ) \vert - {α}_{r} x ) ] - {α}_{r} x ) \\ = {α}_{s} x + ( {σ}_{s} / {σ}_{r} ) ( {σ}_{r} / {σ}_{t} ) ( {x}_{t} - {α}_{t} x ) \\ = {α}_{s} x + ( {σ}_{s} / {σ}_{r} ) ( {x}_{t} - {α}_{t} x ) \\ = DDIM ( {x}_{t} , x , t , s )\end{matrix}$$

Therefore, δ(xₛ−DDIM(DDIM(xₜ, x, t, r), x, r, s))=δ(xₛ−DDIM(xₜ, x, t, s)). So DDIM is self-consistent.

It also implies a Gaussian forward process

$${q}_{t} ( {x}_{t} \vert x ) = 𝒩 ( {α}_{t} x , {σ}_{t}^{2} {σ}_{d}^{2} I )$$

as in diffusion models. By definition,

$${q}_{t , 1} ( {x}_{t} \vert x ) = {q}_{t} ( {x}_{t} \vert x ) = \int {q}_{t} ( {x}_{t} \vert x , ϵ ) p ( ϵ ) d ϵ$$

so that xₜ is a deterministic transform given x and ϵ, i.e. x, =DDIM(ϵ, x, t, 1)=αₜx+σₜϵ, which implies

$$𝒩 ( {α}_{t} x , {σ}_{t}^{2} {σ}_{d}^{2} I ) .$$

3.2 Reusing xₜ for xᵣ

It is proposed propose that instead of sampling x, via forward flow αᵣx+σᵣϵ, xₜ is reused such that xᵣ=DDIM(xₜ, x, r, t) to reduce variance. In fact, for any self-consistent interpolant, one can reuse xₜ via xᵣ~q_{r|t} (xᵣ|x, xₜ) and xᵣ will follow qᵣ (xᵣ) marginally. It is checked

$${q}_{r} ( {x}_{r} ) {=}^{( a )} {q}_{r \vert t} ( {x}_{r} ) = \int \int {q}_{r \vert t} ( {x}_{r} \vert x , {x}_{t} ) {q}_{t} ( x \vert {x}_{t} ) {q}_{t} ( {x}_{t} ) {dxdx}_{t} = \int \int {q}_{r \vert t} ( {x}_{r} \vert x , {x}_{t} ) \int {q}_{t} ( {x}_{t} \vert x , ϵ ) q ( x ) p ( ϵ ) d ϵ {dxdx}_{t}$$

where (a) is due to Lemma 5. Sampling x, xₜ first then xᵣ~q_{r|t} (xᵣ|x, xₜ) respects the marginal distribution qᵣ (xᵣ).

### 3.3 Simplified Objective

The simplified objective is derived. Given MMD defined in Eq. (1), the objective is written as

$${ℒ}_{MMSD} ( θ ) = {𝔼}_{s , t} [ 𝔴 ( s , t ) {‖ {𝔼}_{{x}_{t}} [ k ( {f}_{s , t}^{θ} ( {x}_{t} ) , \cdot ) ] - {𝔼}_{{x}_{r}} [ k ( {f}_{s , r}^{θ -} ( {x}_{r} ) , \cdot ) ] ‖}_{ℋ}^{2} ] \qquad ( 62 )$$

$${=}^{( a )} {𝔼}_{s , t} [ 𝔴 ( s , t ) {‖ {𝔼}_{{x}_{t} , {x}_{r}} [ k ( {f}_{s , t}^{θ} ( {x}_{t} ) , \cdot ) - k ( {f}_{s , r}^{θ -} ( {x}_{r} ) , \cdot ) ] ‖}_{ℋ}^{2} ] \qquad ( 63 )$$

$$= {𝔼}_{s , t} [ 𝔴 ( s , t ) 〈 {𝔼}_{{x}_{t} , {x}_{r}} [ k ( {f}_{s , t}^{θ} ( {x}_{t} ) , \cdot ) - k ( {f}_{s , r}^{θ -} ( {x}_{r} ) , \cdot ) ] , {𝔼}_{{x}_{t}^{′} , {x}_{r}^{′}} [ k ( {f}_{s , t}^{θ} ( {x}_{t}^{′} ) , \cdot ) - k ( {f}_{s , r}^{θ -} ( {x}_{r}^{′} ) , \cdot ) ] 〉 ] \qquad ( 64 )$$

$$= {𝔼}_{s , t} [ 𝔴 ( s , t ) {𝔼}_{{x}_{t} , {x}_{r} , {x}_{t}^{′} , {x}_{r}^{′}} [ 〈 k ( {f}_{s , t}^{θ} ( {x}_{t} ) , \cdot ) , k ( {f}_{s , t}^{θ} ( {x}_{t}^{′} ) , \cdot ) 〉 + 〈 k ( {f}_{s , r}^{{θ}^{-}} ( {x}_{r} ) , \cdot ) , k ( {f}_{s , r}^{θ -} ( {x}_{r}^{′} ) , \cdot ) 〉 - 〈 k ( {f}_{s , t}^{θ} ( {x}_{t} ) , \cdot ) , k ( {f}_{s , r}^{θ -} ( {x}_{r}^{′} ) , \cdot ) 〉 - 〈 k ( {f}_{s , t}^{θ} ( {x}_{t}^{′} ) , \cdot ) , k ( {f}_{s , r}^{θ -} ( {x}_{r} ) , \cdot ) 〉 ] ] \qquad ( 65 )$$

$$= {𝔼}_{{x}_{t} , {x}_{r} , {x}_{t}^{′} , {x}_{r}^{′} , s , t} [ 𝔴 ( s , t ) [ k ( {f}_{s , t}^{θ} ( {x}_{t} ) , {f}_{s , t}^{θ} ( {x}_{t}^{′} ) ) + k ( {f}_{s , r}^{{θ}^{-}} ( {x}_{r} ) , {f}_{s , r}^{θ -} ( {x}_{r} ) , \cdot ) ) - k ( {f}_{s , t}^{θ} ( {x}_{t} ) , {f}_{s , r}^{θ -} ( {x}_{r}^{′} ) ) - k ( {f}_{s , t}^{θ} ( {x}_{t}^{′} ) , {f}_{s , r}^{θ -} ( {x}_{r} ) ) ] ] \qquad ( 66 )$$

where [symbol] ⋅, ⋅ [symbol] is in RKHS, (a) is due to the correlation between xᵣ and xₜ by re-using xₜ.

### 3.4 Empirical Estimation

As proposed in Gretton et al. (2012, which is incorporated by reference herein in its entirety), MMD is typically estimated with V-statistics by instantiating a matrix of size M×M such that a batch of B x samples,

$${\{ {x}^{( i , j )} \}}_{i = 1 , j = 1}^{B / M , M} ,$$

is separated into groups of M (assume B is divisible by M) particles

$${\{ {x}^{( i )} \}}_{i = 1}^{B}$$

where each group share a (sⁱ, rⁱ, tⁱ) sample. The Monte Carlo estimate becomes

$${\hat{ℒ}}_{MMSD} ( θ ) = \frac{1}{B / M} {\sum }_{i = 1}^{B / M} w ( {s}^{i} , {t}^{j} ) \frac{1}{{M}^{2}} {\sum }_{j = 1}^{M} {\sum }_{k = 1}^{M} [ k ( {f}_{{s}^{i} , {t}^{i}}^{θ} , ( {x}_{{t}^{i}}^{( i , j )} ) , {f}_{{s}^{i} , {t}^{i}}^{θ} , ( {x}_{{t}^{i}}^{( i , k )} ) ) + \text{} k \text{} ( {f}_{{s}^{i} , {r}^{i}}^{θ -} , ( {x}_{{r}^{i}}^{( i , j )} ) , {f}_{{s}^{i} , {r}^{i}}^{θ -} , ( {x}_{{r}^{i}}^{( i , k )} ) ) - 2 k ( {f}_{{s}^{i} , {t}^{i}}^{θ} , ( {x}_{{t}^{i}}^{( i , j )} ) , {f}_{{s}^{i} , {r}^{i}}^{θ -} , ( {x}_{{r}^{i}}^{( i , k )} ) ) ] \qquad ( 67 )$$

Computational efficiency. First it is noted that regardless of M, w only 2 model forward passes are required—one with and one without stop gradient, since the model takes in all B instances together within the batch and produce outputs for the entire batch. For the calculation of the loss, although the need for M particles may imply inefficient computation, the cost of this matrix computation is negligible in practice compared to the complexity of model forward pass. Suppose a forward pass for a single instance is [symbol] (K), then the total computation for computation loss for a batch of B instances is [symbol] (BK)+ [symbol] (BM). Deep neural networks often has K>>M, so [symbol] (BK) dominates the computation.

### 3.5 Simplified Parameterization

$${f}_{s , t}^{θ} ( {x}_{t} )$$

is derived for each parameterization, which now generally follows the form

$${f}_{s , t}^{θ} ( {x}_{t} ) = {c}_{skip} ( s , t ) {x}_{i} + {c}_{out} ( s , t ) {G}_{θ} ( {c}_{in} ( s , t ) {x}_{i} , {c}_{noise} ( s ) , {c}_{noise} ( t ) )$$

Identity. This is simply DDIM with x-prediction network.

$${f}_{s , t}^{θ} ( {x}_{t} ) ( {α}_{s} - \frac{{σ}_{s}}{{σ}_{t}} {α}_{t} ) {G}_{θ} ( \frac{{x}_{t}}{{σ}_{d} \sqrt{{α}_{t}^{2} + {σ}_{t}^{2}}} , {c}_{noise} ( s ) , {c}_{noise} ( t ) ) + \frac{{σ}_{s}}{{σ}_{t}} {x}_{t}$$

### Simple-EDM.

$$\begin{matrix}{f}_{s , t}^{θ} ( {x}_{t} ) = ( {α}_{s} - \frac{{σ}_{s}}{{σ}_{t}} {α}_{t} ) [ \frac{{α}_{t}}{{α}_{t}^{2} + {σ}_{t}^{2}} {x}_{t} - \frac{{σ}_{t}}{\sqrt{{α}_{t}^{2} + {σ}_{t}^{2}}} {σ}_{d} {G}_{θ} ( \frac{{x}_{t}}{{σ}_{d} \sqrt{{α}_{t}^{2} + {σ}_{t}^{2}}} , {c}_{noise} ( s ) , {c}_{noise} ( t ) ) ] + \frac{{σ}_{s}}{{σ}_{t}} {x}_{t} \\ = \frac{{α}_{s} {α}_{t} + {σ}_{s} {σ}_{t}}{{α}_{t}^{2} + {σ}_{t}^{2}} {x}_{t} - \frac{{α}_{s} {σ}_{t} - {σ}_{s} {α}_{t}}{\sqrt{{α}_{t}^{2} + {σ}_{t}^{2}}} {σ}_{d} {G}_{θ} ( \frac{{x}_{t}}{{σ}_{d} \sqrt{{α}_{t}^{2} + {σ}_{t}^{2}}} , {c}_{noise} ( s ) , {c}_{noise} ( t ) )\end{matrix}$$

When noise schedule is cosine,

$${f}_{s , t}^{θ} ( {x}_{t} ) = cos ( \frac{1}{2} π ( t - s ) ) {x}_{t} - sin ( \frac{1}{2} π ( t - s ) ) {σ}_{d} {G}_{θ} ( \frac{{x}_{t}}{{σ}_{d} \sqrt{{α}_{t}^{2} + {σ}_{t}^{2}}} , {c}_{noise} ( s ) , {c}_{noise} ( t ) ) .$$

And similar to Lu & Song (2024, which is incorporated by reference herein in its entirety), it can be shown that predicting xₛ=DDIM(xₜ, x, s, t) with [symbol] ₂ loss is equivalent to v-prediction with cosine schedule.

$$w ( s , t ) {‖ {f}_{s , t}^{θ} ( {x}_{t} ) - ( ( {α}_{s} - \frac{{σ}_{s}}{{σ}_{t}} {α}_{t} ) x + \frac{{σ}_{s}}{{σ}_{t}} {x}_{t} ) ‖}^{2} = w ( s , t ) {‖ \frac{{α}_{s} {α}_{t} + {σ}_{s} {σ}_{t}}{{α}_{t}^{2} + {σ}_{t}^{2}} {x}_{t} - \frac{{α}_{s} {σ}_{t} - {σ}_{s} {α}_{t}}{\sqrt{{α}_{t}^{2} + {σ}_{t}^{2}}} {σ}_{d} {G}_{θ} ( \frac{{x}_{t}}{{σ}_{d} \sqrt{{α}_{t}^{2} + {σ}_{t}^{2}}} , {c}_{noise} ( s ) , {c}_{noise} ( t ) ) - ( ( {α}_{s} - \frac{{σ}_{s}}{{σ}_{t}} {α}_{t} ) x + \frac{{σ}_{s}}{{σ}_{t}} {x}_{t} ) ‖}^{2} = \tilde{w} ( s , t ) {‖ {σ}_{d} {G}_{θ} ( \frac{{x}_{t}}{{σ}_{d} \sqrt{{α}_{t}^{2} + {σ}_{t}^{2}}} , {c}_{noise} ( s ) , {c}_{noise} ( t ) ) - {\underbrace{( - \frac{\sqrt{{α}_{t}^{2} + {σ}_{t}^{2}}}{{α}_{s} {σ}_{t} - {σ}_{s} {α}_{t}} ) ( ( {α}_{s} - \frac{{σ}_{s}}{{σ}_{t}} {α}_{t} ) x + \frac{{σ}_{s}}{{σ}_{t}} {x}_{t} - \frac{{α}_{s} {α}_{t} + {σ}_{s} {σ}_{t}}{{α}_{t}^{2} + {σ}_{t}^{2}} {x}_{t} )}}_{{G}_{target}} ‖}^{2} \\ where$$

$$\begin{matrix}{G}_{target} = ( - \frac{\sqrt{{α}_{t}^{2} + {σ}_{t}^{2}}}{{α}_{s} {σ}_{t} - {σ}_{s} {α}_{t}} ) ( ( {α}_{s} - \frac{{σ}_{s}}{{σ}_{t}} {α}_{t} ) x + \frac{{σ}_{s}}{{σ}_{t}} {x}_{t} - \frac{{α}_{s} {α}_{t} + {σ}_{s} {σ}_{t}}{{α}_{t}^{2} + {σ}_{t}^{2}} {x}_{t} ) \\ = ( - \frac{\sqrt{{α}_{t}^{2} + {σ}_{t}^{2}}}{{α}_{s} {σ}_{t} - {σ}_{s} {α}_{t}} ) ( ( {α}_{s} - \frac{{σ}_{s}}{{σ}_{t}} {α}_{t} ) x + \frac{{α}_{s} {α}_{t}^{2} + \text{?} - {α}_{s} {α}_{t} {σ}_{t} - \text{?}}{{σ}_{t} ( {α}_{t}^{2} + {σ}_{t}^{2} )} ( {α}_{t} x + {σ}_{t} ϵ ) ) \\ = ( - \frac{\sqrt{{α}_{t}^{2} + {σ}_{t}^{2}}}{{α}_{s} {σ}_{t} - {σ}_{s} {α}_{t}} ) ( \frac{( {α}_{s} {σ}_{t} - {σ}_{s} {α}_{t} ) ( {α}_{t}^{2} + {σ}_{t}^{2} ) + {σ}_{s} {α}_{t}^{3} - {α}_{s} {α}_{t}^{2} {σ}_{t}}{{σ}_{t} ( {α}_{t}^{2} + {σ}_{t}^{2} )} x + \frac{{σ}_{s} {α}_{t}^{2} - {α}_{s} {α}_{t}^{2} {σ}_{t}}{{α}_{t}^{2} + {σ}_{t}^{2}} ϵ ) \\ = ( - \frac{\sqrt{{α}_{t}^{2} + {σ}_{t}^{2}}}{{α}_{s} {σ}_{t} - {σ}_{s} {α}_{t}} ) ( \frac{( {α}_{s} {σ}_{t} - {σ}_{s} {α}_{t} ) ( {α}_{t}^{2} + {σ}_{t}^{2} ) - ( {α}_{t} {σ}_{t} - {σ}_{s} {α}_{t} ) {α}_{t}^{2}}{{α}_{t}^{2} + {σ}_{t}^{2}} x - \frac{( {α}_{s} {σ}_{t} - {σ}_{s} {α}_{t} ) {α}_{t}}{{σ}_{t} ( {α}_{t}^{2} + {σ}_{t}^{2} )} ϵ ) \\ = \frac{{α}_{t} ϵ - {σ}_{t} x}{\sqrt{{α}_{t}^{2} + {σ}_{i}^{2}}}\end{matrix}$$

This reduces to v-target if cosine schedule is used, and it deviates from v-target if FM schedule is used instead.

### Euler-FM. Assume OT-FM Schedule.

$$\begin{matrix}{f}_{s , t}^{θ} ( {x}_{t} ) = ( ( 1 - s ) - \frac{s}{t} ( 1 - t ) ) [ {x}_{t} - t {σ}_{d} {G}_{θ} ( \frac{{x}_{t}}{{σ}_{d} \sqrt{{α}_{t}^{2} + {σ}_{t}^{2}}} , {c}_{noise} ( s ) , {c}_{noise} ( t ) ) ] + \\ \frac{s}{t} {x}_{t} \\ = ( ( 1 - \frac{s}{t} ) [ {x}_{t} - t {σ}_{d} {G}_{θ} ( \frac{{x}_{t}}{{σ}_{d} \sqrt{{α}_{t}^{2} + {σ}_{t}^{2}}} , {c}_{noise} ( s ) , {c}_{noise} ( t ) ) ] + \frac{s}{t} {x}_{t} \\ = {x}_{t} - ( t - s ) {σ}_{d} {G}_{θ} ( \frac{{x}_{t}}{{σ}_{d} \sqrt{{α}_{t}^{2} + {σ}_{t}^{2}}} , {c}_{noise} ( s ) , {c}_{noise} ( t ) )\end{matrix}$$

This results in Euler ODE from xₜ to xₛ. It is also shown that the network output reduces to v-prediction if matched with xₛ=DDIM(xₜ, x, s, t). To see this,

$$w ( s , t ) {‖ {f}_{s , t}^{θ} ( {x}_{t} ) - ( ( ( 1 - s ) - \frac{s}{t} ( 1 - t ) ) x + \frac{s}{t} {x}_{t} ) ‖}^{2} = w ( s , t ) {‖ {f}_{s , t}^{θ} ( {x}_{t} ) - ( ( 1 - \frac{s}{t} ) x + \frac{s}{t} {x}_{t} ) ‖}^{2} = w ( s , t ) {‖ {x}_{t} - ( t - s ) {σ}_{d} {G}_{θ} ( \frac{{x}_{t}}{{σ}_{d} \sqrt{{α}_{t}^{2} + {σ}_{t}^{2}}} , {c}_{noise} ( s ) , {c}_{noise} ( t ) ) - ( ( 1 - \frac{s}{t} ) x + \frac{s}{t} {x}_{t} ) ‖}^{2} = \tilde{w} ( s , t ) {‖ {σ}_{d} {G}_{θ} ( \frac{{x}_{t}}{{σ}_{d} \sqrt{{α}_{t}^{2} + {σ}_{t}^{2}}} , {c}_{noise} ( s ) , {c}_{noise} ( t ) ) - ( - \frac{1}{( t - s )} ) ( ( 1 - \frac{s}{t} ) x + ( \frac{s}{t} - 1 ) {x}_{t} ) ‖}^{2} = \tilde{w} ( s , t ) {‖ {σ}_{d} {G}_{θ} ( \frac{{x}_{t}}{{σ}_{d} \sqrt{{α}_{t}^{2} + {σ}_{t}^{2}}} , {c}_{noise} ( s ) , {c}_{noise} ( t ) ) - {\underbrace{( - \frac{1}{( t - s )} ) ( ( 1 - \frac{s}{t} ) x + ( \frac{s}{t} - 1 ) {x}_{t} )}}_{{G}_{target}} ‖}^{2} \\ where \\ \begin{matrix}{G}_{target} = ( - \frac{1}{( t - s )} ) ( ( 1 - \frac{s}{t} ) x + ( \frac{s}{t} - 1 ) ( ( 1 - t ) x + t ϵ ) ) \\ = ( - \frac{1}{( t - s )} ) ( ( 1 - \frac{s}{t} ) x + ( \frac{s}{t} - s - 1 + t ) x + ( s - t ) ϵ ) \\ = ( - \frac{1}{( t - s )} ) ( ( t - s ) x + ( s - t ) ϵ ) \\ = ϵ - x\end{matrix}$$

which is v-target under OT-FM schedule. This parameterization naturally allows zero-SNR sampling and satisfies boundary condition at s=0, similar to Simple-EDM above. This is not true for Identity parametrization using Go as it satisfies boundary condition only at s>0.
   3.6 Mapping Function r(s,t)

The concrete choices for r(s, t) are discussed below. A constant decrement ϵ>0 is used in different spaces.

Constant decrement in η(t):=ηₜ=σₜ/αₜ. This is the choice that is found to work better than other choices in practice. First, let its inverse be η⁻¹(⋅),

$$r ( s , t ) = max ( s , {η}^{- 1} ( η ( t ) - ϵ ) )$$

Choose ϵ==(ηₘₐₓ−ηₘᵢₙ)/2^{k} for some k. ηₘₐₓ≈160 and ηₘᵢₙ≈0 may be chosen. k={10, . . . , 15}works well enough depending on datasets.

Constant decrement in t,

$$r ( s , t ) = max ( s , t - ϵ )$$

Choose ϵ=(T−ϵ)/2^{k},

Constant decrement in

$$λ ( t ) := log - {SNR}_{t} = 2 log ( {α}_{t} / {σ}_{t} ) .$$

Let its inverse be λ⁻¹ (⋅), then

$$r ( s , t ) = max ( s , {λ}^{- 1} ( λ ( t ) - ϵ ) ) )$$

Choose ∈=(λₘₐₓ−λₘᵢₙ)/2^{k}. This choice comes close to the first choice, but this is refrained from because r(s, t) becomes close to t both when t≈0 and t≈1 instead of just t≈1. This gives more chances for training instability than the first choice.

Constant increment in 1/η(t).

$$r ( s , t ) = max ( s , {η}^{- 1} ( \frac{1}{1 / η ( t ) - ϵ} ) )$$

Choose ϵ=(1/η(t)ₘᵢₙ−1/η(t)ₘₐₓ)/2^{k}.

3.7 Time Distribution p(s, t)

In all cases choose p(t)= [symbol] (ϵ, T) and p(s|t)= [symbol] (ϵ, t) for some ϵ≥0 and T≤1. The decision for time distribution is coupled with r(s, t). The constraints on p(s, t) for each r(s, t) choice are listed below.

Constant decrement in η(t). T<1 needs to be chosen because, for example, assuming OT-FM schedule, ηₜ=t/(1−t), one can observe that constant decrement in ηₜ, when t≈1 results in r(s, t) that is too close to t due to ηₜ's exploding gradient around 1. T<1 needs to be defined such that r(s, T) is not too close to T for s reasonably far away. With ηₘₐₓ≈160, T=0.994 can be chosen for OT-FM and T=0.996 for VP-diffusion.

Constant decrement in t. No constraints needed. T=1, ϵ=0.

Constant decrement in λₜ. One can similarly observe exploding gradient causing r(s, t) to be too close to t at both t≈0 and t≈1, so, e.g. 0.001 can be chosen, in addition to choosing T=0.994 for OT-FM and T=0.996 for VP-diffusion.

Constant increment in 1/ηₜ. This experience exploding gradient for t≈0, so ϵ<0 is required, e.g. 0.005. And T=1.

### 3.8 Kernel Function

For the Laplace kernel k(x, y)=exp(−\acute{ω}(s, t) max(∥x-y∥₂, ϵ)/D), let ϵ>0 be a reasonably small constant, e.g. 10⁻⁸. Looking at its gradient w.r.t. x,

$${∇}_{x} e {\text{?}}^{− w ( s , t ) max ( {‖ x − y ‖}_{2} , ϵ ) / D} = \{ \begin{matrix}− \frac{w \text{?} ( s , t )}{D} ϵ {\text{?}}^{− w ( s , t ) {‖ x − y ‖}_{2} / D} \frac{x − y}{{‖ x − y ‖}_{2}} , & if {‖ x − y ‖}_{2} > ϵ \\ 0 , & otherwise\end{matrix}$$

$$\text{?} \text{indicates text missing or illegible when filed}$$

one can notice that the gradient is self-normalized to be a unit vector, which is helpful in practice. In comparison, the gradient of RBF kernel of the

$$k ( x , y ) = exp ( \frac{1}{2} w \text{?} ( s , t ) {‖ x - y ‖}^{2} / D ) \text{?}$$

$$\text{?} \text{indicates text missing or illegible when filed}$$

form

$${∇}_{x} e {\text{?}}^{− w ( s , t ) {‖ x − y ‖}^{2} / D} = - \frac{w \text{?} ( s , t )}{D} e {\text{?}}^{− w ( s , t ) \frac{1}{2} {‖ x − y ‖}^{2} / D} ( x − y ) \qquad ( 68 )$$

$$\text{?} \text{indicates text missing or illegible when filed}$$

whose magnitude can vary a lot depending on how far x is from y.

For \acute{ω}(s,t) it is helpful to write out the [symbol] ₂ loss between the arguments. For simplicity, denote

$${\hat{G}}_{θ} ( {x}_{t} , s , t ) = {G}_{θ} ( \frac{x \text{?}}{σ \text{?} \sqrt{α \text{?} + \text{?}}} , {c}_{noise} ( s ) , {c}_{noise} ( t ) )$$

$$\begin{matrix}w \text{?} ( s , t ) {‖ {f}_{s , t}^{θ} ( {x}_{t} ) - f \text{?} ( {x}_{r}^{′} ) ‖}_{2} = \begin{matrix}w \text{?} ( s , t ) ‖ \text{?} ( s , t ) x \text{?} + \text{?} ( s , t ) {\hat{G}}_{θ} ( {x}_{i} , s , t ) - \\ {( {c}_{skip} ( s , r ) {x}_{r}^{′} + \text{?} ( s , r ) \hat{G} ( {x}_{r}^{′} , s , r ) ) ‖}_{2}\end{matrix} \\ = \begin{matrix}w \text{?} ( s , t ) \text{?} ( s , t ) ‖ {\hat{G}}_{θ} ( {x}_{t} , s , t ) - \frac{1}{\text{?} ( s , t )} ( {c}_{skip} ( s , r ) ) {x}_{r}^{′} + \\ {\text{?} ( s , r ) \hat{G} ( {x}_{r}^{′} , s , r ) - {c}_{skip} ( s , t ) {x}_{t} ) ‖}_{2}\end{matrix}\end{matrix}$$

$$\text{?} \text{indicates text missing or illegible when filed}$$

Set \tilde{w}(s, t)=1/cₒᵤₜ(s, t) for the overall weighting to be 1. This allows invariance of magnitude of kernels w.r.t. t.

3.9 Weighting Function w(s,t)

To review VDM (Kingma et al., 2021, which is incorporated by reference herein in its entirety), the negative ELBO loss for diffusion model is

$${ℒ}_{ELB0} ( θ ) = \frac{1}{2} {𝔼}_{x , ϵ , t} [ ( − \frac{d}{dt} {λ}_{t} ) {‖ {ϵ}_{θ} ( {x}_{t} , t ) − ϵ ‖}^{2} ] \qquad ( 69 )$$

where ϵ_{θ} is the noise-prediction network and λₜ=log-SNRₜ. The weighted-ELBO loss proposed in Kingma & Gao (2024, which is incorporated by reference herein in its entirety) introduces an additional weighting function w(t) monotonically increasing in t (monotonically decreasing in log-SNRₜ) understood as a form of data augmentation. Specifically, they use sigmoid as the function such that the weighted ELBO is written as

$${ℒ}_{w - ELB0} ( θ ) = \frac{1}{2} {𝔼}_{x , ϵ , t} [ σ ( b − {λ}_{t} ) ( − \frac{d}{dt} {λ}_{t} ) {‖ {ϵ}_{θ} ( {x}_{t} , t ) − ϵ ‖}^{2} ] \qquad ( 70 )$$

where σ(⋅) is sigmoid function.

The αₜ is tailored towards the Simple-EDM and Euler-FM parameterization as shown in Example 3.5 that the networks σ_{d}G_{θ} amounts to v-prediction in cosine and OT-FM schedules. Notice that ELBO diffusion loss matches c instead of v. Inspecting the gradient of Laplace kernel, (again, for simplicity let

$${\hat{G}}_{θ} ( {x}_{t} , s , t ) = {G}_{θ} ( \frac{x \text{?}}{σ \text{?} \sqrt{α \text{?} + \text{?}}} , {c}_{noise} ( s ) , {c}_{noise} ( t ) ) ) .$$

$$\begin{matrix}\frac{\partial }{\partial θ} e {\text{?}}^{− w ( s , t ) {‖ {f}_{s , t}^{θ} ( {x}_{t} ) − {f}_{s , r}^{θ −} ( {x}_{r} ) ‖}_{2} / D} = \begin{matrix}- \frac{w \text{?} ( s , t )}{D} e {\text{?}}^{− w ( s , t ) {‖ {f}_{s , t}^{θ} ( {x}_{t} ) − {f}_{s , r}^{θ −} ( {x}_{r} ) ‖}_{2} / D} \\ \frac{{f}_{s , t}^{θ} ( {x}_{t} ) - {f}_{s , r}^{θ -} ( {x}_{r} )}{{‖ {f}_{s , t}^{θ} ( {x}_{t} ) - {f}_{s , r}^{θ -} ( {x}_{r} ) ‖}_{2}} \frac{\partial }{\partial θ} {f}_{s , t}^{θ} ( {x}_{t} )\end{matrix} \\ = \begin{matrix}- \frac{w \text{?} ( s , t )}{D} e {\text{?}}^{− w ( s , t ) {‖ {f}_{s , t}^{θ} ( {x}_{t} ) − {f}_{s , r}^{θ −} ( {x}_{r} ) ‖}_{2} / D} \\ \frac{{\hat{G}}_{θ} ( {x}_{t} , s , t ) - {\hat{G}}_{target}}{{‖ {\hat{G}}_{θ} ( {x}_{t} , {s}_{t} , t ) - {\hat{G}}_{target} ‖}_{2}} \frac{\partial }{\partial θ} {f}_{s , t}^{θ} ( {x}_{t} )\end{matrix}\end{matrix}$$

$$\text{?} \text{indicates text missing or illegible when filed}$$

for some constant Ĝ_{target}. It is shown that gradient

$$\frac{\text{?}}{\text{?}} {f}_{s , t}^{θ} ( {x}_{t} )$$

$$\text{?} \text{indicates text missing or illegible when filed}$$

is guided by vector Ĝ_{θ}(xₜ, s,t)−Ĝ_{target}. Assuming Ĝ_{θ}(xₜ, s, t) is v-prediction, as is the case for Simple-EDM parameterization with cosine schedule and Euler-FM parameterization with OT-FM schedule, v- to ϵ-prediction can be reparametrized with ϵ_{θ} as the new parameterization. Arguments to network are omitted for simplicity.

It is shown below that for both cases ε_{θ}−ϵ_{target}=αₜ(Ĝ_{θ}−Ĝ_{target}) for some constants ϵ_{target} and Ĝ_{target}. For Simple-EDM, it is known that x-prediction from v-prediction parameterization (Salimans & Ho, 2022, which is incorporated by reference herein in its entirety), x_{θ}=αᵣxₜ−σₜĜ_{θ}, and it is also known that x-prediction from ϵ-prediction, x_{θ}=(xₜ−σₜϵ_{θ})/αₜ.

$$\begin{matrix} & \frac{{x}_{t} − {σ}_{t} {ϵ}_{θ}}{{α}_{t}} = {α}_{t} x \text{?} − {σ}_{t} {\hat{G}}_{θ}\end{matrix} \qquad ( 71 )$$

$$⇔ {x}_{t} − {σ}_{t} {ϵ}_{θ} = {α}_{t}^{2} {x}_{t} − {α}_{t} {σ}_{t} {\hat{G}}_{θ} \qquad ( 72 )$$

$$⇔ ( 1 − {α}_{t}^{2} ) x \text{?} + {α}_{t} {σ}_{t} {\hat{G}}_{θ} - {σ}_{t} {ϵ}_{θ} \qquad ( 73 )$$

$$⇔ {σ}_{t}^{2} {x}_{i} + {α}_{t} {σ}_{t} {\hat{G}}_{θ} - {σ}_{t} {ϵ}_{θ} \qquad ( 74 )$$

$$⇔ {ϵ}_{θ} = {σ}_{t} {x}_{t} + {α}_{t} {\hat{G}}_{θ} \qquad ( 75 )$$

$$⇔ {ϵ}_{θ} - {ϵ}_{target} = {σ}_{t} {x}_{t} + {α}_{t} {\hat{G}}_{θ} - ( {σ}_{t} {x}_{t} + {α}_{t} {\hat{G}}_{target} ) \qquad ( 76 )$$

$$⇔ {ϵ}_{θ} − {ϵ}_{target} = {α}_{t} ( {\hat{G}}_{θ} − {\hat{G}}_{target} ) \qquad ( 77 )$$

$$\text{?} \text{indicates text missing or illegible when filed}$$

For Euler-FM, x-prediction from v-prediction parameterization is known, x_{θ}=xₜ−tĜ_{θ} and x-prediction from ϵ-prediction is also known, x_{θ}=(xₜ−tϵ_{θ})/(1−t).

$$\begin{matrix} & \frac{{x}_{t} − t {ϵ}_{θ}}{1 - t} = {x}_{t} − t {\hat{G}}_{θ}\end{matrix} \qquad ( 78 )$$

$$⇔ {x}_{t} − t {ϵ}_{θ} = ( 1 - t ) {x}_{t} − t ( 1 − t ) {\hat{G}}_{θ} \qquad ( 79 )$$

$$⇔ t x \text{?} + t ( 1 − t ) {\hat{G}}_{θ} - t {ϵ}_{θ} \qquad ( 80 )$$

$$⇔ {ϵ}_{θ} - {x}_{t} + ( 1 − t ) {\hat{G}}_{θ} \qquad ( 81 )$$

$$⇔ {ϵ}_{θ} = {x}_{t} + {α}_{t} {\hat{G}}_{θ} \qquad ( 82 )$$

$$⇔ {ϵ}_{θ} - {ϵ}_{target} = {x}_{t} + {α}_{t} {\hat{G}}_{θ} - ( {x}_{t} + {α}_{t} {\hat{G}}_{target} ) \qquad ( 83 )$$

$$⇔ {ϵ}_{θ} − {ϵ}_{target} = {α}_{t} ( {\hat{G}}_{θ} − {\hat{G}}_{target} ) \qquad ( 84 )$$

$$\text{?} \text{indicates text missing or illegible when filed}$$

In both cases, (Ĝ_{θ}(xₜ, s, t)−Ĝ_{target}) can be rewritten to (ϵ_{θ}(xₜ, s, t)−ϵ_{target}) by multiplying a factor αₜ, and the guidance vector now matches that of the ELBO-diffusion loss. Therefore, one is motivated to incorporate αₜ into w(s, t) as proposed.

Lastly, the division of αₜ²+σₜ² is inspired by the increased weighting for middle time-steps (Esser et al., 2024, which is incorporated by reference herein in its entirety) for Flow Matching training. This is purely an empirical decision.

### Example 4—Training Algorithm

Lastly, the division of αₜ²+σₜ² is inspired by the increased weighting for middle time-steps (Esser et al., 2024, which is incorporated by reference herein in its entirety) for Flow Matching training. This is purely an empirical decision.

```
Algorithm 3 MMSD Training
Input: model f^{θ}, data distribution q(x) and label distribution q(c|x) (if label is used), prior
$distribution 𝒩 ( 0 , {σ}_{d}^{2} I ) . , time distribution p ( t ) and p ( s \vert t ) , DDIM interpolator DDIM ( {x}_{t} , x , s , t ) and its$
flow coefficients αₜ, σₜ, mapping function r(s, t), kernel function k(•, •), weighting function w(s,
t), batch size B, particle number M, label dropout probability p
$Output : learned model {f}_{s , t}^{θ}$
Initialize n ← 0, θ⁰ ← θ
while model not converged do
  Sample a batch of data, label, and prior, and split into B/M groups,
  ${\{ ( {x}^{( i , j )} , {c}^{( i , j )} , {ϵ}^{( i , j )} ) \}}_{i = 1 , j = 1}^{B / M , M}$
  $For each group , sample {\{ ( {s}^{i} , {t}^{i} ) \}}_{i = 1}^{B / M} and {r}^{i} = r ( {s}^{i} , {t}^{i} ) for each i . this results in a tuple$
  ${\{ ( {s}^{i} , {r}^{i} , {t}^{i} ) \}}_{i = 1}^{B / M}$
  ${x}_{{t}^{i}}^{( i , j )} ← DDIM ( {ϵ}^{( i , j )} , {x}^{( i , j )} , {t}^{i} , 1 ) = {α}_{{t}^{i}} {x}^{( i , j )} + {σ}_{{t}^{i}} {ϵ}^{( i , j )} , ∀ ( i , j )$
  ${x}_{{r}^{i}}^{( i , j )} ← DDIM ( {x}_{{t}^{i}}^{( i , j )} , {x}^{( i , j )} , {r}^{i} , {t}^{i} ) , ∀ ( i , j )$
(Optional) Randomly drop each label c^{(i,j)} to be null token Ø with probability p
θₙ₊₁← optimizer step by minimizing [symbol]  _{MMSD}(θₙ) using model f^{θ}^{ₙ} (see Eq. (67)) (optionally
inputting c^{(i, j)} into network)
end while
```

### Example 5—Classifier-Free Guidance

Readers are referred to Example 3.5 for analysis of each parameterization. Most notably, the network G_{θ} in both (1) Simple-EDM with cosine diffusion schedule and (2) Euler-FM with OT-FM schedule are equivalent to v-prediction parameterization in diffusion (Salimans & Ho, 2022, which is incorporated by reference herein in its entirety) and FM (Lipman et al., 2022, which is incorporated by reference herein in its entirety). When conditioned on label c during sampling, it is customary to use classifier-free guidance to reweight this v-prediction network via

$${G}_{θ}^{W} ( {c}_{in} ( t ) {x}_{t} , {c}_{noise} ( s ) , {c}_{noise} ( t ) , c ) = {wG}_{θ} ( {c}_{in} ( t ) {x}_{t} , {c}_{noise} ( s ) , {c}_{noise} ( t ) , c ) + ( 1 − w ) {G}_{θ} ( {c}_{in} ( t ) {x}_{t} , {c}_{noise} ( s ) , {c}_{noise} ( t ) , ϕ ) \qquad ( 85 )$$

with guidance weight w so that the classifier-free guided

$${f}_{s , t , w}^{θ} ( {x}_{t} )$$

is

$${f}_{s , t , w}^{θ} ( {x}_{t} ) = {c}_{skip} ( s , t ) {x}_{t} + {c}_{out} ( s , t ) {G}_{θ}^{w} ( {c}_{in} ( t ) {x}_{t ,} {c}_{noise} ( s ) , {c}_{noise} ( t ) , c ) \qquad ( 86 )$$

### Example 6—Sampling Algorithms

Pushforward sampling. Assume a series of N time steps

$${\{ t \text{?} \}}_{i = 0}^{N}$$

$$\text{?} \text{indicates text missing or illegible when filed}$$

with T=t>t_{N}>t_{N-1}> . . . >t₂>t₁>t₀=ϵ for the maximum time T and minimum time ϵ. Denote σ_{d} as data standard deviation.

Algorithm 4 Pushforward Sampling
$Input : model {f}^{θ} , time steps {\{ {t}_{i} \}}_{i = 0}^{N} , prior distribution 𝒩 ( 0 , {σ}_{d}^{2} I ) , ( optional ) guidance weight w$
Output: xₜ_{₀}
$Sample {x}_{N} ∼ 𝒩 ( 0 , {σ}_{d}^{2} I )$
for i = N, . . . , 1 do
(Optional) w ← 1 if N =1 // can optionally discard unconditional branch for N = 1
${x}_{{t}_{i - 1}} ← {f}_{{t}_{i - 1} , {t}_{i}}^{θ} ( {x}_{{t}_{i}} ) or {f}_{{t}_{i - 1} , {t}_{i} , w}^{θ} ( {x}_{{t}_{i}} )$
end for

Restart sampling. Different from pushforward sampling, N time steps

$${\{ {t}_{i} \}}_{i = 0}^{N}$$

do not need to be strictly decreasing for all time steps, e.g. T=t_{N}>t_{N}−1> . . . >₂>t₁>t₀=ϵ(assuming T>ϵ). Different from pushforward sampling, restart sampling first denoise a clean sample before resampling a noise to be added to this clean sample. Then a clean sample is predicted again. The process is iterated for N steps.

Algorithm 5 Restart Sampling
$Input : model {f}^{θ} , time steps {\{ {t}_{i} \}}_{i = 0}^{N} , prior distribution 𝒩 ( 0 , {σ}_{d}^{2} I ) , , DDIM interpolant coefficients {α}_{t} and$
σₜ, (optional) guidance weight w
Output: xₜ_{_{θ}}
Sample
$for i = N , {x}_{N} \sim 𝒩 ( 0 , {σ}_{d}^{2} I ) … , 1 do$
(Optional) w ← 1 if N =1 // can optionally discard unconditional branch for N = 1
${x}^{} ← {f}_{{t}_{α} , {t}_{i}}^{θ} ( {x}_{{t}_{i}} ) or {f}_{{t}_{0} , {t}_{i} , w}^{θ} ( {x}_{{t}_{i}} )$
if i ≠ 1 then
${ϵ}^{} \sim 𝒩 ( 0 , {σ}_{d}^{2} I )$
xₜ_{_{i−1}} ← αₜ_{_{i−1}} \tilde{x} + σₜ_{_{i−1}}\tilde{ϵ} //or more generally xₜ_{_{i−1}} ~ qₜ(xₜ_{_{i−1}}|\tilde{x}, \tilde{ϵ})
else
xₜ_{_{θ}} = \tilde{x}
end if
end for

### Example 7—Consistency with Additional Models

### 7.1 Consistency Models

Consistency models explicitly match PF-ODE trajectories using a network g_{θ}|(xₜ, t) that directly outputs a sample given any xₜ~qₜ (xₜ). The network explicitly uses EDM parameterization to satisfy boundary condition g_{θ}(x₀, 0)=x₀ and trains via loss [symbol] [symbol] where xᵣ is a deterministic function of xₜ from an ODE solver.

It is shown that CM loss is a special case of the simplified MMSD objective.
Lemma 1. When

$${x}_{t} = {x}_{i}^{′} , {x}_{r} = {x}_{r}^{′} , k ( x , y ) = - {‖ x - y ‖}^{2} ,$$

and s≥0 is a small constant, Eq. (12) reduces to CM loss [symbol] ₓ_{ₜ}_{x, t}[w(t)∥g_{θ}(xₜ, t)−g_{θ}. . . (xᵣ, r)∥²]+C for a valid r(t)<t and some constant C.
Proof. Since

$${x}_{t} = {x}_{t}^{′} , {x}_{r} = {x}_{r}^{′} ,$$

we have

$${f}_{s , t}^{θ} ( {x}_{i} ) = {f}_{s , t}^{θ} ( {x}_{t}^{′} ) and {f}_{s , r}^{θ} ( {x}_{r} ) = {f}_{s , r}^{θ} ( {x}_{r}^{′} ) . So k ( {f}_{s , t}^{θ} ( {x}_{t} ) , {f}_{s , t}^{θ} ( {x}_{i}^{′} ) ) = k ( {f}_{s , r}^{θ} ( {x}_{r} ) , {f}_{s , r}^{θ} ( {x}_{r}^{′} ) ) = 1$$

by definition. Since k(x, y)=∥x-y∥², it is easy to see Eq. (12) reduces to

$${𝔼}_{{x}_{t} , t} [ w ( s , t ) {‖ {f}_{s , t}^{θ} ( {x}_{t} ) - {f}_{s , r}^{θ} ( {x}_{r} ) ‖}^{2} ] + C \qquad ( 87 )$$

where C=2 and w(s, t) is a weighting function. If s is a small positive constant, have

$$\text{?}$$

$$\text{?} \text{indicates text missing or illegible when filed}$$

where s is dropped as input. If g_{θ}(xₜ, t) itself satisfies boundary condition at s=0, s=0 can be directly taken in which case

$$\text{?}$$

$$\text{?} \text{indicates text missing or illegible when filed}$$

And under these assumptions, the loss becomes

$${𝔼}_{{x}_{t} , x , t} [ w ( t ) {‖ {g}_{θ} ( {x}_{t} , t ) - {g}_{θ} \text{?} ( {x}_{r} , r ) ‖}^{2} ] + C ,$$

$$\text{?} \text{indicates text missing or illegible when filed}$$

which is simply a CM loss [symbol] ₂ using distance.

However, one can notice that from a moment-matching perspective, this loss is problematic in two aspects. First, it assumes single particle estimate, which now ignores the entropy repulsion term in MMD that arises only during multi-particle estimation. This can contribute to mode collapse and training instability of CM. Second, the choice of energy kernel only matches the first moment, which is insufficient for matching two complex distributions!Kernels that match higher moments should be used in practice. In fact, it is shown in the following Lemma that the pseudo-huber loss proposed in Song & Dhariwal (2023, which is incorporated by reference herein in its entirety) matches higher moments as a kernel.
Lemma 2. Negative pseudo-huber loss k_{c}(x, y)=c−\sqrt{∥x-y∥²+c²} for c>0 is a conditionally positive definite kernel that matches all moments of x and y where weights on higher moments depend on c.

Proof First check that negative pseudo-huber loss c~\sqrt{∥x-y∥²+c²} is a conditionally positive definite kernel (Auffray & Barbillon, 2009, which is incorporated by reference herein in its entirety). By definition, k(x, y) is conditionally positive definite if for x₁, . . . , xₙ ∈ [symbol] ^{D} and c₁, . . . , , cₙ ∈ [symbol] ^{D} with

$${\sum }_{i = 1}^{n} {c}_{i} = 0 \qquad ( 89 )$$

$${\sum }_{i = 1}^{n} {\sum }_{j = 1}^{n} {c}_{i} {c}_{j} k ( {x}_{i} , {x}_{j} ) \geq 0$$

It is known that negative L₂ distance −∥x-y∥ is conditionally positive definite. This is proven below for completion. Due to triangle inequality, −∥x-y∥≥−∥x∥-∥y∥. Then

$$\begin{matrix}{\sum }_{i = 1}^{n} {\sum }_{j = 1}^{n} {c}_{i} {c}_{j} ( - ‖ {x}_{i} - {x}_{j} ‖ ) \geq {\sum }_{i = 1}^{n} {\sum }_{j = 1}^{n} {c}_{i} {c}_{j} ( - ‖ {x}_{i} ‖ - ‖ {x}_{j} ‖ ) ( 90 ) \\ = - {\sum }_{i = 1}^{n} {c}_{i} ( {\sum }_{j = 1}^{n} {c}_{j} ‖ {x}_{j} ‖ ) - {\sum }_{j = 1}^{n} {c}_{j} ( {\sum }_{i = 1}^{n} {c}_{i} ‖ {x}_{i} ‖ ) ( 91 ) \\ {=}^{( a )} 0 ( 92 )\end{matrix}$$

where (α) is due to

$${\sum }_{i = 1}^{n} {c}_{i} = 0.$$

Now since for all c−\sqrt{∥z∥²+c²}≥−∥z∥ for all c>0, have

$${\sum }_{i = 1}^{n} {\sum }_{j = 1}^{n} {c}_{i} {c}_{j} ( c - \sqrt{{‖ {x}_{i} - {x}_{j} ‖}^{2} + {c}^{2}} ) \geq {\sum }_{i = 1}^{n} {\sum }_{j = 1}^{n} {c}_{i} {c}_{j} ( - ‖ {x}_{i} - {x}_{j} ‖ ) \geq 0 \qquad ( 93 )$$

So negative pseudo-huber loss is a valid conditionally positive definite kernel.

Next, pseudo-huber loss's effect on higher-order moments is analyzed by directly Taylor expanding \sqrt{∥z∥²+c²}−c at z=0

$$\begin{matrix}\sqrt{{‖ z ‖}^{2} + {c}^{2}} - c = \frac{1}{2 c} {‖ z ‖}^{2} - \frac{1}{8 {c}^{3}} {‖ z ‖}^{4} + ( 94 ) \\ \frac{1}{16 {c}^{5}} {‖ z ‖}^{6} - \frac{5}{128 {c}^{7}} {‖ z ‖}^{8} + 𝒪 ( {‖ z ‖}^{9} ) \\ = \frac{1}{2 c} {‖ x - y ‖}^{2} - \frac{1}{8 {c}^{3}} {‖ x - y ‖}^{4} + ( 95 ) \\ \frac{1}{16 {c}^{5}} {‖ x - y ‖}^{6} - \frac{5}{128 {c}^{7}} {‖ x - y ‖}^{8} + 𝒪 ( {‖ x - y ‖}^{9} ) \\ \text{?}\end{matrix}$$

$$\text{?} \text{indicates text missing or illegible when filed}$$

where z=x-y is substituted Each higher order ∥x-y∥^{k} for k>2 expands to a polynomial containing up to k-th moments, i.e., {x, x², . . . x^{k}}, {y, y², . . . , y^{k}}, thus the implicit feature map contains all higher moments where c contributes to the weightings in front of each term.

Furthermore, the finite difference (between r(s, t) and t) MMSD objective to the differential limit is extended by taking r(s, t)←t in Example 8. This results in a new objective that similarly subsumes continuous-time CM (Song et al., 2023; Lu & Song, 2024, which is incorporated by reference herein in its entirety) as a single-particle special case.

### 7.2 Diffusion GAN and Adversarial Consistency Distillation

Diffusion GAN (Xiao et al., 2021, which is incorporated by reference herein in its entirety) parameterizes its generative distribution as

$${p}_{s \vert t}^{θ} ( {x}_{s} \vert {x}_{t} ) = \int {q}_{s \vert t} ( {x}_{s} \vert {G}_{θ} ( {x}_{t} , z ) , {x}_{t} ) p ( z ) dz$$

where G_{θ} is a neural network, p(z) is standard Gaussian distribution, and q_{s|t}(xₛ|x, xₜ) is the DDPM posterior

$$\begin{matrix}{q}_{s \vert t} ( {x}_{s} \vert x , {x}_{t} ) = 𝒩 ( {μ}_{s , t} , {σ}_{s , t}^{2} I ) \\ {μ}_{Q} = \frac{{α}_{t} {σ}_{s}^{2}}{{α}_{s} {σ}_{t}^{2}} {x}_{t} + {α}_{s} ( 1 - \frac{{α}_{t}^{2}}{{α}_{s}^{2}} \frac{{σ}_{s}^{2}}{{σ}_{t}^{2}} ) x \\ {σ}_{Q}^{2} = {σ}_{s}^{2} ( 1 - \frac{{α}_{t}^{2}}{{α}_{s}^{2}} \frac{{σ}_{s}^{2}}{{σ}_{t}^{2}} )\end{matrix} \qquad ( 97 )$$

Note that DDPM posterior is a stochastic interpolant, and more importantly, it is self-consistent, which is shown in the Lemma below.
Lemma 6. For all 0≤s<t≤1, DDPM posterior distribution from t to s as defined in Eq. (97) is a seif-consistent Gaussian interpolant between x and xₜ.
   Proof Let xᵣ~q_{r|t} (xᵣ|x, xₜ) and xₛ~g_{x|r}(xₛ|x, xᵣ), we show that xₛ follows q_{x|t}(xₛ|x, xₜ).

$${x}_{r} = \frac{{α}_{t} {σ}_{r}^{2}}{{α}_{r} {σ}_{t}^{2}} {x}_{t} + {α}_{r} ( 1 - \frac{{α}_{t}^{2} {σ}_{r}^{2}}{{α}_{r}^{2} {σ}_{t}^{2}} ) x + {σ}_{r} \sqrt{1 - \frac{{α}_{t}^{2} {σ}_{r}^{2}}{{α}_{r}^{2} {σ}_{t}^{2}}} {ϵ}_{1} \qquad ( 98 )$$

$${x}_{s} = \frac{{α}_{r} {σ}_{s}^{2}}{{α}_{s} {σ}_{r}^{2}} {x}_{r} + {α}_{s} ( 1 - \frac{{α}_{r}^{2} {σ}_{r}^{2}}{{α}_{s}^{2} {σ}_{t}^{2}} ) x + {σ}_{s} \sqrt{1 - \frac{{α}_{r}^{2} {σ}_{s}^{2}}{{α}_{s}^{2} {σ}_{t}^{2}}} {ϵ}_{2} \qquad ( 99 )$$

where ϵ₁, ϵ₂~ [symbol] (0, I) are i.i.d. Gaussian noise. Directly expanding

$${x}_{s} = \frac{{α}_{r} {σ}_{s}^{2}}{{α}_{z} {σ}_{r}^{2}} [ \frac{{α}_{t} {σ}_{r}^{2}}{{α}_{r} {σ}_{t}^{2}} {x}_{t} + {α}_{r} ( 1 - \frac{{α}_{t}^{2} {σ}_{r}^{2}}{{α}_{r}^{2} {σ}_{t}^{2}} ) x + {σ}_{r} \sqrt{1 - \frac{{α}_{t}^{2} {σ}_{r}^{2}}{{α}_{r}^{2} {σ}_{t}^{2}}} {ϵ}_{1} ] + {α}_{s} ( 1 - \frac{{α}_{r}^{2} {σ}_{r}^{2}}{{α}_{s}^{2} {σ}_{t}^{2}} ) x + {σ}_{s} \sqrt{1 - \frac{{α}_{r}^{2} {σ}_{s}^{2}}{{α}_{s}^{2} {σ}_{t}^{2}}} {ϵ}_{2} \qquad ( 100 )$$

$$= \frac{{α}_{t} {σ}_{s}^{2}}{{α}_{s} {σ}_{t}^{2}} {x}_{t} + [ \frac{{α}_{r}^{2} {σ}_{s}^{2}}{{α}_{s} {σ}_{r}^{2}} ( 1 - \frac{{α}_{t}^{2} {σ}_{r}^{2}}{{α}_{r}^{2} {σ}_{t}^{2}} ) + {α}_{s} ( 1 - \frac{{α}_{r}^{2} {σ}_{r}^{2}}{{α}_{s}^{2} {σ}_{t}^{2}} ) x + \frac{{α}_{r} {σ}_{s}^{2}}{{α}_{s} {σ}_{r}^{2}} [ {σ}_{r} \sqrt{1 - \frac{{α}_{t}^{2} {σ}_{r}^{2}}{{α}_{r}^{2} {σ}_{t}^{2}}} {ϵ}_{1} ] + {σ}_{s} \sqrt{1 - \frac{{α}_{r}^{2} {σ}_{s}^{2}}{{α}_{s}^{2} {σ}_{t}^{2}}} {ϵ}_{2} \qquad ( 101 )$$

$$= \frac{{α}_{t} {σ}_{s}^{2}}{{α}_{s} {σ}_{t}^{2}} {x}_{t} + {α}_{s} ( 1 - \frac{{α}_{t}^{2} {σ}_{s}^{2}}{{α}_{s}^{2} {σ}_{t}^{2}} ) x + \frac{{α}_{r} {σ}_{s}^{2}}{{α}_{s} {σ}_{r}} \sqrt{1 - \frac{{α}_{t}^{2} {σ}_{r}^{2}}{{α}_{r}^{2} {σ}_{t}^{2}}} {ϵ}_{1} + {σ}_{s} \sqrt{1 - \frac{{α}_{r}^{2} {σ}_{s}^{2}}{{α}_{s}^{2} {σ}_{t}^{2}}} {ϵ}_{2} \qquad ( 102 )$$

$${=}^{( a )} \frac{{α}_{t} {σ}_{s}^{2}}{{α}_{s} {σ}_{t}^{2}} {x}_{t} + {α}_{s} ( 1 - \frac{{α}_{t}^{2} {σ}_{s}^{2}}{{α}_{s}^{2} {σ}_{t}^{2}} ) x + {σ}_{s} \sqrt{1 - \frac{{α}_{t}^{2} {σ}_{s}^{2}}{{α}_{s}^{2} {σ}_{t}^{2}}} {ϵ}_{3} \qquad ( 103 )$$

where (a) is due to the fact that sum of two independent Gaussian variables with variance a² and b² is also Gaussian with variance a²+b², and ϵ₃~N (0, I) is another independent Gaussian noise. The calculation of the variance is shown:

$$\frac{{α}_{r}^{2}}{{α}_{s}^{2}} \frac{{σ}_{s}^{4}}{{σ}_{r}^{2}} ( 1 - \frac{{α}_{t}^{2} {σ}_{r}^{2}}{{α}_{r}^{2} {σ}_{t}^{2}} ) + {α}_{s}^{2} ( 1 - \frac{{α}_{r}^{2} {σ}_{s}^{2}}{{α}_{s}^{2} {σ}_{t}^{2}} ) = - \frac{{α}_{t}^{2} {σ}_{s}^{4}}{{α}_{t}^{2} {σ}_{s}^{2}} + {σ}_{s}^{2} -= {σ}_{s}^{2} ( 1 - \frac{{α}_{t}^{2} {σ}_{s}^{2}}{{α}_{s}^{2} {σ}_{t}^{2}} )$$

This shows xₛ follows q_{s|r}(xₛ|x, xₜ) and completes the proof.

This shows another possible design of the interpolant that can be used for self-distillation, and diffusion GAN's formulation generally complies with the design of the generative distribution, except that it learns this conditional distribution of x given xₜ directly while a marginal distribution is learned. When they directly learn the conditional distribution by matching

$${p}_{s \vert t}^{θ} ( x \vert {x}_{t} )$$

with qₜ(x|xₜ), the model is forced to learn q (x|xt) and there only exists one minimizer. However, in this case, the model can learn multiple different solutions because the marginals are matched instead.

GAN loss and MMD loss. There is also similarity between GAN loss used in Xiao et al. (2021, which is incorporated by reference herein in its entirety); Sauer et al. (2025, which is incorporated by reference herein in its entirety) and MMD loss. MMD is an integral probability metric over a set of functions F in the following form

$${D}_{ℱ} ( P , Q ) = {sup}_{f ϵℱ} \vert {E}_{x \sim P ( x )} f ( x ) - {𝔼}_{y \sim Q ( y )} f ( y ) \vert$$

where a supremum is taken on this set of functions. This naturally gives rise to an adversarial optimization algorithm if F is defined as the set of neural networks. However, MMD bypasses this by selecting F as the RKHS where the optimal f can be analytically found. This eliminates the adversarial objective and gives a stable minimization objective in practice. However, this is not to say that RKHS is the best function set. With the right optimizers and training scheme, the adversarial objective may achieve better empirical performance, but this also makes the algorithm difficult to scale to large datasets.

### 7.3 Generative Moment Matching Network

It is trivial to check that GMMN is a special parameterization. Fix t=1, and due to boundary condition, r(s, t)=s=0 implies training target

$$p \text{?} ( {x}_{s} ) = {q}_{s} ( \text{?} )$$

$$\text{?} \text{indicates text missing or illegible when filed}$$

the data distribution. Additionally,

$$p \text{?}$$

$$\text{?} \text{indicates text missing or illegible when filed}$$

is a simple pushforward of prior p(ϵ) through network g_{θ}(ϵ) where drop dependency on t and s since they are constant.

### Example 8—Differential Moment Matching Self-Distillation

Similar to the continuous-time CMs presented in (Lu & Song, 2024, which is incorporated by reference herein in its entirety), the MMD self-distillation objective can be taken to the differential limit. Consider the simplified loss and parameterization in Eq. (12), the RBF kernel is used as the kernel of choice for simplicity.
Theorem 2 (Differential Moment Matching Self-Distillation). Let

$$f \text{?} ( \text{?} )$$

$$\text{?} \text{indicates text missing or illegible when filed}$$

be a twice continuously differentiable function with bounded first and second derivatives, let k(⋅, ⋅) be RBF kernel with unit bandwidth, x, xⁱ~q(x), xₜ~gₜ(xₜ|x),

$$x \text{?} \sim {q}_{s} ( \text{?} \vert {x}^{′} ) , {x}_{r} = DDIM ( \text{?} , x , t , r ) and x \text{?} = DDIM ( \text{?} , {x}^{′} , t , r ) ,$$

$$\text{?} \text{indicates text missing or illegible when filed}$$

the following objective

$${ℒ}_{MMSD - ∞} ( θ , t ) = {lim}_{\text{?}} \frac{1}{{( t - r )}^{2}} {𝔼}_{\text{?}} [ k ( \text{?} ) + k ( \text{?} ) - k ( \text{?} ) - k ( \text{?} ) ] \qquad ( 104 )$$

$$\text{?} \text{indicates text missing or illegible when filed}$$

can be analytically derived as

$${𝔼}_{\text{?}} [ \text{?} ( \frac{df \text{?}}{dt} \frac{df \text{?}}{dt} - \frac{df \text{?}}{dt} ( \text{?} - \text{?} ) {( \text{?} - \text{?} )}^{T} \frac{df \text{?}}{dt} ) ] \qquad ( 105 )$$

$$\text{?} \text{indicates text missing or illegible when filed}$$

Proof. Firstly, the limit can be exchanged with the expectation due to dominated convergence theorem where the integrand consists of kernel functions which can be assumed to be upper bounded by 1, e.g. RBF kernels are upper bounded by 1, and thus integrable. It then suffices to check the limit of the integrand. Before that, let us review the first and second-order Taylor expansion of c^{-∥x-y∥}^{²}. We let a, b∈ [symbol] ^{D} be constants to be expanded around. The Taylor expansion to second-order is noted down below for notational convenience.

$${e}^{- {‖ x - b ‖}^{2} / 2} at x = a : {e}^{- {‖ a - b ‖}^{2} / 2} - {{e}^{- {‖ a - b ‖}^{2} / 2} ( a - b )}^{T} ( x - a ) + \frac{1}{2} {( x - a )}^{T} {e}^{- {‖ a - b ‖}^{3} / 2} ( ( a - b ) {( a - b )}^{T} - I ) ( x - a )$$

$${e}^{- {‖ y - a ‖}^{2} / 2} at y = b : {e}^{- {‖ b - a ‖}^{3} / 2} - {{e}^{- {‖ b - a ‖}^{2} / 2} ( b - a )}^{T} ( y - b ) + \frac{1}{2} {( y - b )}^{T} {e}^{- {‖ b - a ‖}^{2} / 2} ( ( b - a ) {( b - a )}^{T} - I ) ( y - b )$$

$${e}^{- {‖ x - y ‖}^{2} / 2} at x = a , y = b : {e}^{- {‖ a - b ‖}^{2} / 2} - {{e}^{- {‖ a - b ‖}^{2} / 2} ( a - b )}^{T} ( x - a ) - {{e}^{- {‖ b - a ‖}^{2} / 2} ( b - a )}^{T} ( y - b ) + \frac{1}{2} {( y - b )}^{T} {e}^{- {‖ b - a ‖}^{2} / 2} ( ( b - a ) {( b - a )}^{T} - I ) ( y - b ) + \frac{1}{2} {( y - b )}^{T} {e}^{- {‖ b - a ‖}^{3} / 2} ( ( b - a ) {( b - a )}^{T} - I ) ( y - b ) + {( x - a )}^{T} {e}^{- {‖ b - a ‖}^{2} / 2} ( I - ( a - b ) {( a - b )}^{T} - I ) ( y - b )$$

Putting it together the above results imply

$${e}^{- {‖ x - y ‖}^{2} / 2} + {e}^{- {‖ a - b ‖}^{2} / 2} - {e}^{- {‖ x - b ‖}^{2} / 2} - {e}^{- {‖ \text{?} ‖}^{3} / 2} \approx {( x - a )}^{T} {e}^{- {‖ b - a ‖}^{2} / 2} ( I - ( a - b ) {( a - b )}^{T} ) ( y - b )$$

$$\text{?} \text{indicates text missing or illegible when filed}$$

since it is easy to check that the remaining terms cancel.

Substituting

$$x = f \text{?} , a = f \text{?} , y = f \text{?} , b = f \text{?} ,$$

$${lim}_{\text{?}} \frac{1}{t - r} ( x - a ) = {lim}_{\text{?}} \frac{1}{t - r} [ f \text{?} - f \text{?} ] \qquad ( 106 )$$

$$= {lim}_{\text{?}} \frac{1}{t - r} [ ( t - r ) \frac{df \text{?}}{dt} + 𝒪 ( {\vert t - r \vert}^{2} ) ] \qquad ( 107 )$$

$$= \frac{df \text{?}}{dt} \qquad ( 108 )$$

$$\text{?} \text{indicates text missing or illegible when filed}$$

Similarly,

$${lim}_{\text{?}} \frac{1}{t - r} ( y - b ) = {lim}_{\text{?}} \frac{1}{t - r} [ f \text{?} - f \text{?} ] = \frac{df \text{?}}{dt} \qquad ( 109 )$$

$$\text{?} \text{indicates text missing or illegible when filed}$$

Therefore, [symbol] _{MMSD-∞}(θ, t) can be derived as

$$\begin{matrix}{𝔼}_{x} {\text{?}}_{x} \text{?} [ {e}^{- \frac{1}{2} ‖ f} {\text{?}}^{( x} {\text{?}}^{) - f} {\text{?}}^{{( {x}_{t} ) ‖}^{2}} \frac{{{df}_{s , t}^{θ} ( {x}_{t} )}^{T}}{dt} & ( 110 ) \\ ( I - ( {f}_{s , t}^{θ} ( {x}_{t} ) - {f}_{s , t}^{θ} ( {x}_{t}^{′} ) ) {( {f}_{s , t}^{θ} ( {x}_{t} ) - {f}_{s , t}^{θ} ( {x}_{t}^{′} ) )}^{T} ) \frac{{df}_{s , t}^{θ} ( {x}_{t}^{′} )}{dt} = & ( 111 ) \\ {𝔼}_{x} {\text{?}}_{x} \text{?} [ {e}^{- \frac{1}{2} ‖ f} {\text{?}}^{( x} {\text{?}}^{) - f} {\text{?}}^{{( {x}_{t} ) ‖}^{2}} ( \frac{{{df}_{s , t}^{θ} ( {x}_{t} )}^{T}}{dt} \frac{{df}_{s , t}^{θ} ( {x}_{t}^{′} )}{dt} - & ( 112 ) \\ \frac{{{df}_{s , t}^{θ} ( {x}_{t} )}^{T}}{dt} ( {f}_{s , t}^{θ} ( {x}_{t} ) - {f}_{s , t}^{θ} ( {x}_{t}^{′} ) ) {( {f}_{s , t}^{θ} ( {x}_{t} ) - {f}_{s , t}^{θ} ( {x}_{t}^{′} ) )}^{T} \frac{{df}_{s , t}^{θ} ( {x}_{t}^{′} )}{dt} ) ] & \end{matrix}$$

$$\text{?} \text{indicates text missing or illegible when filed}$$

### 8.1 Pseudo-Objective

Due to the stop-gradient operation, a pseudo-objective can similarly be found whose gradient matches the gradient of [symbol] _{MMSD-∞(θ, t) in the limit of r} [symbol] _{t.}
Theorem 3. Let Let

$$Let {f}_{s , t}^{θ} ( {x}_{t} )$$

be a twice continuously differentiable function with bounded first and second derivatives, k(⋅, ⋅) be RBF kernel with unit bandwidth,

$$x , {x}^{′} ∼ q ( x ) , x \text{?} ∼ q \text{?} ( {x}_{t} \vert x ) , {x}_{t}^{′} ∼ q \text{?} ( {x}_{t} \vert x ) \text{?}$$

$${x}_{t}^{′} ∼ q \text{?} ( {x}_{t}^{′} \vert {x}^{′} ) , {x}_{r} = DDIM ( x \text{?} x , t , r ) and$$

$${x}^{′} \text{?} = DDIM ( x \text{?} {x}^{′} , t , r ) ,$$

$$\text{?} \text{indicates text missing or illegible when filed}$$

the gradient of the following pseudo-objective

$${∇}_{θ} {ℒ}_{MMSD}^{-} \text{?} ( θ , t ) = {lim}_{\text{?}} \frac{1}{( t - r )} {∇}_{θ} {𝔼}_{x , {x}_{1}^{′} , x , {x}^{′}} \text{?} [ k ( {f}_{s , t}^{θ} ( {x}_{t} ) , {f}_{s , t}^{θ} ( {x}_{t}^{′} ) ) + k ( {f}_{s , r}^{θ} \text{?} ( {x}_{r} ) , {f}_{s , r}^{θ} \text{?} ( {x}_{r}^{′} ) ) - k ( {f}_{s , t}^{θ} ( {x}_{t} ) , {f}_{s , t}^{θ} \text{?} ( {x}_{t}^{′} ) ) - k ( {f}_{s , t}^{θ} ( {x}_{t}^{′} ) , {f}_{s , r}^{θ} \text{?} ( {x}_{r} ) ) ] \qquad ( 113 )$$

$$\text{?} \text{indicates text missing or illegible when filed}$$

can be used to optimize 0 and can be analytically derived as

$${𝔼}_{x} {\text{?}}_{x} \text{?} [ {e}^{- \frac{1}{2} ‖ f} {\text{?}}^{( x} {\text{?}}^{) - f} {\text{?}}^{{( {x}_{t} ) ‖}^{2}} ( \frac{{df}_{s , t}^{θ} \text{?} {( {x}_{t}^{′} )}^{T}}{dt} - {[ {f}_{s , t}^{θ} \text{?} ( {x}_{t} ) - {f}_{s , t}^{θ} \text{?} ( {x}_{t}^{′} ) ]}^{T} {\frac{{df}_{s , t}^{θ} \text{?} ( {x}_{t}^{′} )}{dt} [ {f}_{s , t}^{θ} \text{?} ( {x}_{t} ) - {f}_{s , t}^{θ} \text{?} ( {x}_{t}^{′} ) ]}^{T} ) {∇}_{θ} {f}_{s , t}^{θ} ( {x}_{t} ) + ( \frac{{df}_{s , t}^{θ} \text{?} {( {x}_{t} )}^{T}}{dt} - {[ {f}_{s , t}^{θ} \text{?} ( {x}_{t} ) - {f}_{s , t}^{θ} \text{?} ( {x}_{t}^{′} ) ]}^{T} {\frac{{df}_{s , t}^{θ} \text{?} ( {x}_{t} )}{dt} [ {f}_{s , t}^{θ} \text{?} ( {x}_{t} ) - {f}_{s , t}^{θ} \text{?} ( {x}_{t}^{′} ) ]}^{T} ) {∇}_{θ} {f}_{s , t}^{θ} ( {x}_{t}^{′} ) ) ] \qquad ( 114 )$$

$$\text{?} \text{indicates text missing or illegible when filed}$$

Proof Similar to the derivation of

$${ℒ}_{MMSD - ∝} ( θ , t ) , let x = {f}^{θ} \text{?} ( {x}_{t} ) , a = {f}_{s , r}^{θ} \text{?} ( {x}_{r} ) , y = {f}_{s , t}^{θ} ( {x}_{t}^{′} ) , b = {f}_{s , r}^{θ} \text{?} ( {x}_{r}^{′} ) ,$$

$$have$$

$${lim}_{r \to t} \frac{1}{( t - r )} {∇}_{θ} {( x - a )}^{T} {e}^{- {‖ b - a ‖}^{2} / 2} ( I - ( a - b ) {( a - b )}^{T} ) ( y - b ) = {lim}_{r \to t} \frac{1}{( t - r )} {e}^{- {‖ b - a ‖}^{2} / 2} [ ( {( y - b )}^{T} - ( {( a - b )}^{T} ( y - b ) ) {( a - b )}^{T} ) {∇}_{θ} x + ( {( x - a )}^{T} - ( {( a - b )}^{T} ( x - a ) ) {( a - b )}^{T} ) {∇}_{θ} y ]$$

$$where$$

$${lim}_{r \to t} \frac{1}{( t - r )} ( x - a ) = \frac{{df}_{s , t}^{θ} \text{?} ( {x}_{t} )}{dt} ,$$

$${lim}_{r \to t} \frac{1}{( t - r )} ( y - b ) = \frac{{df}_{s , t}^{θ} \text{?} ( {x}_{t}^{′} )}{dt}$$

$$\text{?} \text{indicates text missing or illegible when filed}$$

Note that

$$\frac{df \text{?}}{\text{?}}$$

$$\text{?} \text{indicates text missing or illegible when filed}$$

is now parameterized by θ⁻ instead of θ because the gradient is already taken w.r.t. f^{θt} (xₜ) outside of the brackets, so (x−a) and (y−b) merely require evaluation at current θ with no gradient information, which θ⁻ satisfies. The objective can be derived as

$${∇}_{θ} {ℒ}_{MMSD - ∝}^{-} ( θ , t ) = {𝔼}_{x} {\text{?}}_{x} \text{?} [ {e}^{- \frac{1}{2} ‖ f} {\text{?}}^{( x} {\text{?}}^{) - f} {\text{?}}^{{( {x}_{t} ) ‖}^{2}} ( ( \frac{{df}_{s , t}^{θ} \text{?} {( {x}_{t}^{′} )}^{T}}{dt} - {[ {f}_{s , t}^{θ} \text{?} ( {x}_{t} ) - {f}_{s , t}^{θ} \text{?} ( {x}_{t}^{′} ) ]}^{T} \frac{{df}_{s , t}^{θ} \text{?} ( {x}_{t}^{′} )}{dt} {f}_{s , t}^{θ} \text{?} ( {x}_{t} ) - {f}_{s , t}^{θ} \text{?} {( {x}_{t}^{′} )}^{T} ) {∇}_{θ} {f}_{s , t}^{θ} ( {x}_{t} ) + ( \frac{{df}_{s , t}^{θ} \text{?} {( {x}_{t} )}^{T}}{dt} - {[ {f}_{s , t}^{θ} \text{?} ( {x}_{t} ) - {f}_{s , t}^{θ} \text{?} ( {x}_{t}^{′} ) ]}^{T} {\frac{{df}_{s , t}^{θ} \text{?} ( {x}_{t} )}{dt} [ {f}_{s , t}^{θ} \text{?} ( {x}_{t} ) - {f}_{s , t}^{θ} \text{?} ( {x}_{t}^{′} ) ]}^{T} ) {∇}_{θ} {f}_{s , t}^{θ} ( {x}_{t}^{′} ) ) ]$$

$$\text{?} \text{indicates text missing or illegible when filed}$$

8.2 Connection with Continuous-Time CMs

Observing Eq. (105) and Eq. (110), it can be seen that when

$${x}_{t} = {x}_{t}^{′} and {x}_{r} = {x}_{r}^{′} ,$$

s being a small positive constant, then

$${f}_{s , t}^{θ} ( {x}_{t}^{′} ) = {f}_{s , t}^{θ} ( {x}_{t} ) , and exp ( - \frac{1}{2} ‖ {f}_{s , t}^{θ} ( {x}_{t}^{′} ) - {f}_{s , t}^{θ} ( {x}_{t} ) ‖ \text{?} = 1 , and {f}_{s , t}^{θ} ( {x}_{t}^{′} ) \approx g \text{?} ( x \text{?} , t )$$

$$\text{?} \text{indicates text missing or illegible when filed}$$

where since s is fixed the dependency on s is discarded as input. Then, Eq. (105) reduces to

$${𝔼}_{x} \text{?} [ {‖ \frac{{df}_{s , t}^{θ} ( {x}_{t} )}{dt} ‖}^{2} ] \qquad ( 115 )$$

$$\text{?} \text{indicates text missing or illegible when filed}$$

which is the same as differential consistency loss (Song et al., 2023; Geng et al., 2024; each of which is incorporated by reference herein in its entirety). And Eq. (110) reduces to

$${𝔼}_{x} \text{?} [ \frac{{df}_{s , t}^{θ} \text{?} {( {x}_{t} )}^{T}}{dt} {∇}_{θ} {f}_{s , t}^{θ} ( {x}_{t} ) ] \qquad ( 116 )$$

$$\text{?} \text{indicates text missing or illegible when filed}$$

which is the pseudo-objective for continuous-time CMs (Song et al., 2023; Lu & Song, 2024; each of which is incorporated by reference herein in its entirety) (minus a weighting function of choice).

### Example 9—Experiment Settings

The best runs are summarized in Table 5. Specifically, for ImageNet-256×256, a latent space paradigm is adopted for computational efficiency. For its autoencoder, EDM2 is followed (Karras et al., 2024, which is incorporated by reference herein in its entirety) and all images from ImageNet are pre-encoded into latents without flipping, and the channel-wise mean and std for normalization is calculated. Stable Diffusion VAE is used and the latents are rescaled by channel mean [0.86488, −0.27787343, 0.21616915, 0.3738409] and channel std [4.85503674, 5.31922414, 3.93725398, 3.9870003]. After this normalization transformation, the latents are further multiplied by 0.5 so that the latents roughly have std 0.5. For DiT architecture of different sizes, the same hyperparameters are used for all experiments.

Choices for T and ϵ. By default assuming mapping function r (s, t) is used by constant decrement in ηₜ, ηₘₐₓ≈160 is kept. This implies that for time distribution of the form [symbol] (ϵ, T), T=0.996 is set for cosine diffusion and T=0.994 for OT-FM. For ϵ, it is set differently for pixel-space and latent-space model. ϵ=0 is set by default.

TABLE 5
Experimental settings for different architectures and datasets.

| | |
|---|---|
| CIFAR-10 | ImageNet-256x256 |

Parameterization Setting

| | | | | | |
|---|---|---|---|---|---|
| Architecture | DDPM₊₊ | DiT-S | DIT-B | DiT-L | DiT-XL |
| GFlops | 21.28 | 6.06 | 23.01 | 80.71 | 118.64 |
| Params (M) | 55 | 33 | 130 | 458 | 675 |
| cₙₒᵢₛₑ (t) | 1000t | 1000t | 1000t | 1000t | 1000t |
| Flow Trajectory | OT-FM | OT-FM | OT-FM | OT-FM | OT-FM |
| | Simple-EDM | Euler-FM | Euler-FM | Euler-FM | Euler- |
| g_{θ} (xₜ, s, t) | | | | | FM |
| σd | 0.5 | 0.5 | 0.5 | 0.5 | 0.5 |
| Training iter | 400K | 1.2M | 1.2M | 1.2M | 1.2M |

Training Setting

| | | | | | |
|---|---|---|---|---|---|
| Dropout | 0.2 | 0. | 0. | 0. | 0. |
| Optimizer | RAdam | Adam | Adam | Adam | Adam |
| Optimizer ϵ | 10⁻⁸ | 10⁻⁸ | 10⁻⁸ | 10⁻⁸ | 10⁻⁸ |
| β₁ | 0.9 | 0.9 | 0.9 | 0.9 | 0.9 |
| β₂ | 0.999 | 0.999 | 0.999 | 0.999 | 0.999 |
| Learning Rate | 0.0001 | 0.0001 | 0.0001 | 0.0001 | 0.0001 |
| Weight Decay | 0 | 0 | 0 | 0 | 0 |
| Batch Size | 4096 | 4096 | 4096 | 4096 | 4096 |
| M | 8 | | | | 4 |
| Kernel | Laplace | Laplace | Laplace | Laplace | Laplace |
| r(s, t) p(t) | $\begin{matrix}max ( s , {η}^{- 1} ( {η}_{t} - \frac{( {η}_{max} - {η}_{min} )}{{2}^{13}} ) ) \\ 𝒰 ( 0 , 0.994 )\end{matrix}$ | [symbol] (0, 0.994) | $max ( s , {η}^{- 1} 𝒰 ( 0 , 0.994 )$ | $\begin{matrix}( {η}_{t} - \frac{( {η}_{max} - {η}_{min} )}{{2}^{13}} ) ) \\ 𝒰 ( 0 , 0.994 )\end{matrix}$ | [symbol] (0, 0.994) |
| b | 5 | 4 | 4 | 4 | 4 |
| EMA Rate | 0.9999 | 0.9999 | 0.9999 | 0.9999 | 0.9999 |
| x-flip | True | False | False | False | False |

Inference Setting

| | | | | | |
|---|---|---|---|---|---|
| Sampler Type | Restart | Pushforward | Pushforward | Pushforward | Pushforward |
| Number of Steps | 2 | 8 | 8 | 8 | 8 |
| Schedule Type | t₁ = 1.35 | Uniform | Uniform | Uniform | Uniform |
| FID-50K (w = 0) | 2.05 | — | — | — | — |
| FID-50K (w = | — | 42.28 | 26.02 | 9.33 | 7.25 |
| 1.0, i.e. | | | | | |
| no guidance) | | | | | |
| FID-50K (w = 1.5) | — | 20.36 | 9.69 | 2.80 | 2.13 |

Exceptions occur when other choices of r (s, t) are ablated, e.g. constant decrement in λₜ in which case ϵ=0.001 is set to prevent r (s, t) for being too close to t when t is small.

Injecting time s. The design for additionally injecting s exactly follows the time injection of t. Positional time embedding of s fed through 2-layer MLP (same as for t) is extracted before adding this new embedding to the embedding of t after MLP. The summed embedding is then fed through all the Transformer blocks as in standard DiT architecture.

Improved CT baseline. For ImageNet-256×256, iCT baseline is implemented by using the improved parameterization with Simple-EDM and OT-FM schedule. The proposed pseudo-huber loss is used for training but find training often collapses using the same r (s, t) schedule. The gap is carefully tuned to achieve reasonable performance without collapse and the results are presented in Table 2.

### 9.2 Inference Settings

Inference schedules. For all one-step inference, directly start from

$$ϵ ∼ N ( 0 , \text{?} )$$

$$\text{?} \text{indicates text missing or illegible when filed}$$

at time T to time ϵ through pushforward sampling. For all 2-step methods, set the intermediate timestep t₁ such that ηtₗ=1.35; this choice is arbitrary but works well. For N≥4 steps explore two types of time schedules: (1) uniform decrement in t with η₀<η₁ . . . <η_{N} where

$$t \text{?} = T + \frac{N - i}{N} ( ϵ - T ) \qquad ( 117 )$$

$$\text{?} \text{indicates text missing or illegible when filed}$$

and (2) EDM (Karras et al., 2022, which is incorporated by reference herein in its entirety) time schedule. EDM schedule specifies η₀<η₁ . . . <η_{N} where

$${η}_{i} = {( \begin{matrix}\frac{1}{\text{?}} \\ {η}_{max}\end{matrix} + \frac{N - i}{N} ( \begin{matrix}\frac{1}{\text{?}} \\ {η}_{min}\end{matrix} - \begin{matrix}\frac{1}{\text{?}} \\ {η}_{max}\end{matrix} ) )}^{ρ} and ρ = 7 \qquad ( 118 )$$

$$\text{?} \text{indicates text missing or illegible when filed}$$

The schedule is slightly modified so that η₀=ηₘᵢₙ is the endpoint instead of η₁=ηₘᵢₙ and η₀=0 as originally proposed, since the η₀ can be set to 0 without numerical issue.

The time schedule type used for the best runs and their results is also specified in Table 5.

### 9.3 Scaling Settings

Model GFLOPs. Numbers from DiT (Peebles & Xie, 2023, which is incorporated by reference herein in its entirety) are reused for each model architecture.

Training compute. Following Peebles & Xie (2023, which is incorporated by reference herein in its entirety), the formula model GFLOPs batch size training steps 4 is used for training compute where, different from DiT, constant is 4 because for each iteration there are 2 forward pass and 1 backward pass, which is estimated as twice the forward compute.

Inference compute. Inference compute is calculated via model GFLOPs number of steps.

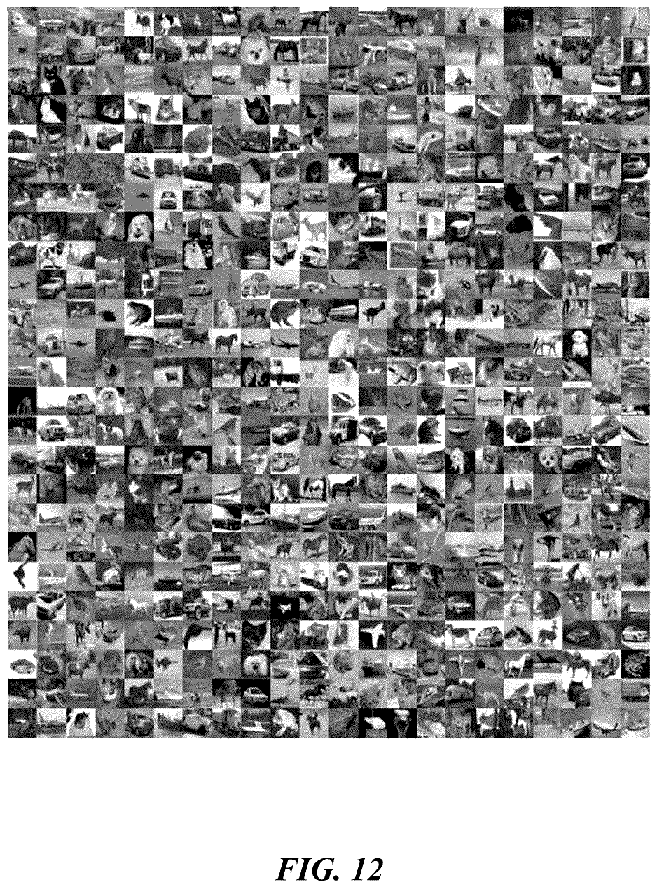

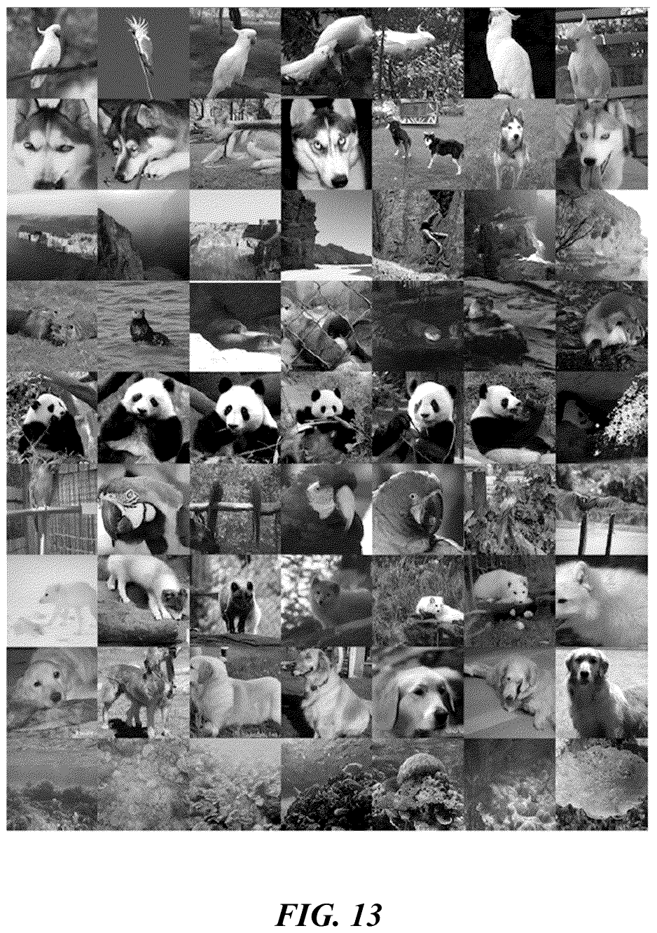

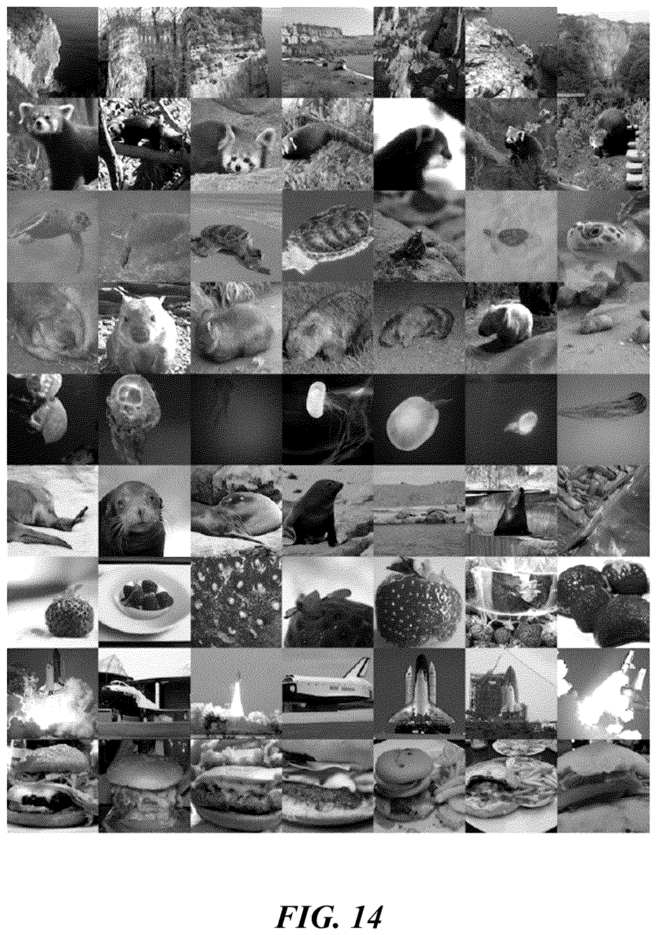

Additional visualizations are shown in FIGS. 12-14.

### Example 10—Additional Demonstration of Technical Improvements

Tables 6-8 provide additional demonstrations of technical improvements over other methods described herein.

TABLE 6

| | CIFAR-10 FID |
|---|---|
| 1-step | 3.20 |
| 2-step | 1.98 |

TABLE 7

| | ImageNet-256 × 256 FID |
|---|---|
| 1-step (w = 1.25) | 7.77 |
| 2-step (w = 1.25) | 5.33 |
| 4-step (w = 1.25) | 3.66 |
| 8-step (w = 1.25) | 2.77 |
| 1-step (w = 1.5) | 8.05 |
| 2-step (w = 1.5) | 3.99 |
| 4-step (w = 1.5) | 2.51 |
| 8-step (w = 1.5) | 1.99 |

TABLE 8

| | ImageNet-256 × 256 FID |
|---|---|
| 10-step (w = 1.5) | 1.98 |
| 16-step (w = 1.5) | 1.90 |
| 32-step (w = 1.5) | 1.89 |

### Computing Systems

In another aspect, disclosed here is a system comprising at least one processor and instructions executable by the at least one processor to cause the at least one processor to perform operations comprising: (a) obtaining (i) a first dataset comprising an observed data sample from a data distribution of observed data and (ii) a second dataset comprising a prior sample from a prior distribution; (b) synthesizing first data at a first time step based on the observed data sample and the prior sample; (c) synthesizing second data at a second time step based on the observed data sample and the first data, wherein the second time step is between a target time step and the first time step; (d) generating, using a neural network, a first output and a second output at the target time step, wherein (i) the first output is obtained using the first data with the target time step and the first time step as conditioning inputs and (ii) the second output is obtained using the second data with the target time step and the second time step as conditioning inputs; and (e) obtaining a trained generative AI model by updating parameters of the neural network, wherein the updating comprises at least computing a loss between a first distribution of the first output and a second distribution of the second output.

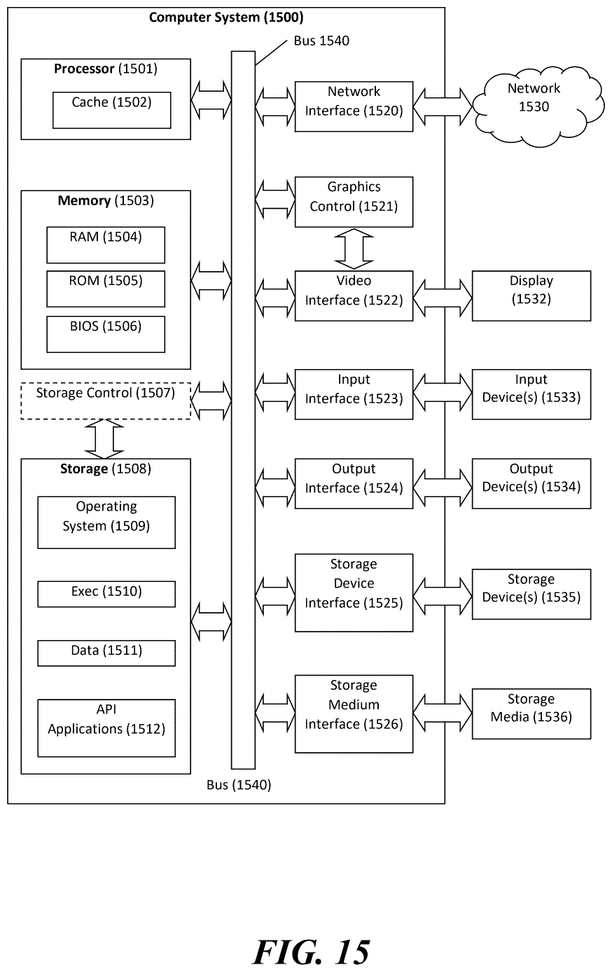

Referring to FIG. 15, a block diagram is shown depicting an exemplary machine that includes a computer system 1500 (e.g., a processing or computing system) within which a set of instructions can execute for causing a device to perform or execute any one or more of the aspects and/or methodologies for static code scheduling of the present disclosure. The components in FIG. 15 are examples only and do not limit the scope of use or functionality of any hardware, software, embedded logic component, or a combination of two or more such components implementing particular embodiments.

Computer system 1500 may include one or more processors 1501, a memory 1503, and a storage 1508 that communicate with each other, and with other components, via a bus 1540. The bus 1540 may also link a display 1532, one or more input devices 1533 (which may, for example, include a keypad, a keyboard, a mouse, a stylus, etc.), one or more output devices 1534, one or more storage devices 1535, and various tangible storage media 1536. All of these elements may interface directly or via one or more interfaces or adaptors to the bus 1540. For instance, the various tangible storage media 1536 can interface with the bus 1540 via storage medium interface 1526. Computer system 1500 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 1500 includes one or more processor(s) 1501 (e.g., central processing units (CPUs) or general purpose graphics processing units (GPGPUs)) that carry out functions. Processor(s) 1501 optionally contains a cache memory unit 1502 for temporary local storage of instructions, data, or computer addresses. Processor(s) 1501 are configured to assist in execution of computer readable instructions. Computer system 1500 may provide functionality for the components depicted in FIG. 15 as a result of the processor(s) 1501 executing non-transitory, processor-executable instructions embodied in one or more tangible computer-readable storage media, such as memory 1503, storage 1508, storage devices 1535, and/or storage medium 1536. The computer-readable media may store software that implements particular embodiments, and processor(s) 1501 may execute the software. Memory 1503 may read the software from one or more other computer-readable media (such as mass storage device(s) 1535, 1536) or from one or more other sources through a suitable interface, such as network interface 1520. The software may cause processor(s) 1501 to carry out one or more processes or one or more steps of one or more processes described or illustrated herein. Carrying out such processes or steps may include defining data structures stored in memory 1503 and modifying the data structures as directed by the software.

The memory 1503 may include various components (e.g., machine readable media) including, but not limited to, a random access memory component (e.g., RAM 1504) (e.g., static RAM (SRAM), dynamic RAM (DRAM), ferroelectric random access memory (FRAM), phase-change random access memory (PRAM), etc.), a read-only memory component (e.g., ROM 1505), and any combinations thereof. ROM 1505 may act to communicate data and instructions unidirectionally to processor(s) 1501, and RAM 1504 may act to communicate data and instructions bidirectionally with processor(s) 1501. ROM 1505 and RAM 1504 may include any suitable tangible computer-readable media described below. In one example, a basic input/output system 1506 (BIOS), including basic routines that help to transfer information between elements within computer system 1500, such as during start-up, may be stored in the memory 1503.

Fixed storage 1508 is connected bidirectionally to processor(s) 1501, optionally through storage control unit 1507. Fixed storage 1508 provides additional data storage capacity and may also include any suitable tangible computer-readable media described herein. Storage 1508 may be used to store operating system 1509, executable(s) 1510, data 1511, applications 1512 (application programs), and the like. Storage 1508 can also include an optical disk drive, a solid-state memory device (e.g., flash-based systems), or a combination of any of the above. Information in storage 1508 may, in appropriate cases, be incorporated as virtual memory in memory 1503.

In one example, storage device(s) 1535 may be removably interfaced with computer system 1500 (e.g., via an external port connector (not shown)) via a storage device interface 1525. Particularly, storage device(s) 1535 and an associated machine-readable medium may provide non-volatile and/or volatile storage of machine-readable instructions, data structures, program modules, and/or other data for the computer system 1500. In one example, software may reside, completely or partially, within a machine-readable medium on storage device(s) 1535. In another example, software may reside, completely or partially, within processor(s) 1501.

Bus 1540 connects a wide variety of subsystems. Herein, reference to a bus may encompass one or more digital signal lines serving a common function, where appropriate. Bus 1540 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 1500 may also include an input device 1533. In one example, a user of computer system 1500 may enter commands and/or other information into computer system 1500 via input device(s) 1533. Examples of an input device(s) 1533 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect®, Leap Motion®, or the like. Input device(s) 1533 may be interfaced to bus 1540 via any of a variety of input interfaces 1523 (e.g., input interface 1523) including, but not limited to, serial, parallel, game port, USB, FIREWIRE, THUNDERBOLT, or any combination of the above.

In particular embodiments, when computer system 1500 is connected to network 1530, computer system 1500 may communicate with other devices, specifically mobile devices and enterprise systems, distributed computing systems, cloud storage systems, cloud computing systems, and the like, connected to network 1530. Communications to and from computer system 1500 may be sent through network interface 1520. For example, network interface 1520 may receive incoming communications (such as requests or responses from other devices) in the form of one or more packets (such as Internet Protocol (IP) packets) from network 1530, and computer system 1500 may store the incoming communications in memory 1503 for processing. Computer system 1500 may similarly store outgoing communications (such as requests or responses to other devices) in the form of one or more packets in memory 1503 and communicated to network 1530 from network interface 1520. Processor(s) 1501 may access these communication packets stored in memory 1503 for processing.

Examples of the network interface 1520 include, but are not limited to, a network interface card, a modem, and any combination thereof. Examples of a network 1530 or network segment 1530 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 1530, may employ a wired and/or a wireless mode of communication. In general, any network topology may be used.

Information and data can be displayed through a display 1532. Examples of a display 1532 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 1532 can interface to the processor(s) 1501, memory 1503, and fixed storage 1508, as well as other devices, such as input device(s) 1533, via the bus 1540. The display 1532 is linked to the bus 1540 via a video interface 1522, and transport of data between the display 1532 and the bus 1540 can be controlled via the graphics control 1521. In some embodiments, the display is a video projector. In some embodiments, the display is a head-mounted display (HMD) such as a VR headset. In further embodiments, suitable VR headsets include, by way of non-limiting examples, HTC Vive®, Oculus Rift®, Samsung Gear VR®, Microsoft HoloLens®, Razer OSVR®, FOVE VR®, Zeiss VR One®, Avegant Glyph®, Freefly VR® headset, and the like. In still further embodiments, the display is a combination of devices such as those disclosed herein.

In addition to a display 1532, computer system 1500 may include one or more other peripheral output devices 1534 including, but not limited to, an audio speaker, a printer, a storage device, and any combinations thereof. Such peripheral output devices may be connected to the bus 1540 via an output interface 1524. Examples of an output interface 1524 include, but are not limited to, a serial port, a parallel connection, a USB port, a FIREWIRE port, a THUNDERBOLT port, and any combinations thereof.

In addition or as an alternative, computer system 1500 may provide functionality as a result of logic hardwired or otherwise embodied in a circuit, which may operate in place of or together with software to execute one or more processes or one or more steps of one or more processes described or illustrated herein. Reference to software in this present disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Select televisions, video players, and digital music players with optional computer network connectivity are suitable for use in the system described herein. Suitable tablet computers, in various embodiments, include those with booklet, slate, and convertible configurations.

In some embodiments, the computing device includes an operating system configured to perform executable instructions. The operating system is, for example, software, including programs and data, which manages the device's hardware and provides services for execution of applications. Suitable server operating systems include, by way of non-limiting examples, FreeBSD®, OpenBSD®, NetBSD®, Linux®, Apple® Mac OS X Server®, Oracle Solaris®, Windows Server®, and Novell NetWare®. Suitable personal computer operating systems include, by way of non-limiting examples, Microsoft Windows®, Apple Mac® OS X, UNIX®, and UNIX-like operating systems such as GNU/Linux®. In some embodiments, the operating system is provided by cloud computing. Suitable mobile smartphone operating systems include, by way of non-limiting examples, Nokia Symbian® OS, Apple® iOS, Research In Motion BlackBerry® OS, Google® Android®, Microsoft® Windows Phone® OS, Microsoft® Windows Mobile OS, Linux®, and Palm® WebOS. Suitable media streaming device operating systems include, by way of non-limiting examples, Apple TV®, Roku®, Boxee®, Google TV®, Google Chromecast®, Amazon Fire®, and Samsung® HomeSync®. Suitable video game console operating systems include, by way of non-limiting examples, Sony® PS3®, Sony® PS4®, Microsoft® Xbox 360®, Microsoft Xbox One®, Nintendo Wii®, Nintendo Wii U®, and Ouya®. Suitable virtual reality headset systems include, by way of non-limiting example, Meta Oculus®.

### Non-Transitory Computer Readable Storage Mediums

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Programs

In another aspect, disclosed herein is a computer program product, the computer program product comprising at least one non-transitory computer-readable medium having computer-readable program code portions embodied therein, the computer-readable program code portions comprising: an executable portion configured to obtain (i) a first dataset comprising an observed data sample from a data distribution of observed data and (ii) a second dataset comprising a prior sample from a prior distribution; an executable portion configured to synthesize first data at a first time step based on the observed data sample and the prior sample; an executable portion configured to synthesize second data at a second time step based on the observed data sample and the first data, wherein the second time step is between a target time step and the first time step; an executable portion configured to generate, using a neural network, a first output and a second output at the target time step, wherein (i) the first output is obtained using the first data with the target time step and the first time step as conditioning inputs and (ii) the second output is obtained using the second data with the target time step and the second time step as conditioning inputs; and an executable portion configured to obtain a trained generative AI model by updating parameters of the neural network, wherein the updating comprises at least computing a loss between a first distribution of the first output and a second distribution of the second output.

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the present disclosure provided herein, a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Applications

In some embodiments, a computer program includes a web application. In light of the present disclosure provided herein, a web application, in various embodiments, utilizes one or more software frameworks and one or more database systems. In some embodiments, a web application is created upon a software framework such as Microsoft®.NET or Ruby on Rails® (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® structured query language (SQL) Server, mySQL™, and Oracle®. A web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML® (AJAX), Flash Actionscript, Javascript®, or Silverlight®. In some embodiments, a web application is written to some extent in a server-side coding language such as Active Server Pages® (ASP), ColdFusion®, Perl®, Java®, JavaServer Pages® (JSP), Hypertext Preprocessor® (PHP), Python®, Ruby®, Tcl®, Smalltalk®, WebDNA®, or Groovy®. In some embodiments, a web application is written to some extent in a database query language such as Structured Query Language (SQL). In some embodiments, a web application integrates enterprise server products such as IBM Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft Silverlight®, Java®, and Unity®.

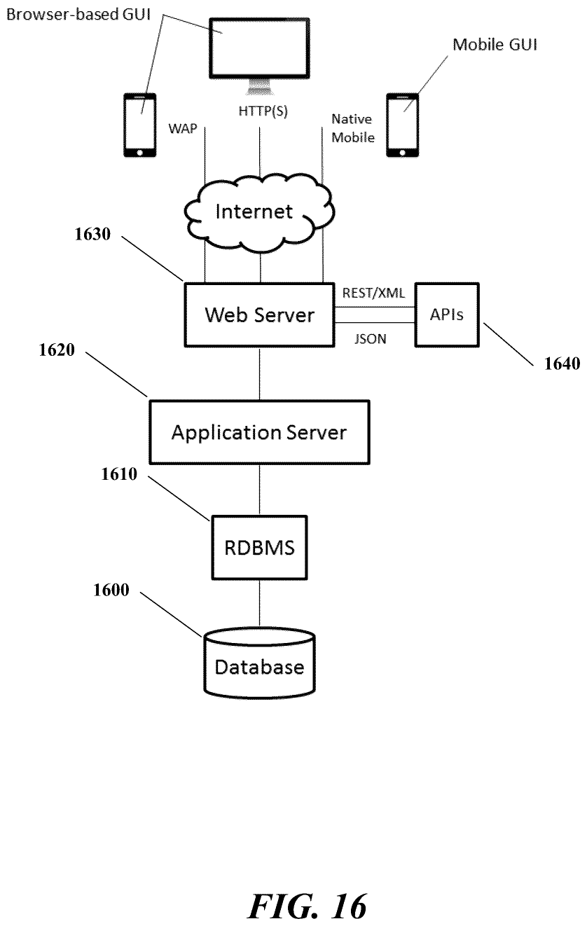

Referring to FIG. 16, in a particular embodiment, an application provision system comprises one or more databases 1600 accessed by a database management system (DBMS) 1610. Suitable DBMSs include Firebird®, MySQL®, NoSQL®, PostgreSQL®, SQLite®, Oracle Database®, Microsoft SQL Server®, IBM DB2®, IBM Informix®, SAP Sybase®, SAP Sybase®, Teradata®, PostGIS®, Apache® Hive, Apache® Impala, time-series databases, graph databases, key-value storage, and the like. In this embodiment, the application provision system further comprises one or more application severs 1620 (such as Java® servers, NET® servers, PHP® servers, and the like) and one or more web servers 1630 (such as Apache®, IIS®, GWS® and the like). The web server(s) optionally expose one or more web services via app application programming interfaces (APIs) 1640. Via a network, such as the Internet, the system provides browser-based and/or mobile native user interfaces. In some cases, a DBMS may be a relational DBMS.

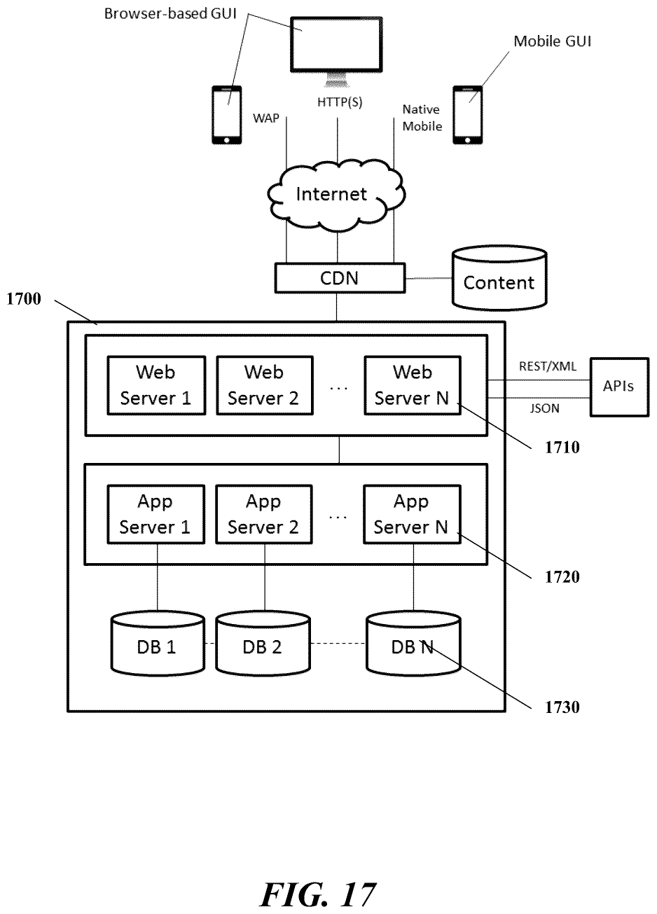

Referring to FIG. 17, in a particular embodiment, an application provision system alternatively has a distributed, cloud-based architecture 1700 and comprises elastically load balanced, auto-scaling web server resources 1710 and application server resources 1720 as well synchronously replicated databases 1730.

### Mobile Applications

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the present disclosure provided herein, a mobile application is created by techniques using hardware, languages, and development environments. Mobile applications are written in several languages. Suitable programming languages include, by way of non-limiting examples, C, C++, C#, Objective-C, Java®, Javascript®, Pascal®, Object Pascal®, Python™ Ruby®, VB.NET®, WML®, and XHTML/HTML with or without CSS, or combinations thereof.

Suitable mobile application development environments are available from several sources. Commercially available development environments include, by way of non-limiting examples, AirplaySDK®, alcheMo®, Appcelerator®, Celsius®, Bedrock®, Flash Lite®, NET Compact Framework®, Rhomobile®, and WorkLight Mobile Platform®. Other development environments are available without cost including, by way of non-limiting examples, Lazarus®, MobiFlex®, MoSync®, and Phonegap®. Also, mobile device manufacturers distribute software developer kits including, by way of non-limiting examples, iPhone® and iPad® (iOS) SDK, Android® SDK, BlackBerry® SDK, BREW SDK, Palm® OS SDK, Symbian® SDK, webOS® SDK, and Windows® Mobile SDK.

Several commercial sources are available for distribution of mobile applications including, by way of non-limiting examples, Apple® App Store, Google® Play, Chrome® WebStore, BlackBerry® App World, App Store® for Palm devices, App Catalog® for webOS, Windows® Marketplace for Mobile, Ovi Store for Nokia® devices, Samsung® Apps, and Nintendo® DSi Shop.

### Standalone Applications

In some embodiments, a computer program includes a standalone application, which is a program that is run as an independent computer process, not an add-on to an existing process, e.g., not a plug-in. Standalone applications are often compiled. A compiler is a computer program(s) that transforms source code written in a programming language into binary object code such as assembly language or machine code. Suitable compiled programming languages include, by way of non-limiting examples, C, C++, Objective-C®, COBOL®, Delphi®, Eiffel®, Java®, Lisp®, Python®, Visual Basic®, and VB .NET®, or combinations thereof. Compilation is often performed, at least in part, to create an executable program. In some embodiments, a computer program includes one or more executable compiled applications. Additionally, microservices related to Python® and JavaScript® may be used.

### Web Browser Plug-Ins

In some embodiments, the computer program includes a web browser plug-in (e.g., web extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Several web browser plug-ins may include Adobe Flash Player®, Microsoft Silverlight®, and Apple QuickTime®. In some embodiments, the toolbar comprises one or more web browser extensions, add-ins, or add-ons. In some embodiments, the toolbar comprises one or more explorer bars, tool bands, or desk bands.

In view of the present disclosure provided herein, several plug-in frameworks are available that enable development of plug-ins in various programming languages, including, by way of non-limiting examples, C++, Delphi®, Java®, PHP®, Python®, and VB .NET®, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft Internet Explorer®, Mozilla Firefox®, Google Chrome®, Apple Safari®, Opera Software Opera®, and KDE Konqueror®. In some embodiments, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google Android® browser, RIM BlackBerry® Browser, Apple Safari®, Palm Blazer®, Palm WebOS® Browser, Mozilla Firefox® for mobile, Microsoft Internet Explorer Mobile®, Amazon Kindle Basic Web®, Nokia Browser®, Opera Software Opera Mobile®, and Sony PSP® browser.

### Software Modules

In some embodiments, the platforms, systems, media, and methods disclosed herein include software, server, and/or database modules, or use of the same. In view of the present disclosure provided herein, software modules are created by techniques using machines, software, and languages. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases (DB), or use of the same. In view of the present disclosure provided herein, many databases are suitable for storage and retrieval data. In various embodiments, suitable databases include, by way of non-limiting examples, relational databases, non-relational databases, object oriented databases, object databases, entity-relationship model databases, associative databases, XML databases, time-series databases, graph databases, and the like. Further non-limiting examples include SQL, PostgreSQL®, MySQL®, Oracle®, DB2®, and Sybase. In some embodiments, a database is internet-based. In further embodiments, a database is web-based. In still further embodiments, a database is cloud computing-based. In a particular embodiment, a database is a distributed database. In other embodiments, a database is based on one or more local computer storage devices.

### Terms and Definitions

Unless otherwise defined, all technical terms used herein have the same meaning as commonly understood by one of ordinary skill in the art to which this present disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount.

As used herein, the term “about” refers to an amount that is near the stated amount by 10%, 5%, or 1%, including increments therein.

As used herein, the term “about” in reference to a percentage refers to an amount that is greater or less the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

While preferred embodiments of the present disclosure have been shown and described herein, such embodiments are provided by way of example only. It is not intended that the present disclosure be limited by the specific examples provided within the specification. While the present disclosure has been described with reference to the aforementioned specification, the descriptions and illustrations of the embodiments herein are not meant to be construed in a limiting sense. Numerous variations, changes, and substitutions may occur without departing from the present disclosure. Furthermore, it shall be understood that all aspects of the present disclosure are not limited to the specific depictions, configurations, or relative proportions set forth herein which depend upon a variety of conditions and variables. It should be understood that various alternatives to the embodiments of the present disclosure described herein may be employed in practicing the present disclosure. It is therefore contemplated that the present disclosure shall also cover any such alternatives, modifications, variations, or equivalents. It is intended that the following claims define the scope of the present disclosure and that systems, methods and structures within the scope of these claims and their equivalents be covered thereby.

What is claimed is:

1. A method for training a generative artificial intelligence (AI) model, the method comprising:
(a) obtaining (i) a first dataset comprising an observed data sample from a data distribution of observed data and (ii) a second dataset comprising a prior sample from a prior distribution;
(b) synthesizing first data at a first time step based on the observed data sample and the prior sample;
(c) synthesizing second data at a second time step based on the observed data sample and the first data, wherein the second time step is between a target time step and the first time step;
(d) generating, using a neural network, a first output and a second output at the target time step, wherein (i) the first output is obtained using the first data with the target time step and the first time step as conditioning inputs and (ii) the second output is obtained using the second data with the target time step and the second time step as conditioning inputs; and
(e) obtaining a trained generative AI model by updating parameters of the neural network, wherein the updating comprises at least computing a loss between a first distribution of the first output and a second distribution of the second output.

2. The method of claim 1, further comprising generating the first dataset and the second dataset.

3. The method of claim 1, wherein the observed data comprises data obtained from image data, video data, audio data, text data, sensor data, geospatial data, or metadata.

4. The method of claim 1, wherein the observed data comprises continuous data, structured data, or unstructured data.

5. The method of claim 1, wherein the prior sample comprises random noise.

6. The method of claim 1, wherein the prior distribution comprises a Gaussian distribution, a uniform random distribution, or a Dirichlet distribution.

7. The method of claim 1, wherein synthesizing the first data comprises sampling from a first marginal interpolating distribution parametrized by the observed data sample and the prior sample.

8. The method of claim 7, wherein the first marginal interpolating distribution is determined using a denoising diffusion implicit model.

9. The method of claim 1, wherein synthesizing the second data comprises sampling from a second marginal interpolating distribution parametrized by the observed data sample and the first data.

10. The method of claim 9, wherein the second marginal interpolating distribution is determined using a denoising diffusion implicit model.

11. The method of claim 1, wherein the first output comprises a first marginal preserving interpolant between the first data and the observed data.

12. The method of claim 11, wherein the first marginal preserving interpolant preserves a marginal distribution of the first output for a plurality of time steps.

13. The method of claim 1, wherein the second output comprises a second marginal preserving interpolant between the second data and the observed data.

14. The method of claim 13, wherein the second marginal preserving interpolation preserves a marginal distribution of the second first output for a plurality of time steps.

15. The method of claim 1, wherein the first time step is sampled from a first time distribution.

16. The method of claim 15, wherein the target time step is sampled from a second time distribution, parametrized by the first time step.

17. The method of claim 16, wherein the second time step is determined using a mapping function parametrized by the first time step and the target time step.

18. The method of claim 1, wherein the computed loss is determined using maximum mean discrepancy.

19. The method of claim 18, wherein the maximum mean discrepancy is determined using a kernel function.

20. The method of claim 1, further comprising applying a stop gradient operation on the second output when computing the loss.

21. The method of claim 1, further comprising prompting the trained generative AI model with at least a request for a type of data and a category of data.

22. The method of claim 21, further comprising generating, using the trained generative AI model, new data based at least on the prompting.

23. The method of claim 22, wherein the new data is determined to be statistically similar to the observed data.

24. The method of claim 22, wherein the new data is determined to be statistically similar to the observed data with a Fréchet inception distance (FID) of less than about 2.5.

25. The method of claim 22, further comprising automatically rendering the new data on a graphical user interface (GUI), wherein the GUI comprises dynamically selectable objects or elements to modify the new data or append additional data to the new data in real time.

26. The method of claim 1, wherein the trained generative AI model comprises a stable model trained in one stage.

27. The method of claim 1, further comprising repetitively synthesizing a third data or more data at successive time steps, based on data synthesized at a previous time step.

28. The method of claim 1, wherein the first dataset comprises a first training dataset, wherein the second dataset comprises a second training dataset, and wherein each dataset is used to obtain the trained generative AI model.
